(19) United States
(12) Patent Application Publication
(10) Pub. No.: US 2025/0165827 A1
(43) Pub. Date: May 22, 2025

(54) QUANTUM PHASED ARRAYS

(71) Applicant: California Institute of Technology, Pasadena, CA (US)

(72) Inventors: Baris Volkan Gurses, Pasadena, CA (US); Samantha I. Davis, Pasadena, CA (US); Maria Spiropulu, Pasadena, CA (US); Seyed Ali Hajimiri, La Canada, CA (US)

(73) Assignee: California Institute of Technology, Pasadena, CA (US)

(21) Appl. No.: 18/629,732

(22) Filed: Apr. 8, 2024

Related U.S. Application Data
(60) Provisional application No. 63/457,727, filed on Apr. 6, 2023.

(51) Int. Cl. G06N 10/20

(52) U.S. Cl. CPC G06N 10/20

(57) ABSTRACT

Quantum Phased Array(s) of emitters and receivers that generate, modulate, emit, receive, and detect any quantum field. Quantum phased arrays include particle source(s) sourcing any quantum field, transmit modulator element(s) modulating any quantum observable and the associated quantum field, emitting elements radiating one or more quantum fields spatiotemporally, a propagation medium with one or more modulator elements for complete control of the quantum field, receiver(s) receiving one or more quantum fields, receive modulator element(s) modulating any quantum observable and the associated quantum field, detector(s) resolving one or more received quantum fields. Quantum metrology, communication and computing systems including quantum phased arrays are detailed for leveraging quantum field engineering functionality (complete control of one or more wavefunctions of one or more particles in any one or more orthonormal bases) of quantum phased arrays for quantum metrology, communication and computing applications.

### CROSS-REFERENCE TO RELATED APPLICATIONS

This application claims the benefit under 35 U.S.C. Section 119(e) of U.S. Provisional Application No. 63/457,727 filed Apr. 6, 2023, by B. Volkan Gurses, Samantha I. Davis, Maria Spiropulu, Ali Hajimiri, entitled “QUANTUM PHASED ARRAYS,” (CIT-8990-P), which application is incorporated by reference herein.

### STATEMENT REGARDING FEDERALLY SPONSORED RESEARCH AND DEVELOPMENT

This invention was made with government support under Grant No. DE-SC0019219 awarded by DOE. The government has certain rights in the invention.

### BACKGROUND OF THE INVENTION

### 1. Field of the Invention

The field of the invention relates to systems that generate, manipulate and detect quantum information for quantum information processing with applications in metrology, communications, and computing.

### 2. Description of the Related Art

Generation, manipulation, and detection of quantum information are the key functionalities for quantum technologies in quantum information science and engineering. By controlling quantum fields or wavefunctions of quantum particles, enhancements to performance in classical systems or novel functionalities unmatched by classical systems have been demonstrated. Therefore, technologies that can generate, manipulate and detect quantum information have promising prospects in enhancing the current performance of classical technologies. Applications, where these enhancements have been demonstrated, are categorized under quantum computing, communications, and metrology.

To unlock these applications and leverage the potential of manipulating information at a single particle level, scalable systems that can manipulate all degrees of freedom of particles, namely their associated quantum fields, at a large, multidimensional scale are necessary. In quantum science and engineering, there have been numerous demonstrations of manipulating the quantum fields at a small scale. Current quantum computers can control 100 s of qubits but further scaling of this number is limited by the system integration of quantum circuitry as well as the classical circuitry required to control each qubit.

Practical realizations of most technologies widely used currently rely on the scalability of the hardware platforms they are realized on. Scaling of classical technologies, one of the prominent examples being Moore's law, enabled the exponential growth of the microelectronics industry, which until recently have not been affected by the fundamental quantum limits of nature. Therefore, while scaling of classical technologies has been relatively easy, they are fundamentally limited by the bounds enforced by quantum mechanics. On the other hand, while quantum technologies promise performance enhancements beyond these bounds, their realizations have been limited by the scaling of the systems and architectures they are built from.

### SUMMARY OF THE INVENTION

In order to improve the performance of classical systems beyond their quantum limits while maintaining the relatively easy scalability of classical systems, modular and highly scalable architectures and system designs are needed for quantum technologies. In order to resolve these challenges, a general system architecture that can be realized with any quantum particle or quasiparticle (including but not limited to any particle in the Standard Model including photons, electrons, quarks, neutrinos; any quasiparticle including plasmons, phonons, excitons; any particle comprised of other previously mentioned particles including atoms, ions, and molecules) on any hardware platform (including but not limited to gaseous-state hardware, solid state hardware, microelectronics, integrated photonics, microfluidics, micro-electromechanical systems, optoelectronics, bulk optics, atomic systems) is described with the name “quantum phased array.”

### BRIEF DESCRIPTION OF THE DRAWINGS

Referring now to the drawings in which like reference numbers represent corresponding parts throughout:

FIG. 1 Quantum phased array transmitter variant.

FIG. 2 Quantum phased array receiver variant.

FIG. 3 Quantum phased array intermediary stage variant.

FIG. 4 Quantum photonic phased array system using photons.

FIG. 5 Quantum electronic phased array system using electrons.

FIG. 6 Quantum atomic phased array system using atoms, ions, or molecules.

FIG. 7 Quantum polaritonic phased array system using polaritons.

FIG. 8 Quantum protonic phased array system using protons.

FIG. 9 Quantum neutronic phased array system using neutrons.

FIG. 10 Quantum phased array system with subatomic charged particles.

FIG. 11 Quantum phased array system with neutrinos.

FIG. 12A quantum phased array based reflective quantum metrology system.

FIG. 13A quantum phased array based transmissive quantum metrology system.

FIG. 14A quantum phased array based quantum communication system.

FIG. 15A quantum phased array based quantum simulator.

FIG. 16A quantum phased array based quantum computer.

FIG. 17. Concept diagram of quantum phased arrays showing free-space quantum Fourier transform, phase shifters and on-chip quantum processors.

FIGS. 18a-18e. Quantum phased array chip. FIG. 18a. Diagram of the quantum phased array chip showing the building blocks including the metamaterial antenna and quantum coherent receiver. FIG. 18b. Far-field radiation pattern of the metamaterial antenna. FIG. 18c. LO power sweep showing 30.7 dB shot noise clearance and 9.43 μW LO power knee for the QRX in high shot noise clearance configuration. FIG. 18d Output noise spectra at different LO powers showing 3.50 GHz shot-noise-limited bandwidth for the QRX in high bandwidth configuration. FIG. 18e High-bandwidth squeezed light detection with a single-channel QRX in high-bandwidth configuration.

FIG. 19a Experimental setup. Squeezed light is generated off-chip and transmitted over free space to a photonic integrated circuit (blue), which is interfaced with electronics (red) for quantum information processing. FIG. 19b: Quantum imaging Squeezed light quadratures are imaged. The mean and variance of the quadratures are plotted for each channel (32 channels in this example). By sweeping over phase space, the density matrix of the quantized field mode for each pixel is reconstructed. The Wigner functions for each pixel are plotted in FIG. 19c, units are +/−1.5 for both x and p.

FIGS. 20a-20f. Wavefunction Engineering. A large challenge in free space quantum sensing and communications is that quantum fields transmitted over free space diffract over large areas, resulting in large illumination losses per receiver [1]. Here we theoretically propose and experimentally demonstrate how wavefunction engineering and beamforming can solve this problem. The concept is most easily visualized with squeezed light, but generalized to any quantum state. We focus on the case of phased array receiver but same arguments apply for transmitter. FIG. 20a Quantum beamforming A quantized electromagnetic field in a squeezed state is transmitted over free space and diffracts over multiple receivers. Each receiver measures the quadrature by coherent detection. The squeezing in the quadrature measured at each receiver is decreased with respect to the squeezing of the state prior to transmission as a result of diffraction. However, since the quadratures are coherent across all receivers, by coherent combination of all the received quadratures and optimizing the phases and gains of each receiver beamforming), quadrature of the original field can be recovered. Receivers are not limited to homodyne detection e.g. could also be quantum transducers. FIG. 20b. Beamforming with squeezed light. We send squeezed light to the chip, coherently combine the receiver outputs and align the optimize the phases to maximize the squeezing in the quadrature noise. To demonstrate the effect of spatial mode matching efficiency, we combine different numbers of channels of the 32 total receivers on the chip and find maximum squeezing at 8 channels. The data follows the trend expected for the mode matching efficiency for gain profile of a box function centered at the middle of the aperture for a given input squeezed state with a Gaussian spatial profile. FIG. 20c Squeezed variance as a function of pump power to SPDC for all 32 channels combined. After combining all 32 channels we can resolve squeezing. The data a fit to the expected squeezed light trend. FIG. 20d. Programmable quantum channels. Programmability of phases and gains allow establish quantum channels over a range of angles, as well as spatial filtering blocking jamming attacks and quantum information sent from undesired channels. FIG. 20e Field of view. The launch angle of the transmitted squeezed light is swept and we beamform for each angle, demonstrating the establishment of quantum links over the field of view of the chip, for 8 and 32 channels combined. FIG. 20f Radiation pattern. The chip is beamformed to a fixed angle as the launch angle of the transmitter is swept, demonstrating the angular (beam) width of an established quantum channel, for 8 and 32 channels combined.

FIG. 21a-21c. Gaussian quantum computing. FIG. 21a. Circuit architecture. FIG. 21b. Equivalent optical circuit implementation. FIG. 21c. Entanglement generation.

FIG. 22. HG Modes uₙₘ(x,y)

FIG. 23. First ten 1D HG modes gₙ(x)

FIG. 24. First ten binned 1D HG modes vectors

FIG. 25. First ten input mode vectors, after Gram-Schmidt

FIG. 26. Matrix plot for U for N=10

FIG. 27. ηₜₒₜ VS χ=L/σ for uniform gains

FIG. 28. η_{N} as a function of number of channels. The x axis in the number of channels with gains=1. The remaining have gains=0. The channels that are turned on are symmetric about the center. E.g. for num. channels=2, channels 15,16 have gain=1 and the rest have gain=0.

FIG. 29: Binary tree networks of bidirectional couplers. An order k tree has 2K inputs and outputs. The inputs and outputs are enumerated in red and black, respectively.

FIG. 30: Block diagram of a quantum phased array.

FIG. 31: Construction of coupler network scattering submatrix

FIG. 32: Outer most matrix

FIG. 33: Quantum Circuit Diagram of the QPA

FIG. 34: How to herald

$$\frac{1}{\sqrt{2}} ( \vert N - 1 , 1 〉 + \vert 1 , N - 1 〉 )$$

in the early and late timebins using the INQNET GUI. Two PNR detectors, each at spatial mode 1 and 2, are each input to a time tagger channel labeled by 1 and 2 in the FIG. This would necessitate four channels in the GUI, where coincidences are taking across the diagonal windows for each time-bin as depicted in the FIG.

FIG. 35: Example chip layout for the free-space QPA.

FIG. 36: Block diagram of structures on one path of a photon.

FIGS. 37a-37b: Experimental setups for the free-space QPA. FIG. 37a: Single photon steering experiment. FIG. 37b Entanglement steering and N00N state generation experiment.

FIG. 38: Hong-Ou-Mandel dip.

FIG. 39: Example chip layout for the fiber-optic QPA/quantum network on chip (QNOC).

FIG. 40: Block diagram of structures on one path of a photon in QNOC.

FIGS. 41a-41b: Experimental setups for the QNOC. FIG. 41a: Single-photon steering experiment. FIG. 41b: Entanglement steering and N00N state generation experiment.

FIG. 42: Example Hardware Environment.

FIG. 43. Example Network Environment.

FIG. 44. Flowchart illustrating a method of making a device.

FIG. 45. Flowchart illustrating a method of using a quantum phased array.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### Quantum Field Theory

Quantum field engineering with quantum phased arrays relies on theory of quantum mechanics, and more generally quantum field theory.

In non-relativistic quantum mechanics, the time evolution of particles is governed by the time-dependent Schrodinger equation,

$$i ℏ \frac{\partial }{\partial t} \vert Ψ 〉 = \hat{H} \vert Ψ 〉 \qquad ( 1 )$$

where |Ψ [symbol] is the state of one or more particles and Ĥ is the Hamiltonian of the

$$\vert Ψ 〉 = \int 〈 r \vert Ψ 〉 \vert r 〉 {d}^{3} r \qquad ( 2 )$$

where r is the position vector and [symbol] r|ψ [symbol] =Ψ(r, t) is the position-basis wavefunction.

In its simplest formulation, the quantum phased array performs quantum state engineering by tuning the phase and amplitude of wavefunction at different positions, followed or preceded by interference of those components through free space propagation. For example, consider a nonrelativistic particle sent into a quantum phased array, which sends the particle into a superposition over the antenna array. The state of the particle at the array is:

$$\vert Ψ 〉 = {\sum }_{i} {c}_{i} \vert {r}_{i} 〉 \qquad ( 3 )$$

where {rᵢ} are the set of the positions for the antennas and cᵢ is the position basis wavefunction evaluated at rᵢ. The amplitude and phased modulators multiply the coefficients cᵢ at each antenna, enabling independent control of each antenna component of the wavefunction. The amplitude and phase manipulation, in addition to subsequent (in the transmitter case) or prior (in the receiver case) propagation of the state through free space, enables the generation of any single particle state in the limit of large number of antennas. By introducing multiple particles into the quantum phased array, more complex states, such as multipartite entanglement, can be generated in a reconfigurable manner.

The quantum phased array concept generalizes beyond non-relativistic particles to relativistic quantum fields. In quantum field theory, particles are excitations of relativistic quantum fields. Fields are quantized through canonical quantization, which introduces the creation (â^{†}) and annihilation operators (â) as generators for fields from the vacuum state. The annihilation and creation operators satisfy the anticommutation relations for fermions,

$$\{ {\hat{a}}_{i} , {\hat{a}}_{j} \} = \{ {\hat{a}}_{i}^{†} , {\hat{a}}_{j}^{†} \} = 0 \qquad ( 4 )$$

$$\{ {\hat{a}}_{i} , {\hat{a}}_{j}^{†} \} = 〈 i \vert j 〉 \qquad ( 5 )$$

and the commutation relations for bosons,

$$[ {\hat{a}}_{i} , {\hat{a}}_{j} ] = [ {\hat{a}}_{i}^{†} , {\hat{a}}_{j}^{†} ] = 0 \qquad ( 6 )$$

$$[ {\hat{a}}_{i} , {\hat{a}}_{j}^{†} ] = 〈 i \vert j 〉 \qquad ( 7 )$$

where applying âᵢ(âᵢ^{†}) corresponds to removing (adding) a single particle from (to) state |i [symbol] . The field creation and annhilation operators are constructed as

$$a ( x ) = {\sum }_{v} {ψ}_{v} ( x ) {a}_{v} \qquad ( 8 )$$

$${a}^{†} ( x ) = {\sum }_{v} {ψ}_{v}^{*} ( x ) {a}_{v}^{†} \qquad ( 9 )$$

The quantum fields are defined in terms of the field creation and annihilation operators, typically expanded in the momentum basis. For instance, for a free scalar field,

$$ϕ ( x , t ) = \int \frac{{d}^{d} p}{{( 2 π )}^{d}} \frac{1}{\sqrt{2 {E}_{p}}} ( {a}_{p} {e}^{- ip \cdot x} + {a}_{p}^{†} {e}^{ip \cdot x} ) \qquad ( 10 )$$

where ϕ satisfies the Klein-Gordon equation.

For a free vector field,

$${ϕ}^{μ} ( x ) = \int \frac{{d}^{d} p}{{( 2 π )}^{d}} \frac{1}{\sqrt{2 {E}_{p}}} ( {a}_{\vec{p}}^{r} {ϵ}_{r}^{μ} {e}^{- ip \cdot x} + {( {a}_{\vec{p}}^{r} )}^{†} {ϵ}_{r}^{μ} {e}^{ip \cdot x} ) \qquad ( 11 )$$

where each component ϕ^{μ} satisfies the Klein-Gordon equation.

In this picture, operations of quantum fields can be interpreted as operations on the corresponding creation/annihilation operators. The quantum phase array takes an input quantum field and sends it into a superposition over the antennas,

$$\hat{a} \to {\sum }_{i} {c}_{i} {\hat{a}}_{i} \qquad ( 12 )$$

where cᵢ is the wavefunction component at the i th antenna. By freely manipulating the coefficients cᵢ, the quantum phased array controls quantum interference of quantum fields over a preceding or subsequent propagating medium to perform quantum field engineering over one or more fields. Note that the manipulation of wavefunction components cᵢ can be in any degree of freedom, such as position, momentum, mass etc.

Quantum field theory captures special relativistic quantum fields, and has been discussed in context of fermions and bosons in the Standard model. While there is no current complete theory of quantum gravity, the concept of quantum phased array extends to all types of quantum fields, including general relativistic and theorized particles.

The disclosed invention has three primary embodiment variants based on if the system is a transmitter, an intermediary stage, or a receiver in the system it is deployed.

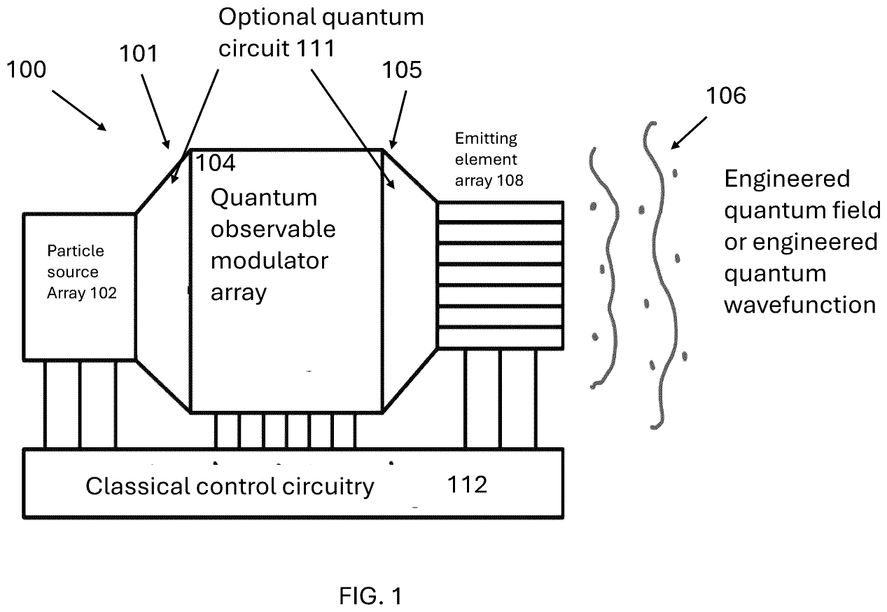

The transmitter variant 100 of the disclosed invention, as shown in FIG. 1, utilizes one or more sources of particles 102 connected to one or more modulator elements 104 that modulate one or more quantum observables (including but not limited to position, momentum, amplitude, phase, spin, polarization, kinetic energy, potential energy, total energy, time, dipole moment) of particles enabling complete control of any arbitrary wavefunction. The engineered quantum field 106 is then emitted by one or more emitters 108 to a spatiotemporal propagation medium. Modulator elements are connected to classical control hardware 112 that has analog and digital circuitry to interface the quantum hardware with software algorithms, enabling real-time control of modulator elements.

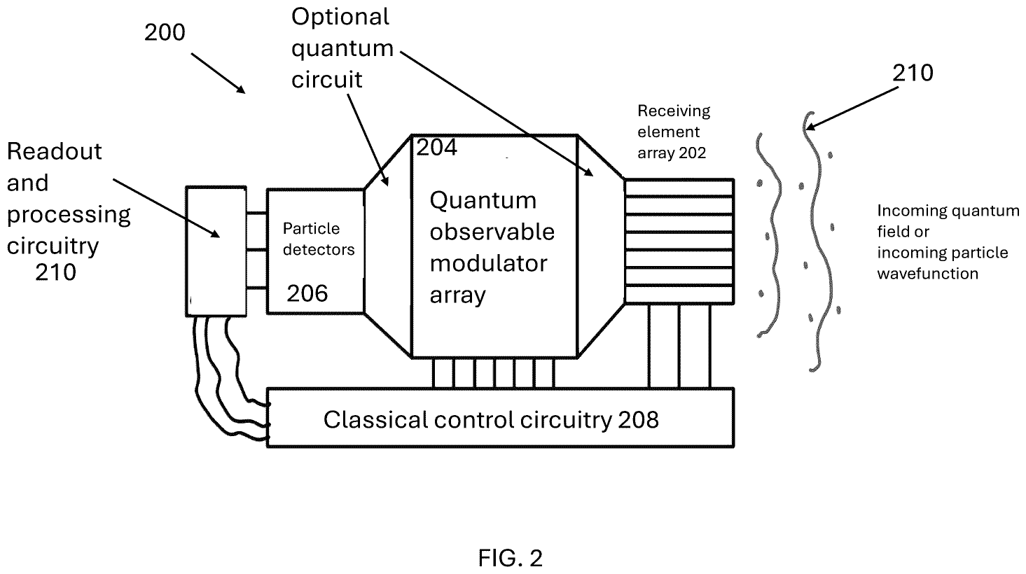

The receiver variant 200 of the disclosed invention, as shown in FIG. 2, is positioned to accept one or more quantum fields emitted by one or more quantum phased array transmitters, quantum phased array intermediary stages, or other arbitrary transmitters in the system. The receiver utilizes one or more receiving elements 202 that accept one or more incoming quantum fields 202, and the receiving elements are connected to one or more modulators 204 that modulate one or more quantum observables of particles, controlling one or more quantum fields. After modulation, the quantum particles are detected by particle detectors 206 that can resolve the quantum information encoded in the wavefunction in one or more orthonormal bases. Modulator elements are connected to classical control hardware 208 that has analog and digital circuitry to interface the quantum hardware with software algorithms, enabling real-time control of modulator elements. Readout from the particle detectors is achieved with classical readout circuitry 210, with which the measured information can be used for various purposes.

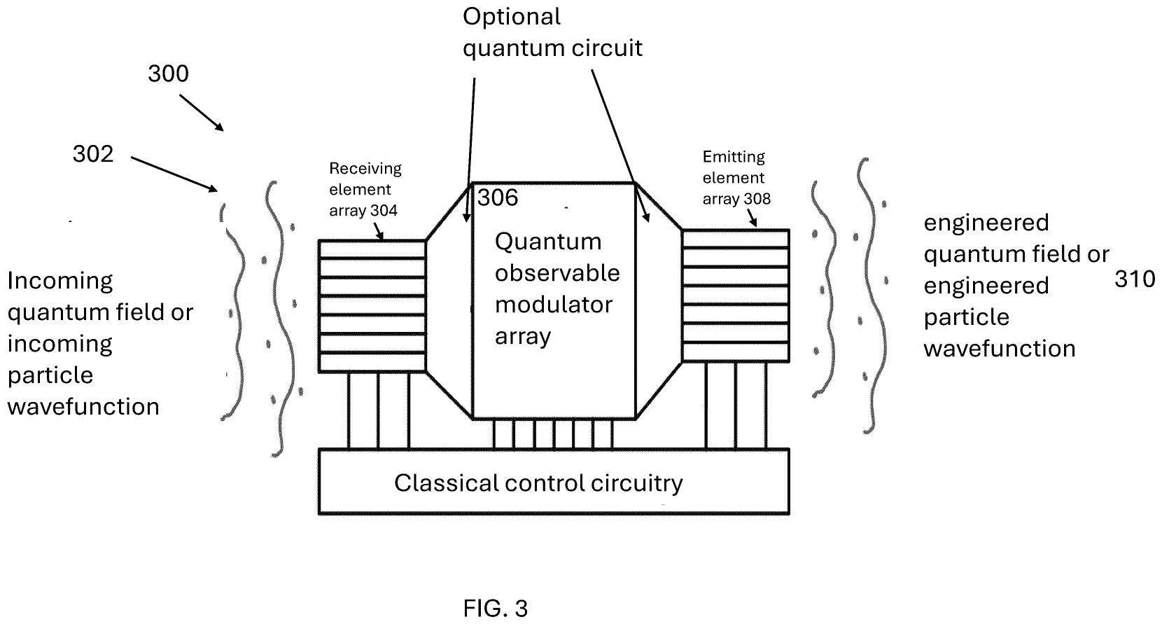

The intermediary stage variant 300 of the disclosed invention, as shown in FIG. 3, is located in the propagation medium of a quantum phased array system and is positioned to accept one or more incoming quantum fields 302 emitted by one or more quantum phased array transmitters, quantum phased array intermediary stages, or other arbitrary transmitters in the system. The intermediary stage utilizes one or more receiving elements 304 that accept one or more incoming quantum fields, and the receiving elements are connected to one or more modulator elements 306 that modulate one or more quantum observables of particles, controlling one or more quantum fields. After modulation, the engineered quantum field is then again emitted by one or more emitters 308 to another spatiotemporal propagation medium 310.

In one embodiment, all variants of the disclosed invention can incorporate quantum circuits in their modulation stages for more complex quantum field engineering. In another embodiment, any or all classical hardware can be interfaced with any or all other classical hardware to form a self-contained system with realtime feedback. In one embodiment of the disclosed invention, the quantum field can be engineered with coherent modulation across one or more modulator channels, whereas in another embodiment, the quantum field can be engineered with incoherent modulation across one or more modulator channels.

In another embodiment, multiple variants can be integrated into a single system to construct various quantum phased array systems in a single form factor. For instance, in one embodiment, one or more quantum phased array transmitters and one or more quantum phased array receivers can be combined to make a quantum phased array transceiver.

Any combination of one or more quantities of these three variants constitutes a quantum phased array system. An end-to-end quantum phased array system enables the generation, manipulation and detection of quantum information along with the subsequent classical processing can be achieved in a single system. This system can be further integrated on a small form factor for easy deployment in various environments for metrology, communications, and computing. Based on the quantum field that is being used, a quantum phased array system has a different design.

### Quantum Phased Array Systems

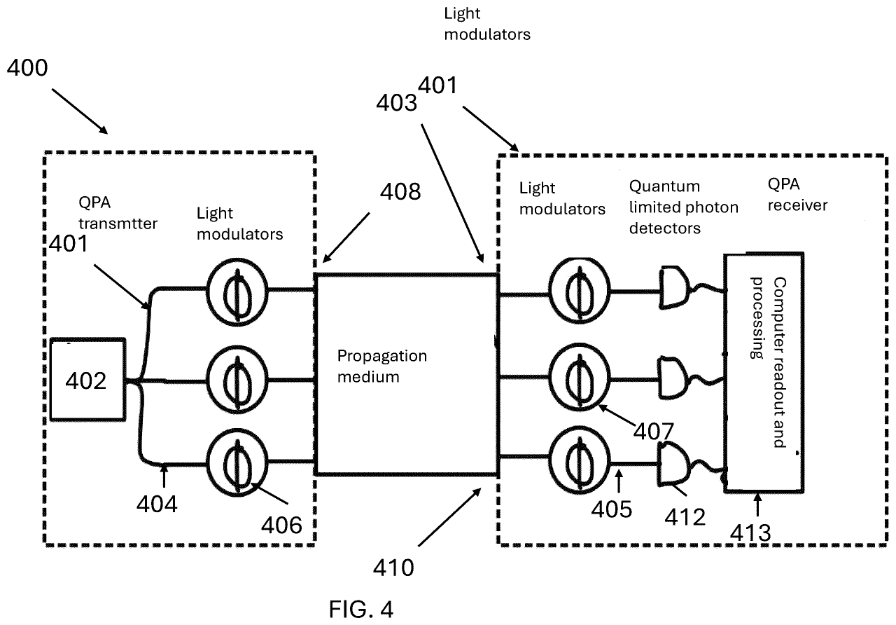

In one embodiment of the disclosed invention, photons are used as shown in FIG. 4. The quantum phased array 400 in this embodiment utilizes a quantum light source 402 that generates single photons. This quantum light source can utilize, including but not limited to, deterministic sources such as atom-based or quantum-dot based photon sources, or probabilistic sources such as nonlinear sources using χ³ in silicon or χ² in lithium niobate, or optical parametric oscillators or optical parametric amplifiers. Generated single photons can be routed to other components via including but not limited to waveguides 404 such as integrated photonic waveguides and fiberoptic cables, or photonic channels in free space. Light modulators 406 can use phase shifters utilizing, including but not limited to, the thermo-optic or electro-optic effect for phase modulation and Mach-Zehnder interferometer networks with phase shifters for amplitude modulation. Light modulators can modulate the wavefunction with respect to any one or more orthonormal bases. Emitting elements 408 or receiving elements 410 can be engineered to be antennas that radiate or accept one or more photon wavefunctions across multiple spatiotemporal modes coherently into or from the adjacent stage in the system. Particle detectors 412 can be including but not limited to single photon-resolving direct detectors such as avalanche photodiodes, photomultiplier tubes, and superconducting nanowire single photon detectors, or single photon-resolving coherent receivers such as balanced homodyne/heterodyne detectors.

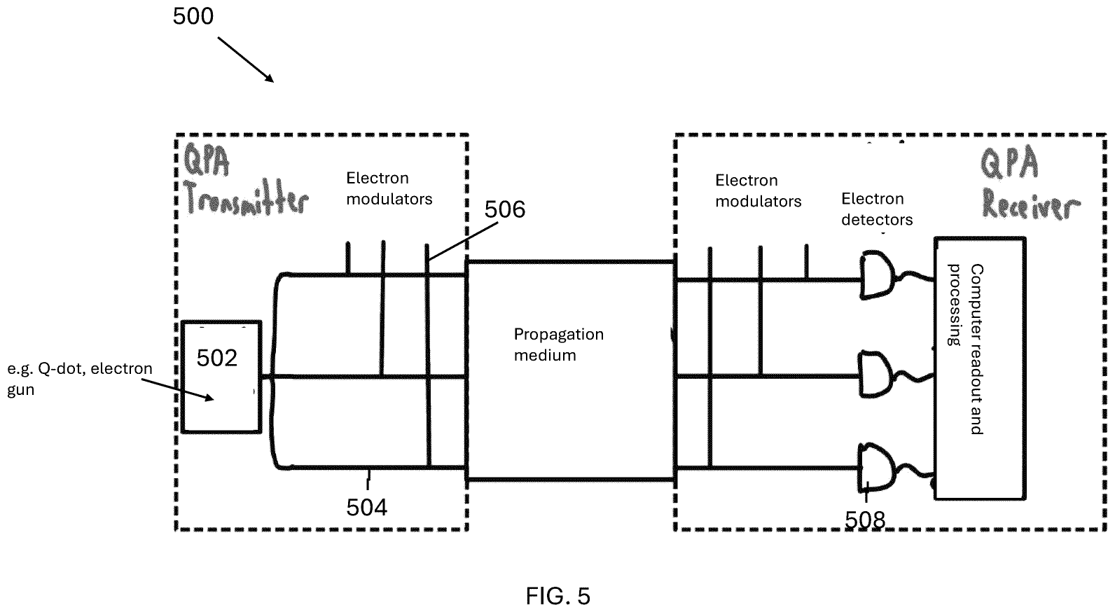

In another embodiment 500 of the disclosed invention, electrons are used as shown in FIG. 5. The particle source 502 that generates single electrons in this embodiment can be including but not limited to electron guns that emit coherent beam of electrons via thermionic, photocathode, plasma, or cold emission, or quantum dot-based single electron sources. Generated single electrons can be routed to other components via including but not limited to electron waveguides 504 such as carbon nanotube waveguides or electron channels in free space. Electron modulators 506 can implement modulation via including but not limited to light-matter interactions such as interacting the electrons with a coherent spatiotemporally engineered light beam or magnetic modulators that inject magnetic field to the medium the electrons are traveling. Modulators can modulate the wavefunction with respect to any one or more orthonormal bases. Emitting or receiving elements can be engineered to radiate or accept one or more electron wavefunctions across multiple spatiotemporal modes coherently into or from the adjacent stage in the system. Particle detectors 508 can be including but not limited to single electron detectors such as superconducting nanowire single electron detectors and resonator-based amplified single electron detectors.

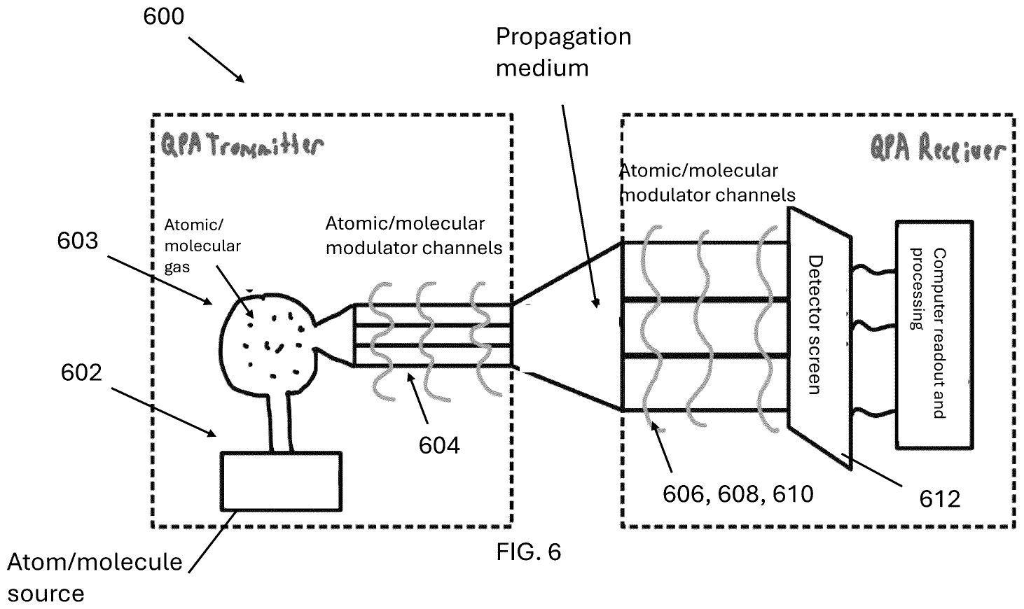

In another embodiment 600 of the disclosed invention, atoms, ions, or multiatom particles such as molecules are used as shown in FIG. 6. In this embodiment, an atom/molecule source 602 supplies the single particles, which are then stored in a gaseous state. The atomic/molecular gas is transferred to atomic/molecular channels 604 in a controlled manner, for example including but not limited to with magnetooptical traps, to emit single atoms/molecules. These channels can be including but not limited to free-space vacuum channels or guided channels such as quadrupole channels in the case of charged particles or optically assisted atomic waveguides. Atomic/molecular modulators 606 can implement modulation on the wavefunction via including but not limited to light-matter interactions such as interacting the electrons with a coherent spatiotemporally engineered light beam 608 or magnetic modulators that inject magnetic field 610 to the modulator channels in the case of charged particles. Modulators can modulate the wavefunction with respect to any one or more orthonormal bases. Emitting or receiving elements can be engineered to radiate or accept one or more atomic/molecular wavefunctions across multiple spatiotemporal modes coherently into or from the adjacent stage in the system. Particle detectors 612 can be including but not limited to single atom detectors such as fluorescence or absorption based spectrometers or electron microscopes.

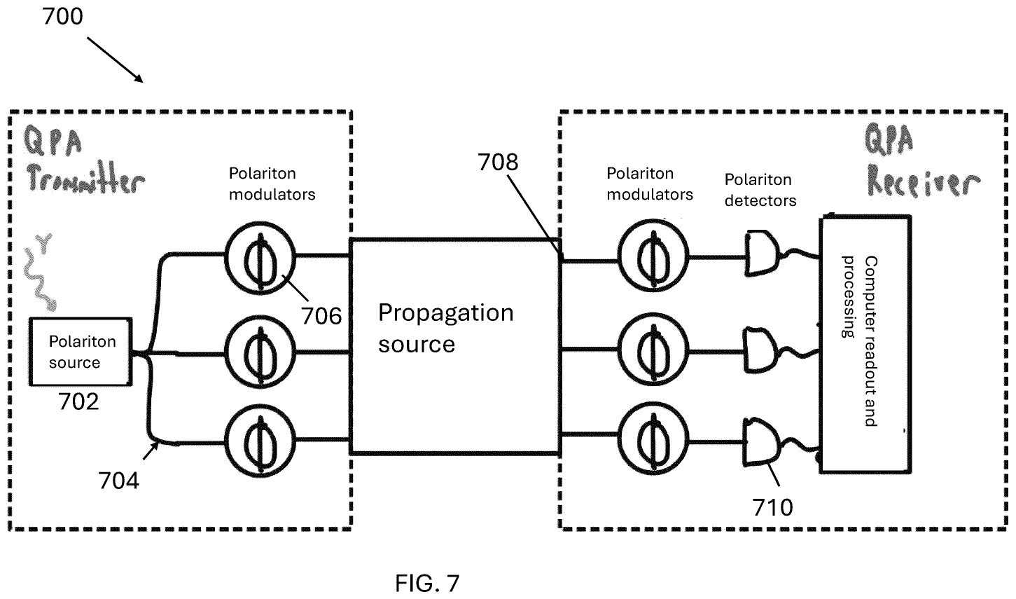

In another embodiment of the disclosed invention, polaritons such as including but not limited to surface plasmon polaritons, exciton polaritons, phonon polaritons are used as shown in FIG. 7. The quantum phased array 700 in this embodiment utilizes a polariton source 702 that generates single polaritons. This polariton source can utilize, including but not limited to, nitrogen-vacancy center-based sources or quantum dot-based single photon-induced sources. Generated single polaritons can be routed to other components via including but not limited to waveguides 704 such as polariton waveguides or free-space channels. Polariton modulators 706 can use including but not limited to phase shifters using the electro-optic or thermo-optic effect and amplitude modulators using interferometer networks with phase shifters. Modulators can modulate the wavefunction with respect to any one or more orthonormal bases. Emitting or receiving elements 708 can be engineered to be antennas that radiate or accept one or more polariton wavefunctions across multiple spatiotemporal modes coherently into or from the adjacent stage in the system. Particle detectors 710 can be including but not limited to single photon-resolving direct detectors such as avalanche photodiodes, photomultiplier tubes, and superconducting nanowire single photon detectors, or single photon-resolving coherent receivers such as balanced homodyne/heterodyne detectors.

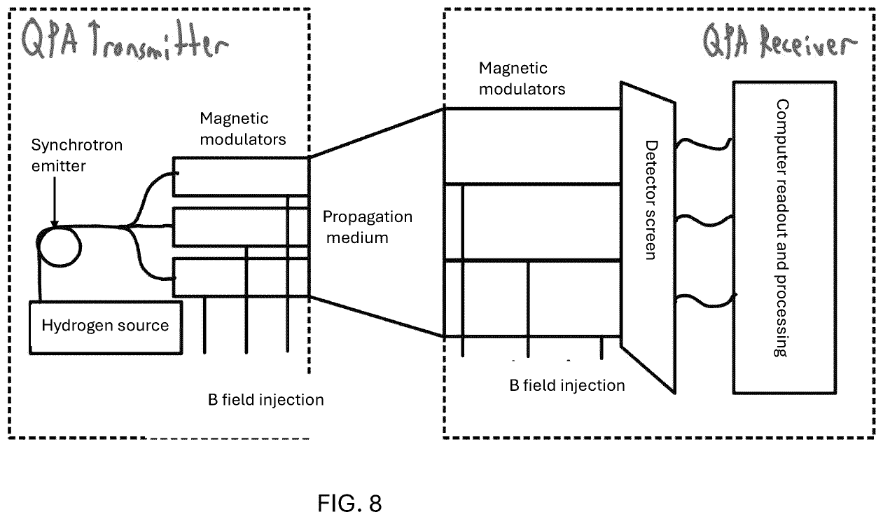

In another embodiment of the disclosed invention protons are used as shown in FIG. 8. In this embodiment 800, the proton source can be including but not limited to hydrogen gas in a hydrogen source such as a tank injected into a duoplasmatron to strip away the electrons in the neutral hydrogen atoms. Resulting single protons can then be routed to other components in channels such as including but not limited to free-space vacuum channels or guided channels such as quadrupole channels. Magnetic accelerators or optical traps can also be utilized to assist in the routing of protons. Proton modulators can implement on the wavefunction via including but not limited to light-matter interactions such as interacting the protons with a coherent spatiotemporally engineered light beam or magnetic modulators that inject magnetic field to the modulator channels.

Modulators can modulate the wavefunction with respect to any one or more orthonormal bases. Emitting or receiving elements can be engineered to radiate or accept one or more protonic wavefunctions across multiple spatiotemporal modes coherently into or from the adjacent stage in the system. Particle detectors can be including but not limited to single proton detectors such as nanowire detectors or magnetic resonance detectors.

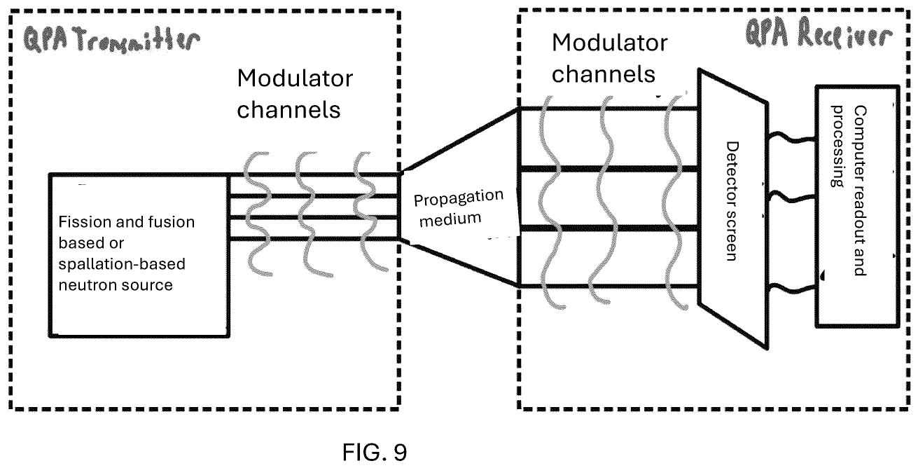

In another embodiment of the disclosed invention, neutrons are used as shown in FIG. 9. In this embodiment, the neutron source can be including but not limited to fission and fusion-based sources such as sealed-tube neutron generators and nuclear reactors, or spallation-based sources such as particle accelerators hitting protons with a target to generate neutrons. Generated neutrons can be routed to other components in channels such as including but not limited to free-space vacuum channels or guided channels such as magnetic neutron waveguides. Magnetic accelerators or optical traps can also be utilized to assist in routing. Neutron modulators can implement modulation on the wavefunction via including but not limited to light-matter interactions such as interacting the neutrons with a coherent spatiotemporally engineered light beam or magnetic modulators that inject magnetic field to the modulator channels. Modulators can modulate the wavefunction with respect to any one or more orthonormal bases. Emitting or receiving elements can be engineered to radiate or accept one or more neutronic wavefunctions across multiple spatiotemporal modes coherently into or from the adjacent stage in the system. Particle detectors can be including but not limited to recoil or reaction-type neutron detectors that detect the subsequent particles generated by the interaction of neutrons with an atomic medium.

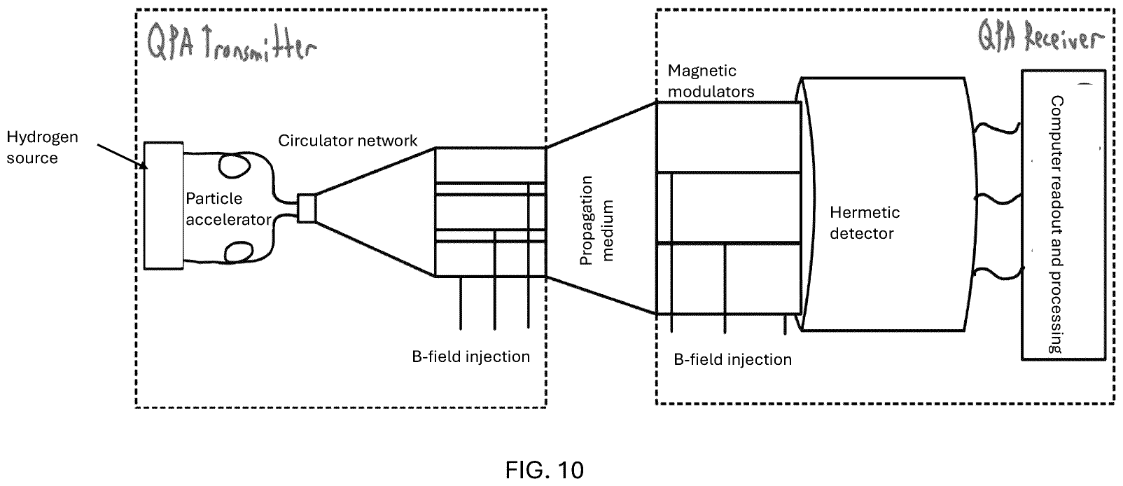

In another embodiment of the disclosed invention, subatomic charged particles in the Standard model such as including but not limited to quarks (up, down, charm, strange, top, down), muons, taus, mesons, baryons, and hadrons are used as shown in FIG. 10. In this embodiment, the particle source can be including but not limited to the aforementioned proton source connected to a quadrupole particle accelerator and an emitter made out of circulator networks, where the particles can be made to selectively decay or grouped into a specific particle. Before the circulator network, a collider can also be used to generate higher energy particles more effectively. Generated single particles can be routed to other components by free-space vacuum channels or guided channels with quadrupoles. Magnetic accelerators or optical traps can also be utilized to assist in routing. Modulators can implement modulation on the particle wavefunction via including but not limited to light-matter interactions such as interacting the electrons with a coherent spatiotemporally engineered light beam or magnetic modulators that inject magnetic field into the modulator channels. Modulators can modulate the wavefunction with respect to any one or more orthonormal bases. Emitting or receiving elements can be engineered to radiate or accept one or more particle wavefunctions across multiple spatiotemporal modes coherently into or from the adjacent stage in the system. Particle detectors can be including but not limited to hermetic detectors with single photon detectors, nanowire detectors, magnetic resonance detectors, and fluorescence or absorption-based spectrometers.

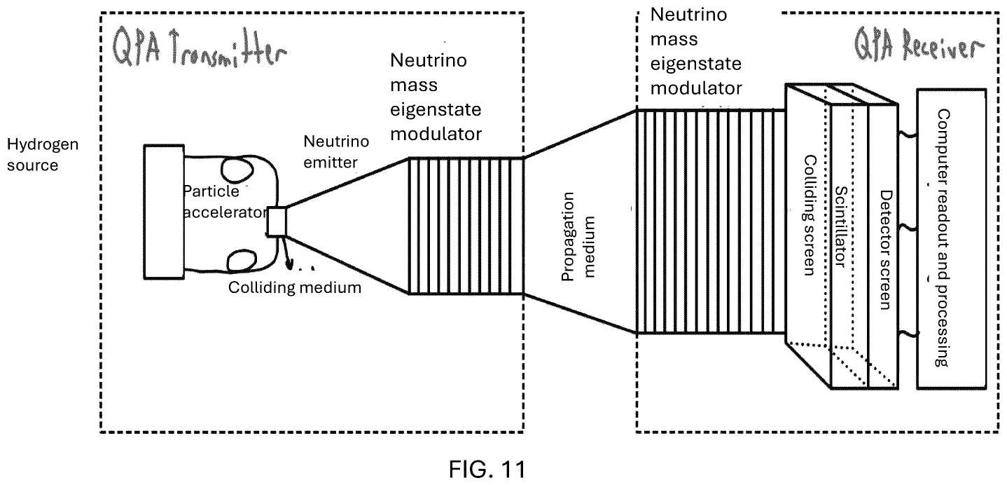

In another embodiment of the disclosed invention, neutrinos are used as shown in FIG. 11. In this embodiment, the neutrino source can be including but not limited to the aforementioned proton source connected to a circulator network generating neutrinos from pion decays or a fission-based source. Generated single neutrinos can be routed to other components by free-space channels or guided channels such as tubes coated with lead. Modulators can modulate the neutrino wavefunction with respect to any one or more orthonormal bases such as including but not limited to mass eigenstate modulators that modulate any one or more neutrino wavefunctions with respect to mass eigenstate by interacting incoming neutrinos with one or more layers of atomic media. Emitting or receiving elements can be engineered to radiate or accept one or more neutrino wavefunctions across multiple spatiotemporal modes coherently into or from the adjacent stage in the system. Detectors can be including but not limited to scintillator-based neutrino detectors, radiochemical neutrino detectors, Cherenkov-radiation-based neutrino detectors, tracking neutrino calorimeters, or coherent recoil detectors based on coherent neutrino scattering.

Other embodiments of the disclosed invention with other particles can be implemented similarly to engineer any one or more wavefunctions of any one or more quantum particles. Since the disclosed invention manipulates quantum fields, the aforementioned quantum particles can be any excitation of any quantum field. In some embodiments, hybrid quantum phased arrays can be used that utilize multiple interacting or non-interacting quantum fields simultaneously.

In another embodiment of the disclosed invention, multiple particles sourcing the resources to engineer any arbitrary quantum field can be used to generate any quantum field abiding by the conservation laws. This embodiment would use quantum field engineering to generate new particles or transform particles to other particles.

### Quantum Protocols

Due to the capability of complete manipulation of any one or more wavefunctions in a quantum system with quantum phased arrays, quantum phased array systems can have protocols for generating any quantum field and any quantum state. Quantum protocols for quantum phased arrays encompass determining the modulation schemes such as static or dynamic set of modulation weights for the modulators to generate a desired quantum state.

### Quantum Field Engineering

We exemplify a protocol for engineering the wavefunction of a single particle or a quantum field with a quantum phased array transmitter or receiver.

For a transmitter, the initial quantum state |ψ [symbol] ᵢₙ can be decomposed into different eigenstates â^{†}(ξ)|0 [symbol] =|1 [symbol] _{ξ}, each of which is associated with a complex field coefficient r(ξ) and the creation operator â^{†}(ξ), for each emitter mode labeled by ξ, as detailed

$${{\vert ψ 〉}_{in} = {\sum }_{ξ} r ( ξ ) {\hat{a}}^{†} ( ξ ) \vert 0 〉 = {\sum }_{ξ} {t}_{ξ} \vert 1 〉}_{ξ} \qquad ( 13 )$$

The quantum field is modulated by the emitter elements, followed by propagation through the propagation medium. The propagation medium consists of components such as including but not limited to free space, in one or more layers of intermediary stages.

As a result, the state is transformed as

$${{\vert ψ 〉}_{out} = \hat{P} \hat{M} \vert ψ 〉}_{in} \qquad ( 14 )$$

where P is the operator for the transformation by the propagation medium and M is the operator for the transformation by the modulators at each antenna.

In the eigenbasis formed by the set of |1 [symbol] _{ξ}, the input state can be represented as a column vector with complex elements, r_{ξ}, such that

$$\vert {ψ}_{in} 〉 = [ \begin{matrix}{r}_{1} \\ {r}_{2} \\ ⋮\end{matrix} ] = R \qquad ( 15 )$$

The output state is represented as

$${\vert ψ 〉}_{out} = {\sum }_{ζ} t ( ζ ) {\hat{a}}^{†} ( ζ ) = [ \begin{matrix}{t}_{1} \\ {t}_{2} \\ ⋮\end{matrix} ] = T = PMR \qquad ( 16 )$$

where t(ζ) are complex field amplitudes over output modes labeled by ζ and M, P are the matrix representations of \hat{M}, \hat{P} in the eigenbasis. Note that the number of output modes is not necessarily equal to the number of emitter element modes.

For a given input state R and target state T, we determine the modulator

$$M = {( P )}^{- 1} {TR}^{- 1} \qquad ( 17 )$$

For a receiver, the initial quantum state, |ψᵢₙ [symbol] , can be decomposed into different eigenstates â^{†}(ζ)|0 [symbol] =|1 [symbol] , each of which is associated with a complex coefficient, t(ζ), and the creation operator â^{†}(ζ) as detailed earlier.

$${{\vert ψ 〉}_{in} = {\sum }_{ζ} t ( ζ ) {\hat{a}}^{†} ( ζ ) \vert 0 〉 = {\sum }_{ζ} {t}_{ζ} \vert 1 〉}_{ζ} \qquad ( 18 )$$

The state then propagates through the propagation medium into the receiving elements, followed by phase and amplitude modulation. The propagation medium consists of components such as, including but not limited to free space, in one or more layers of intermediary stages. As a result, the state is transformed as

$${{\vert ψ 〉}_{out} = \hat{M} \hat{P} \vert ψ 〉}_{in} \qquad ( 19 )$$

where \hat{P} is the operator for the transformation by the propagation medium and M is the operator for the transformation by the modulators at each antenna.

In the eigenbasis formed by the set of |1 [symbol] _{ζ}, the input state can be represented as a column vector with complex elements, t_{ζ}, such that

$$\vert {ψ}_{i n} 〉 = [ \begin{matrix}{t}_{1} \\ {t}_{2} \\ ⋮\end{matrix} ] = T \qquad ( 20 )$$

The output state is represented as

$${\vert ψ 〉}_{out} = {\sum }_{ξ} r ( ξ ) {\hat{a}}^{†} ( ξ ) = [ \begin{matrix}{r}_{1} \\ {r}_{2} \\ ⋮\end{matrix} ] = R = MPT \qquad ( 21 )$$

where r(ζ) are complex field amplitudes over receiving element modes labeled by

ζ and M, P are the matrix representations of \hat{M}, \hat{P} in the eigenbasis. Note that the number of receiver element modes is not necessarily equal to the number of input modes.

For a given input state T and target state R, we determine the modulator settings from,

$$M = {R ( PT )}^{- 1} \qquad ( 22 )$$

This is an exemplified simple quantum protocol for quantum field engineering with quantum phased array transmitters or receivers with a single particle. In addition to pure states, this could be generalized to single particles in mixed states. This could be generalized to including mixing operations preceding or following the modulator elements, correspond to an additional matrix multiplication on the complex field coefficients. More complicated protocols with one or more particles and with one or more layers of intermediary stages in the propagation medium or with a network of quantum phased arrays can also be employed. Due to the universality of quantum phased arrays, any quantum state can be generated with a network of quantum phased array variants.

### Quantum State Steering

While quantum state steering capability of quantum phased arrays is a sub-functionality of quantum field engineering, this capability will be highlighted as another quantum protocol due to its significance in routing quantum information. This scheme entails an embodiment in which a spatial propagation medium is used to propagate a wavefunction in the far-field. In this specific embodiment of the disclosed invention, the propagation of a wavefunction in free space can be analyzed with quantum Fourier optics. Free space propagation of a wavefunction follows the Huygens-Fresnel principle, with which the propagation of a wavefunction can be broken down to superposed propagation of point sources that represent the complex coefficients, â (ζ), of the wavefunction at all spatial positions. Therefore, using this principle and applying the Fresnel approximation, the complex coefficient of the wavefunction at a spatial position (θ) in the propagation medium is:

$$( \hat{a} ) ( θ ) = \frac{{e}^{i k z ( 1 + \frac{1}{2} {sin}^{2} ( θ ) )}}{i λ z} {\int }_{- ∞}^{∞} [ \hat{a} ( ζ ) {e}^{i k \frac{{ξ}^{2}}{2 z}} ] {e}^{- i 2 πξ {f}_{x}} d ξ$$

where x/z=sin θ and

$${f}_{x} = \frac{1}{λ} sin θ .$$

As seen here, (23) corresponds to a Quantum Fourier Transform of the input wavefunction multiplied with a quadratic phase term. In the far field, Fraunhofer approximation can be applied by taking

$$Δ z ≫ \frac{k {( {ξ}_{b , max} - {ξ}_{b , min} )}^{2}}{2} .$$

$$\begin{matrix}\hat{a} ( θ ) = \frac{{e}^{i k z ( 1 + \frac{1}{2} {sin}^{2} ( θ ) )}}{i λ z} {\int }_{− ∞}^{∞} \hat{a} ( ξ ) {e}^{− i 2 πξ {f}_{x}} d ξ & \\ = \frac{{e}^{i k z ( 1 + \frac{1}{2} {sin}^{2} ( θ ) )}}{i λ z} ℱ𝒯 [ \hat{a} ( ξ ) ] & ( 24 )\end{matrix} \qquad ( 24 )$$

Therefore, (24) corresponds to a Quantum Fourier Transform of the input wavefunction. In one embodiment, assuming spatial propagation operation in the far field, propagation medium acts as a Quantum Fourier Transform on the wavefunction at the emitting elements.

Armed with this analysis, the complex modulator weights for either quantum phased array transmitters or receivers can be derived.

Consider for a transmitter, a quantum state, for instance a deterministic single particle state, is desired to be sent to a detector located at θ′ in the propagation medium. To deterministically send single particles to that detector, the target wavefunction at the detector plane is:

$$\vert ψ 〉 = {\hat{a}}^{†} ( {θ}^{′} ) \vert 0 〉 = \int δ ( {θ}^{′} - θ ) {\hat{a}}^{†} ( θ ) d θ \vert 0 〉 \qquad ( 25 )$$

Then the coefficients at the emitting elements are

$$c ( ξ ) = {ℱ}^{- 1} [ δ ( {θ}^{′} - θ ) {e}^{i k z \frac{{λ}^{2} {f}_{x}^{′ 2}}{2}} ] = {e}^{i k z \frac{{λ}^{2} {f}_{x}^{′ 2}}{2}} {e}^{i 2 π k ξ {f}_{x}^{′}} = {e}^{i 2 π k ξ {f}_{x}^{′}} {e}^{i ϕ} \qquad ( 26 )$$

where ϕ=2πkξf′ₓ. The e^{iϕ} factor acts as a global phase and can be ignored.

Now, consider applying a phase profile at the transmitter modulators that is linear in ξ:

$$c ( ξ ) {e}^{i 2 π k ξγ} = {e}^{i 2 π k ξ ( {f}_{x}^{′} + γ )} = {e}^{i 2 π k ξ {f}_{x}^{″}} \qquad ( 27 )$$

where

$${f}_{x}^{″} = \frac{1}{λ} sin {θ}^{″} .$$

We see that by applying a linear phase profile with the transmitter modulators, the single particle state can be steered from a detector at θ′ to a detector at some new θ″. In fact, any quantum mode can be spatiotemporally steered. Since all of the operators in this analysis are unitary, the same functionality is also possible with a quantum phased array receiver.

Quantum state steering is especially useful to spatiotemporally route quantum information to different nodes in a quantum network or to superpose pure states in the same spatiotemporal coordinates to generate multipartite entanglement.

### Quantum Metrology System

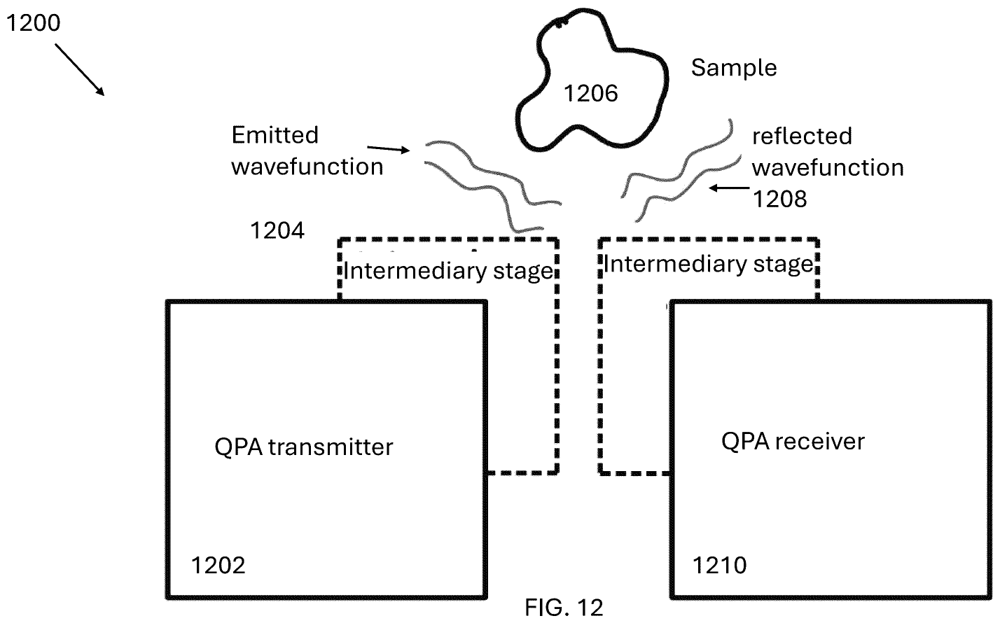

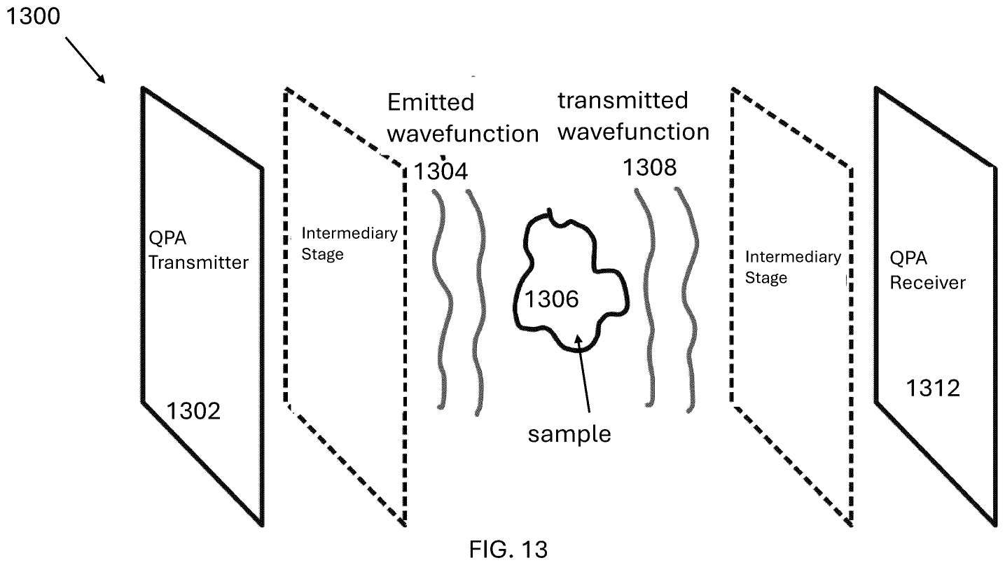

FIG. 13 and FIG. 12 illustrate two example systems comprising the aforementioned embodiments of quantum phased arrays for quantum metrology applications. FIG. 13 exemplifies a transmissive metrological system 1300, in which the quantum phased array transmitter 1302 transmitting a modulated wavefunction 1304 that passes through a sample 1306 placed in the propagation medium. During transmission, the wavefunction interacts with the sample for the sample to encode information in it. After the wavefunction 1308 passes through the sample, it is received by the quantum phased array receiver 1312, which further modulates the wavefunction to extract information from the sample. FIG. 12 exemplifies a reflective metrological system 1200, in which the quantum phased array transmitter 1202 transmitting a modulated wavefunction 1204 that reflects from a sample 1206 placed in the propagation medium. During reflection, the wavefunction interacts with the sample for the sample to encode information in it. After the wavefunction 1208 reflects from the sample, it is received by the quantum phased array receiver 1210, which further modulates the wavefunction to extract information from the sample.

The modulation done by the transmitter and the receiver can be controlled by an algorithm to maximize the amount of information extracted from the sample. In one embodiment, this algorithm can allow the transmitter to generate entanglement between multiple modes of the quantum wavefunction with the aforementioned quantum field engineering capability. After passing through or reflecting from the sample, the quantum correlations in the entangled state can be leveraged to increase the amount of information extracted from the sample.

In another embodiment of the disclosed invention, the aforementioned quantum state steering capability of quantum phased arrays can be utilized to probe specific spatiotemporal locations on a sample with a quantum state. The spatiotemporal selectivity of quantum state steering enables spatiotemporal filtering of quantum information being transmitted through or reflected from a sample. In one embodiment, this can allow a sample to be scanned with a quantum state. This can allow to employ quantum sensing schemes such as scanning differential phase contrast microscopy with quantum resource probes. In another embodiment, this can allow multiplex quantum states to be superposed on the same spatiotemporal location to generate spatially filtered multipartite entanglement.

In another embodiment, the quantum metrology system can be utilized to acquire timing information about the propagation of the quantum wavefunction for quantum-enhanced detection and ranging (QDAR).

In another embodiment, the quantum metrology system can be used to employ any one or more quantum-enhanced metrology schemes, such as including but not limited to, quantum illumination, quantum detection and ranging, N00N interferometry, ghost imaging, quantum microscopy, squeezed light interferometry.

In another embodiment, a quantum circuit 111 (see FIG. 1), such as, including but not limited to, an interferometer network with quantum emitters and detectors, in one of the quantum phased array variants can be employed to generate an arbitrary wavefunction in a single variant. The quantum circuit can precede or follow the emitter elements in the transmitter embodiment or the receiver elements in the receiver embodiment. The configuration and weights of this quantum circuit can be tuned with the initial configuration used as a variational quantum ansatz for arbitrary state preparation that is sent to the sample for information extraction, for example by multiple parameter estimation. The quantum circuit can include antennas, for example.

In another embodiment, the quantum metrology system can multiplex classical and quantum information to enable metrology with both classical and quantum information. This multiplexing can be done by, including but not limited to, spatial, temporal multiplexing or encoding the quantum information in a quantum observable not modulated by classical information encoding.

In another embodiment, quantum phased arrays can be used for metrology experiments for fundamental tests of physics. Due to the spatiotemporal reconfigurability aspect of quantum phased arrays, quantum particles can be manipulated for, including but not limited to, probing the wave-particle duality, testing quantum gravity, dark matter and energy search, Bell tests, detection of new particles, testing time evolution of quantum states in extreme conditions, condensed matter physics.

In another embodiment, quantum phased arrays can be utilized to distribute entanglement or any quantum information across multiple nodes of a quantum enhanced sensor network. By sharing quantum information among multiple nodes, quantum sensor networks with greater performance than their single sensor counterparts can emerge.

### Quantum Communications System

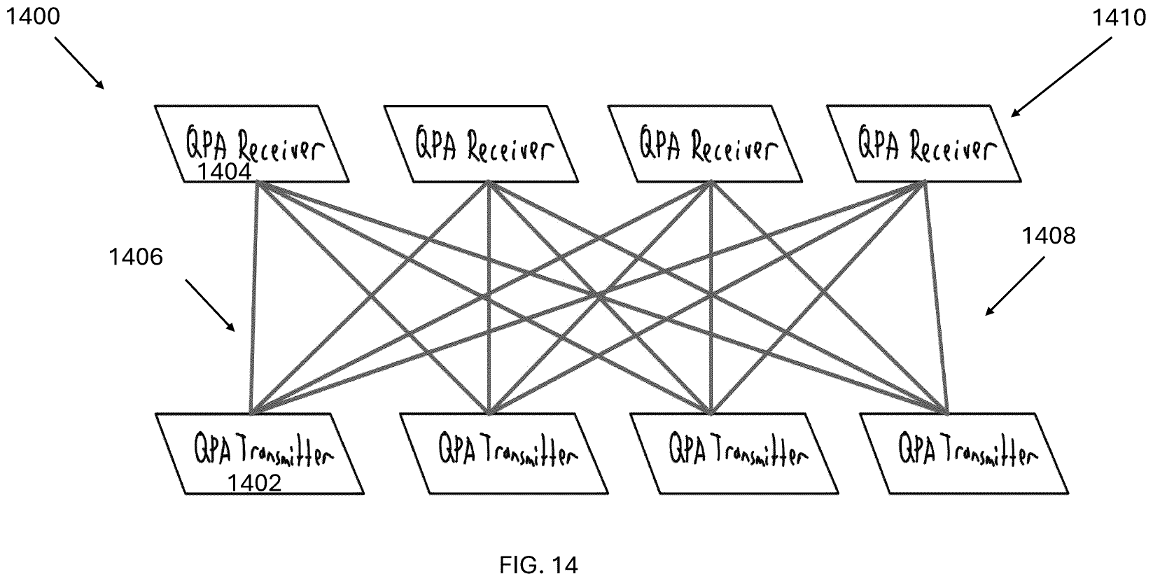

FIG. 14 illustrates an example of a quantum communication system 1400 with quantum phased arrays. This embodiment of a quantum communications network entails placing numerous quantum phased array transmitters 1402 and receivers 1404 in spatiotemporally distant coordinates. By utilizing the quantum state steering capability of quantum phased arrays, quantum phased array transmitters can route information to various quantum phased array receivers. Quantum phased array receivers, again leveraging quantum state steering, can spatiotemporally filter the environment to selectively receive quantum information from specific quantum phased array transmitter nodes. Fast switching between different point-to-point quantum links can be achieved with these systems. Any arbitrary quantum information link and quantum state distribution protocol can be employed with an arbitrarily large network of quantum phased arrays.

In one embodiment, the quantum communication system can be used for wireless quantum information transfer, enabling wireless quantum networks. These quantum phased array transceivers can be placed in various mobile environments such as, including but not limited to, in phones, vehicles, credit cards, identification tags, and electronic devices for wireless and mobile quantum systems. Spatiotemporal reconfigurability of quantum phased arrays also make them suitable to adapt to changes in mobile environments.

In another embodiment of the disclosed invention, the quantum communication system can be used to enable ground-to-satellite and satellite-to-satellite quantum links. These quantum phased arrays can be used as quantum repeaters to distribute entanglement between nodes separated by great distances in space or around the world. Loss reduction by routing quantum information through free space can enable a global quantum internet.

In another embodiment, the quantum communication system can be used to route information in wired networks, scaling the number of nodes significantly in ground-based quantum networks. By fast switching between different quantum nodes in a wired network, higher fidelity and rates of quantum information transfer can be achieved.

In another embodiment, the quantum communication system can be used to transduce quantum information between wireless and wired links. Quantum information in wired and wireless channels can be converted with quantum phased arrays to be sent from wireless links to wired links or vice versa.

In another embodiment, the quantum communication system can multiplex classical and quantum information to establish transfer of both classical and quantum information in the same point-to-point link. This multiplexing can be done by, including but not limited to, spatial, temporal multiplexing or encoding the quantum information in a quantum observable not modulated by classical information encoding.

In another embodiment, the quantum communication system can be utilized to distribute timing information across multiple nodes of a network for clock synchronization. The quantum enhancement acquired by employing quantum-enhanced timing distribution protocols will enable larger-scale distributed networks with shared timing and phase information. These networks can be, including but not limited to, satellite constellations, coherent arrays, distributed sensor networks, distributed computing networks, and Internet-of-Things devices.

In another embodiment, the quantum communication system can be utilized for quantum-secure communications. This quantum security can be achieved by employing various quantum cryptography protocols such as, including but not limited to, quantum key distribution and quantum teleportation. These quantum phased array based quantum secure transceivers can be used to distribute fundamentally secure information between different nodes in a communications network.

In another embodiment, quantum phased array based quantum secure transceivers can be used to establish wireless quantum secure links for, including but not limited to, credit card authentication, RFID, monetary transactions. These mobile quantum-secure information transfer can enable quantum finger prints associated with each device, secured from the environment preventing theft and eavesdropping of the information encoded in the quantum finger print.

In another embodiment, entanglement distribution and quantum information transfer between nodes can be leveraged to transfer energy from a source location to target location by applying classically informed unitaries at the target location via the quantum energy teleportation protocol.

### Quantum Simulation System

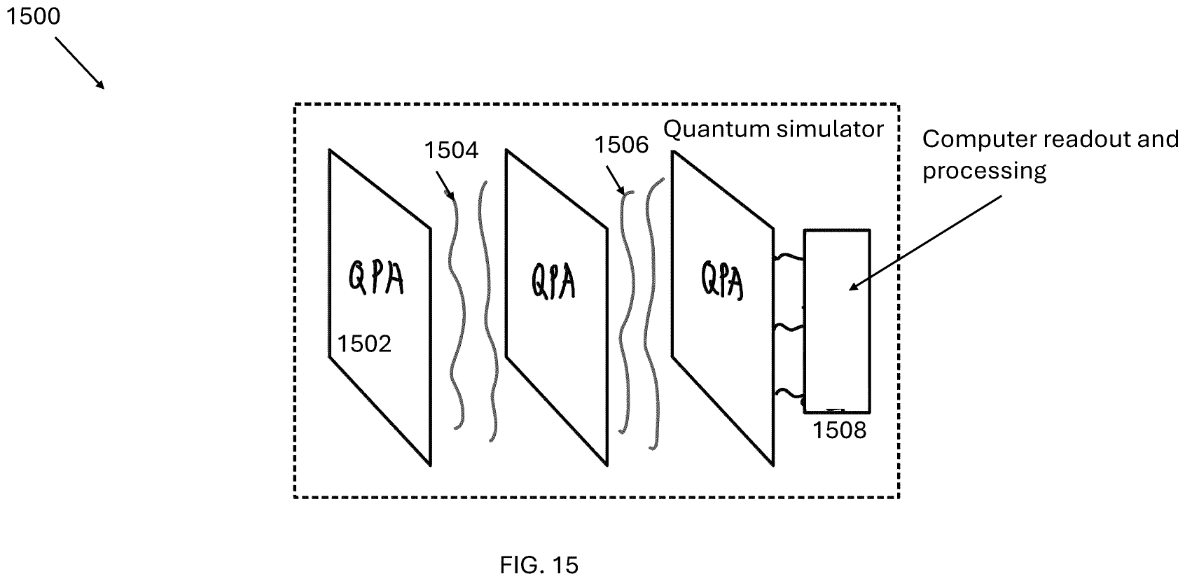

FIG. 15 illustrates an example of a quantum simulation system 1500 with quantum phased arrays. By cascading multiple quantum phased arrays arbitrary quantum states can be time evolved and observed in a quantum phased array system.

In one embodiment, this quantum simulation system can be used to prepare certain states representing interactions in, including but not limited to, quantum chemistry, condensed matter physics, quantum gravity, quantum field theory. These prepared states can be evolved through a network of quantum gates to observe the results with greater computational performance than classical computers.

In another embodiment, this quantum simulation system can be used for experimental physics demonstrations in quantum gravity, wormhole teleportation, Standard Model tests.

In another embodiment, faster simulation time of quantum simulation can be leveraged to develop models for, including but not limited to, materials, particle interactions, and chemical reactions.

### Quantum Computing System

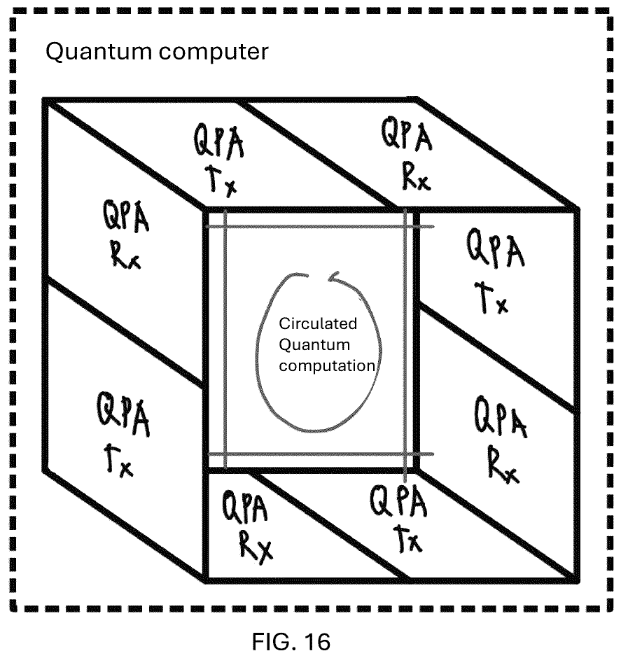

FIG. 16 illustrates an example of a quantum computing system 1600 with quantum phased arrays QPA. In this embodiment, the quantum computer comprises a network of quantum phased arrays QPA Tx, QPA Rx that receive (Rx), manipulate, and transmit (Tx) arbitrary wavefunctions. By utilizing the quantum field engineering functionality of quantum phased arrays, quantum modes, or qumodes, these arbitrary wavefunctions can be engineered to generate entanglement and superposition. In one embodiment, this entanglement and superposition generation can be done with single particle input states generated via material nonlinearities. Generating and utilizing entanglement exponentially increases the computational performance of the quantum computer as more particles are added and the system Hilbert space increases in dimension due to tensor products of density matrices. In another embodiment, qumodes can be encoded as quantum bits, or qubits.

In one embodiment of the disclosed invention, this quantum computer can utilize the Quantum Fourier Transform operation of free space to realize universal matrix multiplication. Supplying non-Gaussian input states, quantum phased array based quantum computer can do universal quantum computation.

In another embodiment, quantum Fourier transform from spatiotemporal propagation either in spatial or spectral configurations can be used to do a novel scheme of quantum computation, named diffractive quantum computing. Diffractive elements in the spatiotemporal propagation medium can be used to generate entanglement and superposition for arbitrary wavefunction manipulation and generation. By utilizing quantum field engineering of quantum phased arrays, universal quantum computing can be achieved.

In another embodiment, quantum phased array system can do universal quantum computing by employing reconfigurable measurements with non-Gaussian input states for measurement-based quantum computing.

In another embodiment, quantum phased array system can do universal quantum computing by employing single particle detectors and universal matrix multiplication for fusion-based quantum computing.

In other embodiments, various quantum computing protocols can be used for manipulating qumodes or qubits for universal quantum computing, such as including but not limited to, Deutsch's algorithm, Deutsch-Jozsa algorithm, Shor's algorithm, and Simon's algorithm.

In another embodiment, the quantum phased array can realize a quantum circuit as an ansatz and utilize variation quantum eigensolver method to realize a quantum computation for quantum machine learning.

In other embodiments, any quantum machine learning protocol can be employed to realize quantum machine learning. In one embodiment, free space can be used as a circuit element for diffractive quantum machine learning.

In other embodiments with quantum atomic phased arrays, Rydberg atom quantum computing can be achieved. In other embodiments with quantum ionic phased arrays, ion trapped quantum computing can be achieved. In other embodiments with quantum photonic phased arrays, linear optical quantum computing can be achieved. In other embodiments with other particles, any quantum computer with any particle can be realized due to the general purpose quantum field engineering capability of quantum phased arrays.

A quantum phased array transmitter and receiver in addition to a reconfigurable propagation medium are detailed.

### II. Working Example: A Free-Space Quantum Information Processor on Chip

Here we demonstrate a compact, room-temperature and mobile quantum optoelectronic system on a silicon photonic chip that can establish a wireless quantum link and engineer quantum states over a free-space channel. With this system, we showcased multi-mode imaging with squeezed light over 32 modes for quantum sensing, free-space routing of quantum information for quantum communications, and Gaussian quantum gates for quantum computing applications.

The freespace-to-chip link was robust after alignment and was enabled by a large active area metamaterial aperture with low-loss coupling. An array of self-stable coherent receivers was used to downconvert the quantum optical information into radio-frequency (RF) for coherent readout. A combination of programmable photonic processing in the optical domain and coherent RF processing in the electronic domain enables Gaussian quantum operations, which can be extended to non-Gaussian operations with non-Gaussian sources.

With this system, which is a specific realization of what we envision as future mobile quantum devices, we showcased multi-mode imaging with squeezed light for quantum sensing, routing of quantum information between different free-space channels for quantum communications, and implementation of Gaussian quantum information processing for quantum computing. Furthermore, we characterized a single channel of the large-scale quantum photonic integrated circuit (PIC) with integrated electronics to illustrate the opportunities in the holistic design of quantum and classical integrated circuits. These systems, which we name “quantum phased arrays”, can enable easy-to-deploy, low-cost and room-temperature quantum links without the need for prior infrastructure, leading to the proliferation of quantum information technologies.

### 1. Quantum Phased Array Chip

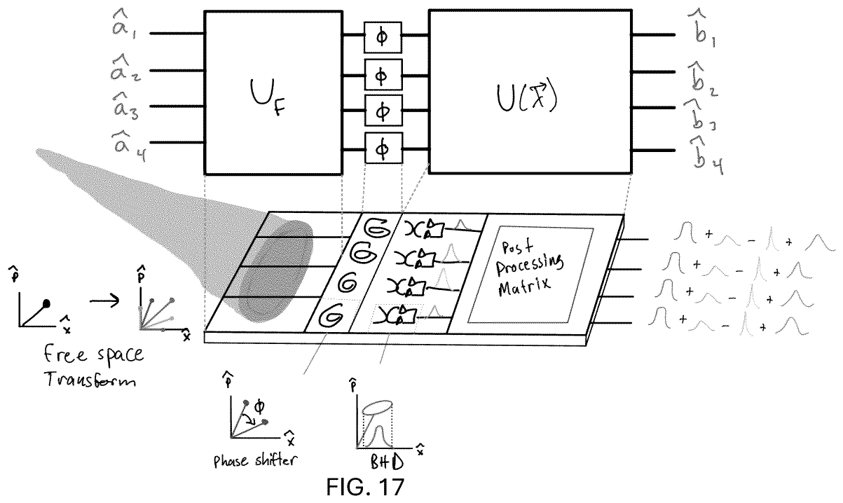

As shown in FIG. 17, the evolution of a state in the QPA transceiver is as follows. An arbitrary quantum state is put into a coherent superposition across an array of modes. Each mode is modulated in some basis followed by propagation in free space. After propagation, the state is accepted by an array of quantum coherent receivers, and each mode is again modulated. The resulting output modes are read out immediately or after coherent processing. This state evolution can be modeled with the quantum phase-space formulation (see theory section).

While QPAs can be built on any platform suitable for processing and detecting quantum fields, we showcase this technology on an integrated photonic platform, specifically using a silicon photonics process, to showcase the capability of operating at room temperature, robustness against quantum decoherence, ease of scaling, and path towards hybrid or monolithic integration of photonics and electronics.

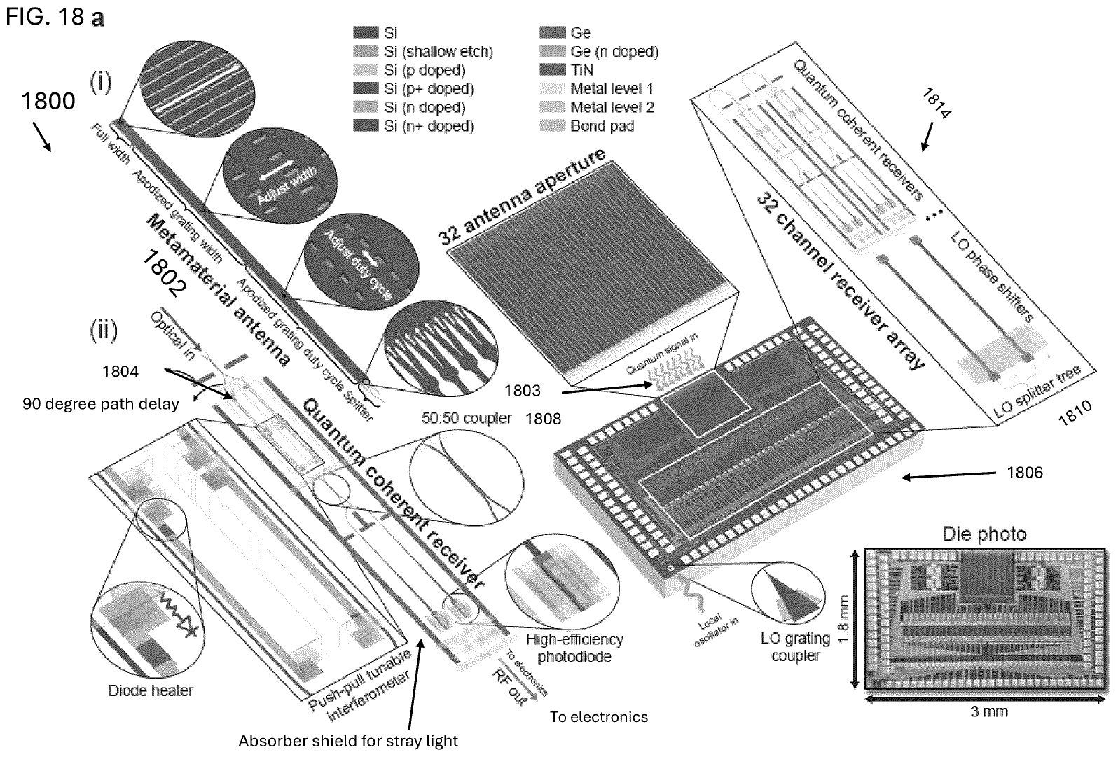

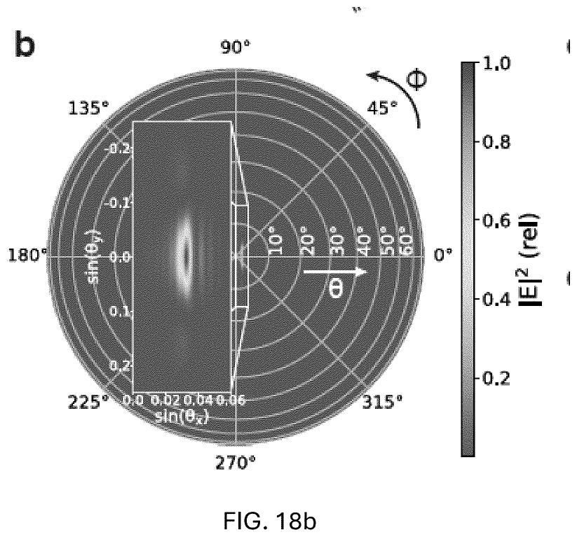

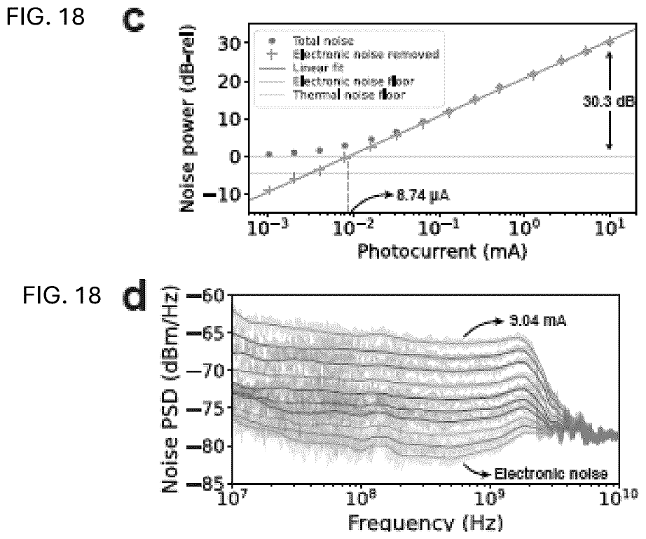

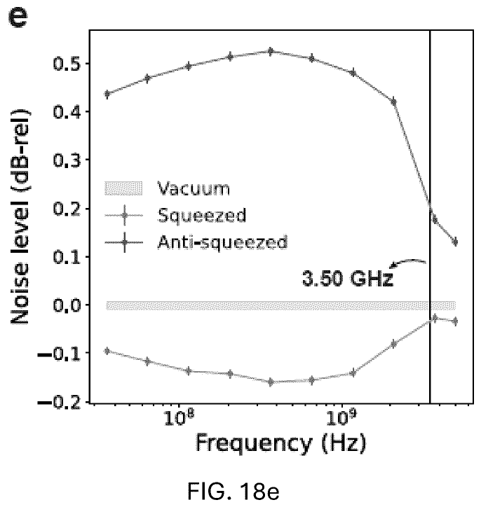

The QPA receiver chip was designed in-house and was fabricated in a commercial silicon photonics foundry. As seen in FIG. 18, the QPA has 32 channels capable of imaging and processing quantum states propagating in free space up to 32 spatial modes.

As illustrated in FIG. 18, low-loss free-space-to-chip coupling was enabled by a large-area fully-filled aperture comprised of 32 nanophotonic metamaterial antennas 1802 (MMAs) that couple a collimated beam in free-space to the single-mode waveguides 1804 on chip 1806. Each MMA is 600×16.7 μm² in footprint with a sufficiently large effective aperture suitable for low-loss coupling from free space to chip with commercial off-the-shelf collimators. This minimizes the geometric loss for low-loss free-space-to-chip coupling, a limitation in conventional nanophotonic antenna designs. The resulting antenna design has a simulated radiation efficiency of 3.78 dB, and the simulated 3D radiation pattern is shown in FIG. 18. After fabrication, the antenna was characterized on an automatic alignment stage. As seen in FIG. 18, the simulated and measured radiation patterns follow closely. The discrepancies between the measurements and the simulation can be attributed to the reflections from the silicon dioxide-substrate and silicon dioxide-air interfaces and the wavefront distortion of the collimator. Off-the-shelf fiber collimators are available for beam diameters greater than 200 μm. For a collimated beam with 200 μm diameter, the total geometric loss of 8 and 21 antenna apertures was 1.95 and 3 dB, respectively. This is at least an order of magnitude lower than previously reported on-chip aperture designs and is sufficiently low to interface free-space quantum optical setups with quantum photonic integrated circuits.

The waveguides after the antennas are path-length matched and are connected to 32 quantum coherent receivers (QRX). Each receiver consists of an interferometer 1808 that mix the received quantum optical state with a strong coherent state named the local oscillator (LO) followed by balanced photodiodes. The LO is coupled to chip with a grating coupler and split into 32 channels with a 1:32 splitter tree 1810. Each channel hosts a thermooptic phase shifter (TOPS) 1812 for phase tuning the LO and another TOPS is added before LO splitting for a global phase shift across all channels 1814. The performance specifications of a QRX are its shot noise clearance (SNC), LO power knee (Pₖₙₑₑ), common-mode rejection ratio (CMRR), 3-dB bandwidth and shot-noise limited bandwidth (fₛₕₒₜ). QRX is characterized in two configurations with two TIA designs (see Methods), one used as the high bandwidth configuration optimal for communications, and another used as the high shotnoise clearance configuration optimal for sensing. These two TIAs are designed to be interchangeably used with the photonic chip to overcome the fundamental tradeoff between SNC and bandwidth in balanced homodyne detection.

The CMRR is measured by setting the MZI to unbalanced (100:0 coupling) and balanced (50:50 coupling) settings while injecting amplitude-modulated LO to the QRX. The CMRR is then defined as

$$CMRR = 10 {log}_{10} ( \frac{2 {P}_{b a l}}{{P}_{u n b}} ) ,$$

where P_{bal} and P_{unb} are the balanced and unbalanced RF power measurements, respectively. In both configurations, the QRX has a CMRR of −92.3 dB at 300 kHz. The total shot noise clearance (SNC) and LO power knee can be measured by integrating the noise spectral density across the 3-dB bandwidth of the QRX at different LO powers. In high SNC (high bandwidth) configuration, the QRX has an SNC of 30.7 (13.1) dB and a Pₖₙₑₑ of 9.43 (468) μW (see Extended Data). The shot-noise limited bandwidth is measured by injecting LO at maximum power before saturating the PDs and finding the bandwidth across which the QRX is shot-noise limited as seen in FIG. 18. In high SNC (high bandwidth) configuration, the QRX has a 3-dB bandwidth of 10.4 MHz (2.57 GHZ) and a shotnoise limited bandwidth of 522 MHz (3.5 GHZ) (see Extended Data). To showcase the high-speed measurements achievable with the QRX in high-bandwidth configuration, squeezed light was measured with a single QRX channel up to the shot-noise-limited bandwidth 3.5 GHz as seen in FIG. 18d along with the output noise spectra at different LO photocurrents. To ensure the noise floor is dominated by shot noise, SNC response integrated across the 2.57 GHz3—dB bandwidth is fitted with a line showing a close to unity 0.9994±0.008 slope.

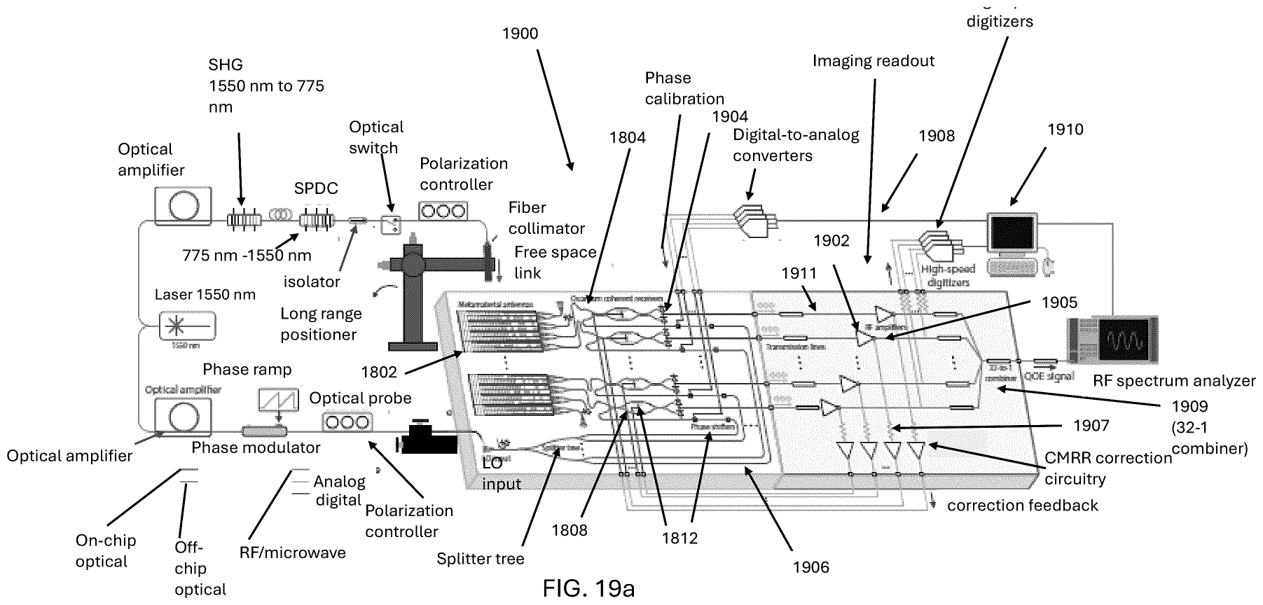

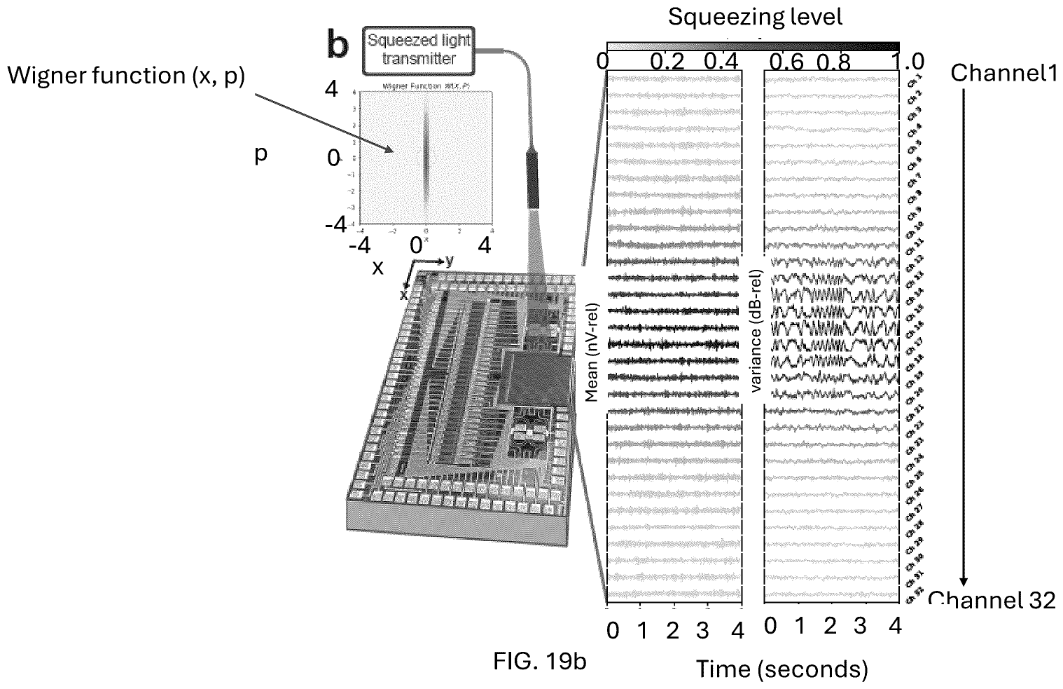

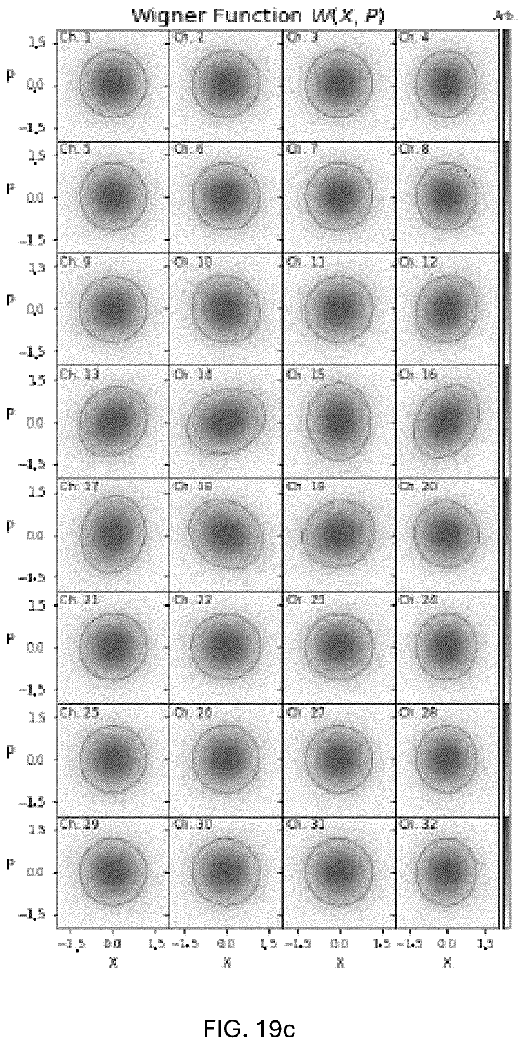

In the subsequent experiments, the QPA chip 1900 was packaged with electronics on a custom-designed printed circuit board (PCB). As shown in FIG. 19, the QPA chip was wirebonded to a PCB interposer to fan out 104 electronic read-out and control lines. The interposer is plugged into a radio-frequency (RF) motherboard with 500 coplanar waveguide outputs. The RF PCB that was used hosts a 32-channel array of transimpedance amplifiers (TIAs) 1902 in high SNC configuration and an auto-CMRR correction circuit. The auto-CMRR correction circuit extracts an error signal from the TIA output, probing the imperfect CMRR of each QRX and feeds it back to each respective push-pull MZI to continuously correct the CMRR of the QRX array. This ensures signal shot-noise limited measurements throughout the operation of the chip, maximizing the effective efficiency of the homodyne measurement. A high-speed coaxial cable assembly is used for the electronic connections to and from the motherboard. 32 read-out lines from the TIAs are connected to 32 digitizers, and 32 control lines are connected to 32 digital-to-analog converters (DACs) for independent phase tuning each QRX. Two photodiodes routed to the two antennas on the sides of the aperture, and the photodiode routed to the LO coupler are connected to current meters for continuous monitoring of signal and LO alignment on the chip.

### 2. Squeezed Light Imaging

We first operated the QPA chip as a phase-sensitive 32-pixel quantum optical camera. A squeezed vacuum state is generated off-chip using off-the-shelf fibercoupled components (see Methods) at a central wavelength of 1550 nm. The squeezed light is sent to a fiber collimator and is transmitted to the chip over free space. The quantized electromagnetic field incident to the chip aperture can be decomposed into positive and negative frequency components, Ê=Ê₊+Ê₋, where Ê₊=Ê₋^{†}. For a normally incident field, the positive frequency component can be described in the paraxial limit as,

$${\hat{E}}_{+} ( x , y ) = \sqrt{\frac{ℏ ω}{2 {ε}_{0} V}} {\sum }_{n , m} {\hat{a}}_{n m} {u}_{n m} ( x , y ) \qquad ( 1 )$$

where ω is the frequency of the light, L is the longitudinal quantization length, and (x,y) are the transverse coordinates of the plane parallel to the aperture. The field is summed is over a complete set of independent modes. For a mode indexed by (n, m), âₙₘ is the annihilation operator and uₙₘ(x,y) is the associated mode function, where [âₙₘ^{†}, â_{n′m′}]=δ_{n,n}δ_{m,m′} obeys the bosonic commutation relations and {uₙₘ(x,y)} forms a set of orthonormal basis functions. Here we take {uₙₘ(x,y)} to be the Hermite-Gaussian basis functions corresponding to the transverse electromagnetic field (TEM) modes.

The collimated squeezed light arriving to the aperture has a Gaussian amplitude profile with 200 μm beam diameter, corresponding to the TEM₀₀ mode. The light is split across the 32 antennas in the aperture. The annihilation operator for the field coupled onto the j th antenna is,

$${\hat{a}}_{j} = {\sum }_{n , m} {\hat{a}}_{nm} \int {ε}_{j} ( x , y ) {u}_{n m} ( x , y ) dxdy \qquad ( 2 )$$

where εⱼ(x,y) is the mode function for j th antenna. Here, the â₀₀ mode is in a squeezed vacuum state and all other modes are in the vacuum state. The mode function for a single antenna is shown in XX. Each antenna field mode is sent to a QRX, which outputs a current proportional to the quadrature \hat{X}ⱼ(θⱼ)=(âⱼe^{iθ}^{ⱼ}+âⱼ^{†}e^{-iθ}^{ⱼ})/\sqrt{2}, where θⱼ is the phase relative to the LO.

To image the squeezed light across the aperture, we collected quadrature statistics of each antenna field mode over various phases by applying a 0.5 Hz 2π phase ramp on LO. The currents from each channel were acquired over 5 s at a sampling rate of 130 Msamples/s and binned over XX samples to obtain the mean and variance. For channel j, the mean current is (îⱼ(θⱼ) [symbol] =0 and the variance of the current is,

$$〈 Δ {{\hat{ι}}_{j} ( {θ}_{j} )}^{2} 〉 = {g}_{j} [ {η}_{j} ( {e}^{- 2 r} {cos}^{2} {θ}_{j} + {e}^{2 r} {sin}^{2} {θ}_{j} ) + 1 - {η}_{j} ] , \qquad ( 3 )$$

where gⱼ is a proportionality constant that depends on the TIA gain and LO amplitude, ηⱼ is the net efficiency of channel j, including effects of optical transmission efficiency, detection efficiency, and geometric loss. The time evolution of the quadrature mean and variance of the 32 antenna modes is shown in FIG. 19b. Thermal fluctuations in the fiber optics of the source give rise to nonlinear phase modulations on top of the 0.5 Hz phase ramp, which are coherent across all 32 channels.

The quadratures \hat{X}(θ) acquired over a full 2π rotation form a tomographically complete set of observables suitable for reconstruction of the density matrix. The phase ramp, in addition to the thermal phase modulations, provide multiple rotations in the phase space for quantum state tomography (QST). To perform QST, we identified a section of the time series where the phase ramp is approximately uniform. The phase-quadrature pairs in this section are used to reconstruct the density matrix of the quantum state received by each QRX by applying an iterative maximum likelihood estimation algorithm. To correct for the optical transmission efficiency and detection loss (ηₜη_{d}), an inverted Bernouilli transformation was also applied to the reconstructed density matrix [8]. The Wigner functions of the reconstructed density matrices of the state generated by the source and the states received by all 32 channels are shown in FIG. 19c.

### 3. Wavefunction Engineering Embodiment

Wavefunction engineering with the QPA chip entails manipulating quantum states by leveraging free-space propagation and coherent processing of an arbitrary selection of modes on chip. This can be identified as a quantum analog of wavefront engineering with classical electromagnetic waves. This cohesion between free-space and on-chip processing of quantum states can allow various protocols to be implemented for generating quantum states with high-dimensional entanglement while utilizing the quantum Fourier transform readily available from free-space propagation. Scalability of integrated quantum photonics and electronics in addition to interfacing with free-space optics enables wavefunction engineering to be utilized for sensing and communications applications, while quantum information processing on-chip to be leveraged for possible novel applications such as quantum Internet of Things and quantum edge computing.

A single QPA transmitter, receiver, or transceiver can be used to demonstrate wavefunction engineering. To that end, we showcased the chip as a QPA receiver utilizing wavefunction engineering to filter spatial modes to accept squeezed light arriving at the aperture at a selected angle. A squeezed vacuum state was again generated off-chip, and the state was transmitted to the chip with an off-the-shelf fiber collimator with 200 μm beam diameter. The collimator was placed on a positioner and was centered on the chip aperture. The positioner allows the collimator to be rotated with the center of rotation staying on the aperture. This allows the impinging beam's angle of arrival to be set to a desired value. Thermooptic phase tuning was used to set the quadrature phase of each spatial mode. For the correct phase settings, the original mode function can be recreated, a quantum analog of classical beamforming.

To find the correct phase settings, a calibration step was added before the experiment. The calibration step for a certain angle of arrival starts with sending a coherent state to the aperture at that angle. A phase ramp around the same frequency as the squeezed light sideband is applied to the LO and the downconverted RF signals are read out. The RF signal from each QRX is coherently combined with a 32-to-1 RF power combiner and is sent to a signal analyzer. Then an optimization algorithm with orthogonal phase mask sweeps was used to find the optimal phase settings that maximize the tone with the phase ramp modulation frequency. Furthermore, since each TOPS can sweep 21 phase, the mode function of the quantum field at the aperture can be engineered. Coupled with photonic-electronic processors and nonlinear sources, wavefunction engineering generalizes the functionalities of classical phased arrays to the non-classical domain and showcases free-space manipulation of quantum states.

### 4. Optoelectronic Processing

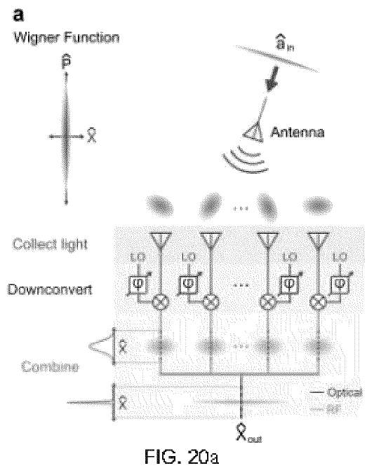

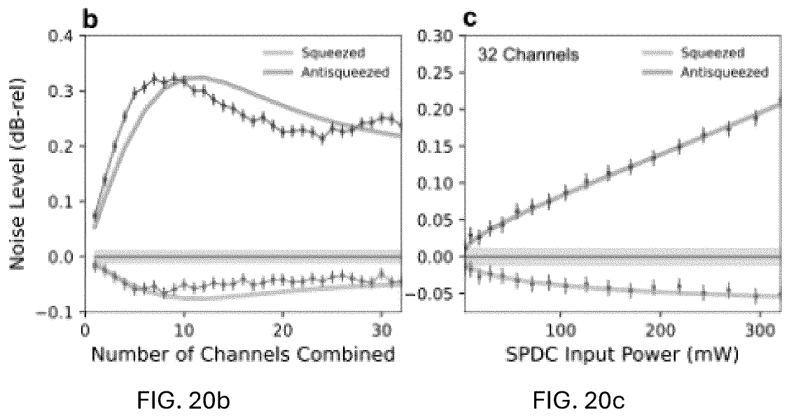

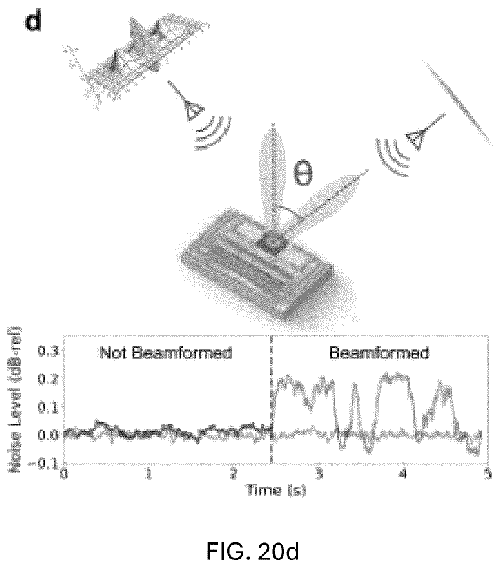

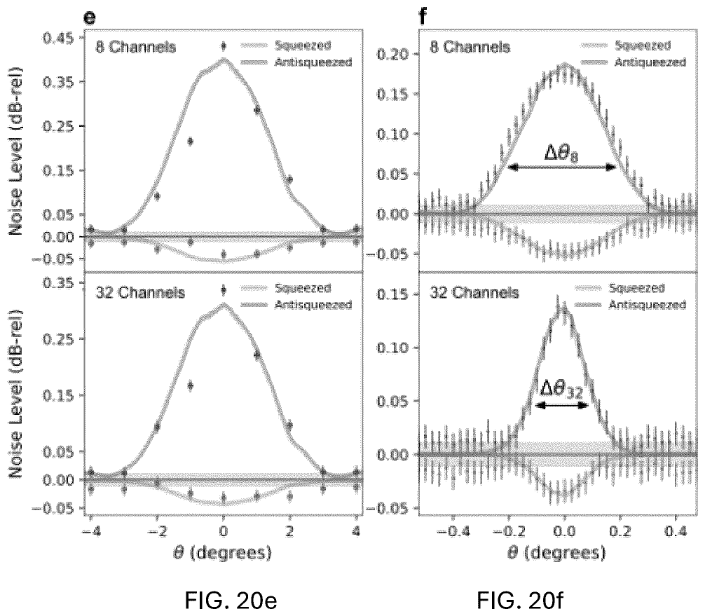

While all-optical processing of the modes can be done to engineer quantum states, any additional photonic components will lead to extra loss that will degrade the state fidelity. While this can be mitigated with optical parametric amplification before optoelectronic down conversion, the effect of optical loss can still be significant, especially for large-scale quantum photonic circuits. Therefore, instead of all-optical processing, we demonstrated optoelectronic processing by first down converting all 32 modes with coherent receivers all operating with quantum-limited sensitivity and then using an RF circuit for coherent processing of the down converted quadrature statistics while maintaining phase coherence across all channels. To demonstrate beamforming, we used a configurable set of RF power combiners to interfere an arbitrary combination of RF channels. FIG. 20b shows the trend in (anti-) squeezing noise levels as we increase the number of combined channels. The peak occurs when 8 channels are combined which agrees with the expected peak from theory. An SPDC pump power sweep is also performed when all 32 channels are combined to extract the efficiency after SPDC. The efficiency is-17 dB which has an extra-2 dB loss due to the errors in phase calibration (see Methods). After this measurement, the collimator is rotated with the QPA aperture staying as the center of rotation. For each set collimator angle, the beamforming algorithm is run to optimize the phases for constructive interference of quadrature statistics. The phase errors from the algorithm are monitored with the simultaneous readout of all channels with the imaging setup. FIG. 20e shows the QPA field-of-view measurement with squeezed light overlaid with the radiation pattern of a single antenna. There is a close resemblance of the single antenna radiation pattern to the beamformed quantum radiation pattern in FIG. 20d.

### 5. Gaussian Quantum Computing

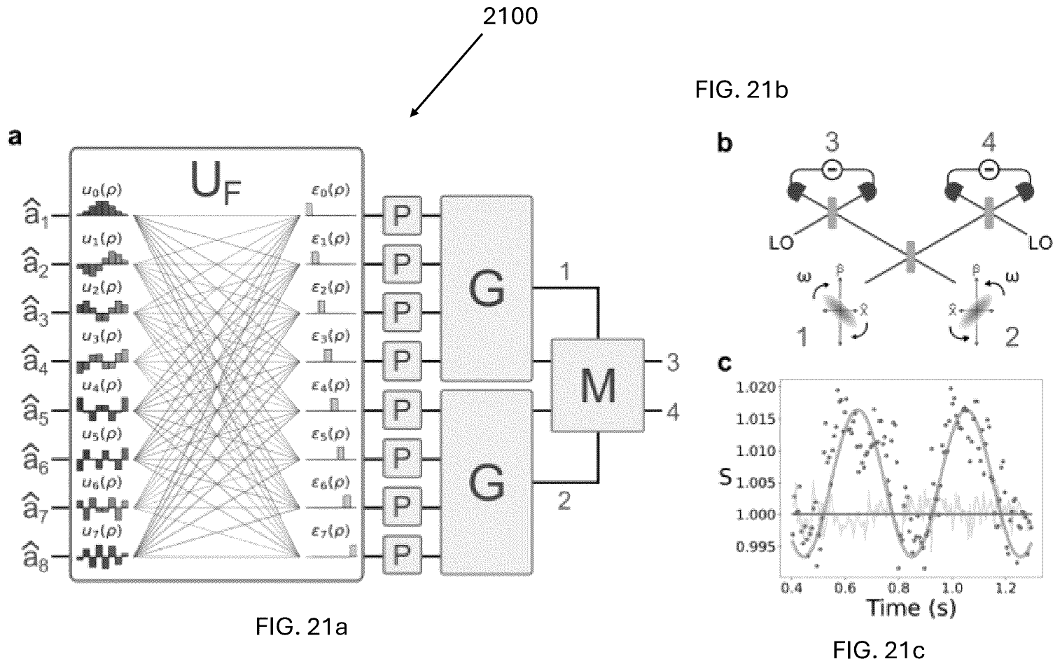

FIG. 21a illustrates a quantum circuit architecture. UF corresponds to unitary implemented by free space, i.e. the change of basis matrix mapping the spatial modes of the input state {uₙ(ρ)} to the antenna modes {εₘ(ρ)}, where ρ here represents the transverse spatial coordinates in the plane parallel to the aperture of the chip (perpendicular to the direction of propagation of the quantum field incident to the chip) [2]. The colored lines represent the matrix element of UF: U_{F,mn}=∫εₘ(ρ)uₙ(ρ)εₘ(ρ)dρ. The matrix elements of U_{F} could be engineered by inverse design of the mode functions of the metamaterial antenna design introduced in this work. After U_{F}, there is an array of phase shifters followed by gains matrices G and M which are implemented here in RF. For this demonstration, we generate entanglement by interfering beamforming on each half of the receiver array, then interfering the two resulting beamformed modes in RF, resulting in an two-mode cluster state. FIG. 21b. Equivalent optical circuit implementation. Here 1 and 2 correspond to the two beamformed squeezed modes. This is the standard linear optical implementation of Gaussian two-mode cluster state generation, which we are able to implement in RF [3]. The interference corresponds to the RF matrix operation M. FIG. 21c illustrates entanglement generation. After the interference, we measure the inseparability of the generated entangled state, which is that S=Var(\hat{p}₄−\hat{x}₃)+Var(\hat{p}₃−\hat{x}₄)<1, where 3 and 4 denote the output modes of the quantum circuit [4]. We observed the sinusoidal signature expected when the phases of the input modes are rotated simultaneously, corresponding to a rotation of the measurement basis of the output modes. We observed S<1 which corresponds to an EPR violation [5]. A two-mode cluster state is related to the maximally entangled EPR state by a Fourier transform. [6]

### Advantages and Improvements

Wavefunction engineering shows a novel way to engineer quantum states. Paves the way toward diffractive quantum information processing.
Quantum beamforming resolves the loss issue due to diffraction in free-space quantum links.
Optoelectronic processing using RF/microwave circuits after optoelectronic down conversion enables novel quantum processor architectures.
Metamaterial antennas designs can be optimized for loss, tailored wavefunction engineering and fuse with quantum metasurfaces body of work for compact free space QIP
Silicon-based integration of quantum optoelectronic components enables large-scale coherent quantum systems with low cost, small footprint and high yield. Leveraging the economies of scale in both design and manufacturing, co-designed quantum optoelectronic systems will democratize quantum technologies, paving the way toward consumer applications.
Low-loss free-space-to-chip coupling enables interfacing quantum integrated circuits with free-space channels, realizing quantum links without the need for existing infrastructure.
Transmitter QPAs implemented in a nonlinear optical platform, e.g. thin film lithium niobate, could enable all chip-to-chip quantum links with high degrees of squeezing, and could overcome losses through parametric amplification [9].
Similar to how phased arrays scaled to enable longer distance and higher gain links, quantum phased arrays can be scaled to enable wireless quantum communications and sensing.
QPA transmitter and receiver chips can be arrayed and enable point-to-point free space quantum links, in particular satellite-to-satellite, satellite-to-ground, ground-to-ground, and mobile quantum communication systems.
Large bulk implementations of QPAs can be arrayed and used for quantum-enhanced metrology, e.g. directionally measuring gravitation waves for LIGO, bringing quantum enhancement to astronomy in a similar role that phased array technology has played for radio astronomy and communications.

### 6. QPA Chip Design

Loss, decoherence, and uncontrolled external noise sources are significantly detrimental to quantum systems. Therefore, the QPA chip was designed to minimize loss, parasitic interference, and optical and electrical crosstalk. A significant source of loss for free-space-coupled integrated systems is the illumination loss due to a significant mode mismatch between an impinging beam and the chip aperture.

Hence, to maximize the effective aperture of the nanophotonic metamaterial antenna, the coupling strength per area needs to be minimized. To achieve this, various antenna designs were simulated, and a parallelized waveguide antenna-based design was determined to have the lowest coupling strength per area while abiding by the design rules from the foundry. 16 waveguide antennas were parallelized with periodic gratings in the regions between the waveguides. The 0.82 μm wide waveguides keep a single mode confined throughout the length of the antenna so that the wavefront of the coupled light across the cross-section of the antenna is flat. At the beginning of each antenna (y=0 μm), a mode converter comprising a linear taper coupling the light from 0.82 μm waveguides to 0.5 μm waveguides and a Y-junction-based 16-to-1 combiner tree combining the flat wavefront in the antenna into a single mode propagating in the 0.5 μm wide waveguide used to route the light on chip. The thickness of all of the waveguide layers was 220 nm. To minimize the free-space-to-chip coupling losses and maximize the modal overlap between the freespace beam and the scattering profile of the antenna, three grating regions with apodized coupling strengths were designed as seen in FIG. 18. The antenna design was verified using an FDTD simulation. The aperture of the chip comprises 32 of these antennas with 17.5 μm pitch to ensure sufficiently low crosstalk between antennas. To aid with the free-space alignment of an impinging field to the chip and ensure uniform electromagnetic response across all 32 antennas, 2 antennas are added on each side of the aperture, resulting in 36 total antennas. One antenna on each side is connected to a standard grating coupler for all-optical alignment and the other antenna is connected to a photodiode for optoelectronic alignment.

The QRX design comprises a Mach-Zehnder interferometer (MZI) made out of two 50:50 directional couplers and two doped phase shifters. Each phase shifter is 100 μm long, comprising a resistive heater made out of doped silicon with 1 kΩ resistance and a diode in series with 1 V forward voltage. The MZI is configured in a push-pull configuration to extend the tuning range of the coupling coefficients and is designed to provide sufficient tuning with +5 V drivers. One branch of the MZI includes an optical delay with 90° phase shift to set the nominal coupling of the MZI to 50:50. Fabrication imperfections such as changes in the gap in the coupling region of the couplers and surface roughness in the waveguides between the couplers shift this ideal 50:50 coupling randomly throughout the chip. The tunability of the MZIs allows correcting for these imperfections to set 50:50 coupling. MZIs are also designed to be symmetric to ensure a high extinction ratio.

After the MZI, the waveguides are adiabatically tapered to connect to a Ge photodiode with >20 GHz bandwidth at 3 V reverse bias, >76% quantum efficiency, and <100 nA dark current. The QRX is surrounded by a Ge shield to absorb stray light propagating in the chip substrate and prevent it from coupling to the photodiodes as classical noise. Each QRX output is connected to a separate on-chip pad to be interfaced with a transimpedance amplifier (TIA) and subsequent electronics for parallelized RF processing.

The LO is coupled to chip with a grating coupler and is sent to each QRX through a 1-to-32 splitter tree. Each Y-junction in the splitter tree has a 0.28 dB loss, and the grating coupler has a 3.5 dB loss. Before the splitter tree, a directional coupler on the LO waveguide is present to couple 1% of LO power to a photodiode for LO power monitoring. After the splitter tree, a TOPS is included in each branch to tune the quadrature phase of each channel for the analog calibration of the system. There is also an additional TOPS before the splitter tree for a global phase shift of the LO across all channels. Each TOPS for phase tuning is 315 μm long, comprising a resistive heater made out of titanium nitride above the waveguide with 5700 resistance. The half-wave power (P_{π}) of the TOPS is 33.8 mW and the electro-optic bandwidth (f_{3 dB}) is 100 KHz.

### 7. Antenna Characterization

To characterize the nanophotonic metamaterial antenna for the experiments, a far-field and a near-field measurement was done. For the far-field measurement, the chip was placed on an auto-alignment stage with its y-axis parallel to the y-axis of the positioner holding the collimator. A collimator is used to illuminate the antenna with a 200 μm collimated beam diameter. The collimator is centered on the antenna so that the modal overlap between the impinging beam and the antenna is maximized, and the angle of the collimator is scanned in two orthogonal planes (ThX and ThZ) to measure the orthogonal radiation patterns. Light coupled into the antenna is routed to a photodiode away from the antenna to prevent optical crosstalk. The photocurrent from the photodiode is used to characterize the far-field radiation pattern of the antenna. The antenna is also simulated in Lumerical FDTD to compare with the measurement. In the simulation, a planar wave impinging on the antenna is assumed to simplify the simulation.

For the near-field measurement, a lensed fiber with 1 μm spot size and 12 μm working distance was placed on the positioner and aligned also in z direction to focus the light onto the surface of the antenna. The positioner is scanned in x and y directions to illuminate different parts of the antenna. The optical power coupled into the antenna is read out through a photodiode. By scanning the location of the lensed fiber throughout the antenna, the near-field scattering profile of the MMA is reconstructed. The antenna is also simulated in Lumerical FDTD to compare with the measurement. The coupled power into the antenna follows closely with the simulation up to y=150 μm but falls off steeper than the simulation between y=150-300 μm. This is most likely due to the variations in thickness of the layers resulting in a larger coupling strength per area than what was simulated. However, these thickness variations can be accounted for in future designs to further increase the effective aperture. The geometric loss calculations can be done by using the following modal overlap equation.

$$η = \frac{{\vert \int {E}_{1}^{*} {E}_{2} dA \vert}^{2}}{\int {\vert {E}_{1} \vert}^{2} dA \int {\vert {E}_{2} \vert}^{2} dA} \qquad ( 14 )$$

where E₁ and E₂ are the electric field profile of the impinging beam and the electric field scattering profile of the antenna. Since the radiation pattern is diffractionlimited and doesn't feature any significant grating lobes, we assume a flat phase front for the antenna scattering profile. For an optimally aligned 200 μm (400 μm) collimated beam with Gaussian amplitude distribution, the minimum geometric loss is 1.25 dB (2.21 dB) with the simulated scattering profile and 1.95 dB (3 dB) with the measured scattering profile. The minimum geometric losses for 200 μm (400 μm) beam diameters are achieved with 8 (21) antenna apertures. The discrepancy is again caused by the aforementioned difference in the coupling strength of the gratings. The beam diameter can also be tuned to minimize the geometric loss.

### 8. Quantum Coherent Receiver Characterization

In high bandwidth configuration, to maximize the optoelectronic bandwidth, the balanced PDs of the QRX are biased to −1 V, resulting in a PD bandwidth of >15 GHz. In high SNC configuration, to minimize the dark current and the noise coupling through the bias circuit, the balanced PDs are biased to 0 V, resulting in a PD bandwidth of >10 GHz.

### 9. Electronic Circuit Design

The interposer board was designed with a laser-milled cavity in the middle to place the QPA chip surrounded by pads with blind vias for high-density routing. The chip and the interposer are assembled so that the on chip pads are level and parallel with the on-board pads to shorten the bond wire length. The traces from the interposer pads to the TIA inputs on the motherboard are minimized and spaced sufficiently apart with a coplanar waveguide (CPW) structure to ensure minimal electronic crosstalk. The discrete TIA circuit on the motherboard utilizes a FET-input operational amplifier (op-amp) with resistive feedback. The op-amp IC (LTC6269-10) has a 4 GHz gain-bandwidth product and is used with a 50 kΩ feedback resistor. The capacitance of the feedback trace is used to ensure sufficient phase margin while keeping the closed-loop gain greater than 10 since the op-amp is decompensated. A 500 resistor is placed in series with the output of the TIA for impedance matching and to dampen any oscillations from capacitive loading. With these design considerations, the 32-channel QRX array achieves on average 24.2 dB SNC and 44.5 MHz bandwidth.

The DC voltage across the TIA feedback resistor is used as the error signal for the CMRR correction and drives an integrator circuit with a chopper-stabilized opamp IC (OPA2187) for low voltage offset, flicker noise, and offset drift. The integrator unity-gain bandwidth is set close to DC to dampen any oscillations in the autoCMRR correction feedback. The output of the integrator is fed back to the MZI on the QPA chip to continuously correct the CMRR. The polarity of the integrator is designed to match with the polarity of the push-pull MZI so that the correction circuit is topologically protected to maximize the CMRR whether the imperfections lead to negative or positive DC current from the balanced photodiodes. The correction was limited by the dark current of each QRX and the offset voltage at the input of each integrator, but offset correction can be applied to each integrator to further maximize the CMRR. Without offset correction, the improvements in CMRR of all 32 QRX were measured.

### 11. Squeezed Light Generation

To generate squeezed light, continuous wave light from a fibercoupled 1550 nm laser (OEWaves) was split into a signal path and a local oscillator (LO) path. The light in each path is amplified by an erbium-doped fiber amplifier (PriTel EDFA). After amplification in the signal path, the 1550 nm coherent light is upconverted to 775 nm by a periodically poled lithium niobate (PPLN) waveguide (HC Photonics) via second harmonic generation. The upconverted light is used as a continuouswave (CW) pump for Type 0 spontaneous parametric down-conversion (SPDC) with another PPLN waveguide (HC Photonics), which generates squeezed vacuum light at 1550 nm. The squeezed vacuum signal was sent to a fiber optic collimator (component details), which transmits the light over free space with an approximately flat phase front to the chip aperture. After amplification in the LO path, the 1550 nm coherent light is sent to a bulk lithium niobate electro-optic modulator (component details) for phase control. The phase-modulated local oscillator is sent to a cleaved fiber which is grating-coupled to the LO input of the chip. Polarization controllers on the collimator and LO fiber are used to optimize coupling efficiency to the chip.

### 12. System Losses and Scaling

Minimizing the losses in quantum photonic systems is crucial to prevent the decoherence of engineered quantum optical states and for the successful deployment of quantum optoelectronic technologies. The QPA system was designed for this purpose by optimizing the components to minimize loss as much as possible. On-chip signal losses are the antenna radiation efficiency of 3.80 dB, waveguide propagation loss of 0.20 dB, photodiode quantum efficiency of 1.50 dB, and negligible loss from homodyne efficiency. This results in a total on-chip loss of 5.50 dB. In addition to on-chip losses, there is also the illumination loss due to mode mismatch between the aperture and the collimated beam and the insertion loss of the collimator. The illumination loss comprises the geometric loss of the aperture and the efficiency of the calibration algorithm. The on-chip losses were verified experimentally by sending 200 μm collimated beam to the chip aperture after setting all QRXs to the unbalanced (100:0) configuration and summing all QRX currents. For 0.452 mW input power, the output current is 0.0615 muA, resulting in an insertion loss of 8.66 dB. For a 200 μm collimated beam, the geometric loss is 2.21 dB and the insertion loss of the collimator is <0.8 dB. De-embedding these losses from the measurement, the on-chip losses are measured to be 5.65 dB, which agrees well with the expected 5.50 dB loss.

Tabletop fiber-optic setup with the squeezed light source also contributes loss to the system.

### 13. Chip Fabrication

The photonic chip was fabricated in the AMF 180-nm silicon-on-insulator (SOI) process. The process has two metal layers (2000-nm thick and 750-nm thick) for electronic routing, a titanium nitride heater layer, a 220-nm thick silicon layer, a 400-nm thick silicon nitride layer, germanium epitaxy, and various implantations for active devices. A process design kit (PDK) from the foundry was provided, and the final design was completed and verified using the KLayout software.

### REFERENCES FOR WORKING EXAMPLE

The following references are incorporated by reference herein:
[1] N. Gisin, G. Ribordy, W. Tittel, and H. Zbinden, Quantum cryptography, Reviews of modern physics 74, 145 (2002).
[2] G. Ferrini, J.-P. Gazeau, T. Coudreau, C. Fabre, and N. Treps, Compact gaussian quantum computation by multi-pixel homodyne detection, New Journal of Physics 15, 093015 (2013).
[3] P. van Loock, C. Weedbrook, and M. Gu, Building gaussian cluster states by linear optics, Physical Review A 76, 032321 (2007).
[4] S. Armstrong, J.-F. Morizur, J. Janousek, B. Hage, N. Treps, P. K. Lam, and H.-A. Bachor, Programmable multimode quantum networks, Nature communications 3, 1026 (2012).
[5] A. Einstein, B. Podolsky, and N. Rosen, Can quantummechanical description of physical reality be considered complete?, Physical review 47, 777 (1935).
[6] M. Yukawa, R. Ukai, P. Van Loock, and A. Furusawa, Experimental generation of four-mode continuous-variable cluster states, Physical Review A 78, 012301 (2008).
[7] M. Milanizadeh, S. SeyedinNavadeh, F. Zanetto, V. Grimaldi, C. De Vita, C. Klitis, M. Sorel, G. Ferrari, D. A. B. Miller, A. Melloni, and F. Morichetti, Separating arbitrary free-space beams with an integrated photonic processor, Light: Science & Applications 11, 197 (2022).
[8] T. Kiss, U. Herzog, and U. Leonhardt, Compensation of losses in photodetection and in quantum-state measurements, Phys. Rev. A 52, 2433 (1995).
[9] R. Nehra, R. Sekine, L. Ledezma, Q. Guo, R. M. Gray, A. Roy, and A. Marandi, Few-cycle vacuum squeezing in nanophotonics, Science 377, 1333 (2022).
[10] M. Beck, Quantum state tomography with array detectors, Physical Review Letters 84, 5748 (2000).

### III. Example Protocols and Algorithms for Control of the Phased Array for Free-Space Quantum Information Processing

### 1. Quantization of Electromagnetic Field

In the second quantization of the electromagnetic field, where a photon is interpreted as an elementary excitation of a normal mode of the field. The classical Hamiltonian of the electromagnetic field is expressed as the Hamiltonian of a harmonic oscillator:

$$H = \frac{1}{2} ( {p}^{2} + {ω}^{2} {q}^{2} )$$

For example, consider a radiation field confined to a 1D cavity along the z-axis with conducting walls at z=0 and z=L. The Hamiltonian for a single mode field that satisfies Maxwell's equations without sources is

$$H = \frac{1}{2} \int dV [ {ε}_{0} {E}_{x}^{2} ( z , t ) + \frac{1}{{μ}_{0}} {B}_{y}^{2} ( z , t ) ]$$

where

$${E}_{x} ( z , t ) = {( \frac{2 {ω}^{2}}{V {ε}_{0}} )}^{\frac{1}{2}} q ( t ) sin ( kz ) and {B}_{y} ( z , t ) = ( \frac{{μ}_{0} {ε}_{0}}{k} ) {( \frac{2 {ω}^{2}}{V {ε}_{0}} )}^{\frac{1}{2}} p ( t ) cos ( kz ) .$$

After identifying p and q for the classical system, we quantize the harmonic oscillator by taking p→\hat{p} and q→\hat{q}, where the operators \hat{q}, \hat{p} satisfy the commutation relation [\hat{q}, \hat{p}]=ihÎ. In terms of \hat{p} and \hat{q}, the annhilation/creation operators are

$$\hat{a} = {( 2 ℏω )}^{- 1 / 2} ( ω \hat{q} + i \hat{p} )$$

Finally, the corresponding electric and magnetic field operators are

$${\hat{E}}_{x} ( z , t ) = {E}_{0} ( \hat{a} + {\hat{a}}^{†} ) sin kz$$

The creation/annihilation operator corresponds to creates/annihilates a single photon. Since Ê can be found in terms of the creation/annihilation operators, it suffices to study the transformation of the QPA on â, which will take the place of the complex amplitude U from the classical analysis.

### 2. Imaging Protocols and Algorithms

In the far-field limit, the positive frequency component of a quantized electromagnetic field, along the plane parallel to aperture, can be expanded into a set of orthogonal field modes,

$${\hat{E}}^{( + )} ( ρ ) = ( \frac{2 πℏω}{L} ) {\sum }_{n} {\hat{a}}_{n} {ε}_{n} ( ρ ) \qquad ( 1 )$$

where âₙ (âₙ) is the annihilation (creation) operator for the nth field mode, satisfying the bosonic commutation relation [âₙ, âₘ^{†}]=δₘₙ. The coordinates are grouped into ρ, and can be spatial or spectral represent. The annihilation (creation) operator can be expressed in terms of the field quadrature operators as â=\hat{X}+i\hat{P}(â^{†}=\hat{X}−i\hat{P}). The field mode functions {εₙ(ρ)} form set of orthonormal basis functions, [1]

$$\int {ε}_{n} ( ρ ) {{ε}_{m} ( ρ )}^{′} d ρ = {δ}_{nm} \qquad ( 2 )$$

The field is coupled to N pixels on the chip through N antennas contained in the chip aperture. Each pixel consists of an antenna and a quantum coherent receiver. The pixels have associated mode functions,

$${ε}_{n}^{′} ( ρ ) = \{ \begin{matrix}{𝒩}_{n} {A}_{n} ( ρ ) , & ρ ∈ {S}_{n} \\ 0 , & otherwise\end{matrix} \qquad ( 3 )$$

which form the pixel basis {ε′ₙ(ρ)}. In Eq. 17, Aₙ(ρ) is the mode function for the nth antenna, [symbol] is a normalization coefficient such that ∫ε′ₙ(ρ)ε′*ₘ(ρ)=δₙₘ, and Sₙ represent the set of coordinates corresponding to the nth pixel. We note that the pixel basis does not form a complete orthonormal basis for finite N, i.e. it does not span the full Hilbert space of the input mode functions. Coupling the field onto the chip maps the input modes onto the pixel modes,

$${\sum }_{n} {\hat{a}}_{n} {ε}_{n} ( ρ ) \to {\sum }_{n} {\hat{a}}_{n}^{′} {ε}_{n}^{′} ( ρ ) \qquad ( 4 )$$

The pixel modes {âₙ} are related to the input modes by a change-of-basis transformation U,

$${\hat{a}}_{n}^{′} = {\sum }_{m} {U}_{mn} {\hat{a}}_{m} , {U}_{mn} = \int {ε}_{m} ( ρ ) {{ε}_{n}^{′} ( ρ )}^{*} d ρ \qquad ( 5 )$$

$${\hat{a}}_{n}^{′} = {\sum }_{m} {U}_{mn} {\hat{a}}_{m} , {U}_{mn} = {\int }_{{S}_{n}} {A}_{n} ( x , y ) {u}_{m} ( x , y ) dxdy$$

where Aₙ(x,y) is the mode function for the nth antenna.

The pixel modes are sent to a quantum coherent receiver, where they are mixed with a local oscillator in a coherent state and measured with a balanced homodyne detector. The current at the output of each detector is amplified by a trans-impedance amplifier. The effective field transformation is But can't invert U since pixel basis doesn't span the continuous space

$${\hat{a}}_{n}^{″} = {g}_{n} {e}^{i ( {θ}_{n} + {ϕ}_{n} )} {\hat{a}}_{n}^{′} = {g}_{n} {e}^{i {φ}_{n}} {\sum }_{m} {U}_{mn} {\hat{a}}_{m} \qquad ( 6 )$$

where gₙ is the net gain and φₙ=θₙ+ϕₙ is the net phase. Here, θₙ is the LO phase and on is a phase picked up along the pixel path. The field transformation can be summarized in matrix notation as

$${\vec{a}}_{out} = G Δ U {\vec{a}}_{in} \qquad ( 7 )$$

where \vec{a}ᵢₙ=(â₁, â₂, . . . )^{T}, \vec{a}ₒᵤₜ=(â″₁, â″₂, . . . )^{T}, U is the change-of-basis matrix with matrix elements Uₘₙ (note that it need not be a square matrix), Δ is a diagonal matrix with the net pixel phases along the diagonals (Δₘₙ=e^{iφ}^{ₙ}δₘₙ), and G is a diagonal matrix with the net pixel gains along the diagonals (Gₘₙ=gₙδₘₙ)·2

The current îₙ at the output of the nth pixel mode is proportional to the quadrature observable of â″ₙ,

$${\hat{ι}}_{n} ∝ {g}_{n} {\sum }_{m} {U}_{mn} {\hat{X}}_{m} ( {φ}_{n} ) \qquad ( 8 )$$

where \hat{X}(φ)=\hat{X} cos φ+\hat{P} sin φ. The mean and variance of the currents are proportional to,

$$〈 {\hat{ι}}_{n} 〉 = {g}_{n} {\sum }_{m} {U}_{m n} 〈 {\hat{X}}_{m} ( {φ}_{n} ) 〉 \qquad ( 9 )$$

$$\begin{matrix}〈 Δ {\hat{ι}}_{n}^{2} 〉 = {( {g}_{n} )}^{2} {\sum }_{m , {m}^{′}} {U}_{m n} {U}_{{m}^{′} n} Cov ( {\hat{X}}_{m} ( {φ}_{n} ) , {\hat{X}}_{{m}^{′}} ( {φ}_{n} ) ) & ( 10 ) \\ = {( {g}_{n} )}^{2} {\sum }_{m} {( {U}_{m n} )}^{2} Var ( {\hat{X}}_{m} ( {φ}_{n} ) ) & ( 11 ) \\ + {( {g}_{n} )}^{2} {\sum }_{m \neq {m}^{′}} {U}_{m n} {U}_{{m}^{′} n} Cov ( {\hat{X}}_{m} ( {φ}_{n} ) , {\hat{X}}_{{m}^{′}} ( {φ}_{n} ) ) & ( 11 )\end{matrix}$$

### 3. Application to Imaging of Spatial Imaging of Squeezed Light in Working Example

In the spatial domain, the normalized field operator for the field incident to the aperture can be expanded in the Hermite-Gaussian basis, corresponding to the free space solutions of Maxwell's equations,

$$\hat{a} ( x , y ) = {\sum }_{m} {\sum }_{n} {u}_{m n} ( x , y ) {â}_{m n} \qquad ( 12 )$$

$${u}_{m n} ( x , y ) = {g}_{m} ( x ) {g}_{n} ( y ) \qquad ( 13 )$$

$${g}_{m} ( x ) = {( \frac{1}{{σ}^{2} {π}^{2}} )}^{1 / 4} \sqrt{\frac{1}{{2}^{n} m 42}} {H}_{m} ( \frac{x - μ}{σ} ) {e}^{- \frac{{( x - μ )}^{2}}{2 {σ}^{2}}} \qquad ( 14 )$$

where

$${H}_{m} ( x ) = {( - 1 )}^{m} {e}^{{x}^{2}} \frac{{d}^{m}}{d {x}^{m}} {e}^{- {x}^{2}}$$

is the m th Hermite polynomial satisfying,

$${\int }_{- ∞}^{∞} {H}_{m} ( x ) {H}_{n} ( x ) {e}^{- {x}^{2}} d x = \sqrt{π} {2}^{m} m 42 {δ}_{m n} \qquad ( 15 )$$

The set of {uₙₘ(x,y)} form an orthonormal basis that spans L²(R²),

$${\int }_{- ∞}^{∞} {u}_{m n} ( x , y ) {u}_{{n}^{′} {n}^{′}} ( x , y ) dxdy = {δ}_{m , {m}^{′}} {δ}_{n , {n}^{′}} \qquad ( 16 )$$

For the pixel basis, we consider uniform antenna functions, such that

$${ε}_{n}^{′} ( x , y ) = \{ \begin{matrix}1 / \sqrt{{w}_{x} {w}_{y} ,} & x , y ∈ {S}_{n} \\ 0 , & otherwise\end{matrix} \qquad ( 17 )$$

where wₓ, w_{y} are the x and y widths of the rectangular pixels with surface areas wₓw_{y}. Note that the pixel basis {ε′ₙ(x,y)} spans only a subspace V⊂L²(R²). The pixel basis functions are the model functions corresponding to the N pixel modes, {âₙ}. We consider a squeezed state in the first Gaussian mode, â₀₀. The mode is converted to an input mode â_{in,1} in the N dimensional pixel mode space as

$${â}_{00} \to {â}_{in , 1} = {\sum }_{i = 1}^{N} {c}_{1 , i} {â}_{i}^{′} \qquad ( 18 )$$

$$\begin{matrix}{c}_{1 , i} = {\int }_{- ∞}^{∞} {ε}_{i}^{′} ( x , y ) {u}_{00} ( x , y ) dxdy = \frac{1}{\sqrt{{w}_{x} {w}_{y}}} {\int }_{{S}_{i}} {u}_{00} ( x , y ) dxdy & ( 19 ) \\ = \frac{1}{\sqrt{{w}_{x} {w}_{y}}} {\int }_{- {w}_{y} / 2}^{{w}_{y} / 2} {g}_{0} ( y ) d y {\int }_{{x}_{i} - {w}_{x} / 2}^{{x}_{i} + {w}_{x} / 2} {g}_{0} ( x ) d x & ( 20 )\end{matrix}$$

The mode â_{in,1} forms the first mode of the N input mode basis {â_{in,n}} with corresponding vectors {\vec{cₙ}} hat span the pixel mode basis {âₙ}. The input modes can be found by binning the first N Hermite-Gaussian functions {gₙ(x)} over the N pixels, then performing a GramSchmidt orthonormalization. The resulting vectors \vec{c}ₙ resemble discreted Hermite-Gaussian functions. Thus, we start with squeezed state in the first input mode â_{in,1} and vacuum modes in the remaining N−1 modes. We group the input modes into a vector \vec{a}ᵢₙ=(â_{in,1}, . . . , â_{in,N})^{T}. The input modes are mapped to the pixel modes through a change of basis matrix U,

$${\vec{a}}^{′} = U {\vec{a}}_{i n} \qquad ( 21 )$$

where U=(\vec{c}₁, . . . , \vec{c}_{N}) is an N by N unitary matrix.

Since [symbol] \hat{X}( ) [symbol] =0 for vacuum states,

$$〈 {î}_{n} 〉 = 0 \qquad ( 22 )$$

Since the vacuum modes are uncorrelated from the squeezed modes, [3]

$$\begin{matrix}〈 {Δ î}_{n}^{2} 〉 ∝ {( {g}_{n} )}^{2} {\sum }_{m} {( {U}_{m n} )}^{2} Var ( {\hat{X}}_{m} ( {φ}_{n} ) ) & ( 23 ) \\ = \frac{1}{4} {( {g}_{n} )}^{2} {( {U}_{1 n} )}^{2} ( {e}^{- 2 r} {cos}^{2} ( {φ}_{n} ) + {e}^{2 r} {sin}^{2} ( {φ}_{n} ) ) & ( 23 ) \\ + \frac{1}{4} {( {g}_{n} )}^{2} {\sum }_{m > 1} {( {U}_{m n} )}^{2} & ( 23 )\end{matrix}$$

From orthonormality, Σₘ|Uₘₙ|²=1. By defining the mode-matching efficiency as ηₙ=|U₁ₙ|², we can express the current variance as

$$〈 Δ {\hat{ι}}_{n}^{2} 〉 ∝ \frac{1}{4} {( {g}_{n} )}^{2} ( {η}_{n} ( {e}^{- 2 r} {cos}^{2} ( {φ}_{n} ) + {e}^{2 r} {sin}^{2} ( {φ}_{n} ) ) + 1 - {η}_{n} )$$

### 4. Beamforming

Beamforming comprises finding the optimal gains for a given desirable input mode.

Next, we combine the currents:

$${\hat{ι}}_{tot} = {\sum }_{n} {\hat{ι}}_{n} = {\sum }_{n , m} {g}_{n} {U}_{m n} {\hat{X}}_{m} ( {φ}_{n} ) \qquad ( 24 )$$

The effective transformation on the field is:

$${\hat{a}}_{tot} = {\sum }_{n} {â}_{n}^{″} = {\sum }_{n} {\sum }_{m} {â}_{m} {U}_{m n} {g}_{n} {e}^{i {φ}_{n}} \qquad ( 25 )$$

Next, let's choose gₙ=Uⱼₙ, and align all the phases so that φₙ=φ. Then the effective field transformation is:

$$\begin{matrix}{â}_{tot} = {\sum }_{n} {\sum }_{m} {â}_{m} {U}_{m n} {U}_{j n} {e}^{i {φ}_{n}} & ( 26 ) \\ = {\sum }_{m} {â}_{m} {\sum }_{n} {U}_{m n} {U}_{j n} {e}^{i {φ}_{n}} & ( 27 ) \\ = {\sum }_{m} {â}_{m} {e}^{i φ} {\sum }_{n} {U}_{m n} {U}_{j n} & ( 28 )\end{matrix}$$

$$= {\sum }_{m} {â}_{m} {e}^{i φ} {δ}_{m j} \qquad ( 29 )$$

$$= {\hat{a}}_{j} {e}^{i φ} \qquad ( 30 )$$

This only true in the small pixel limit, when ΣₙUₘₙUⱼₙ=δₘⱼ Thus, by aligning the phases across the pixels and selecting the gains to match a particular spatial mode function, we can isolate a particular mode of the field, thus “beamforming”. The combined currents are input to an ESA. The total current îₜₒₜ is the proportional to the quadrature of âtot,

$${î}_{tot} = {\hat{X}}_{j} ( φ ) \qquad ( 31 )$$

### 5. Digital Beamforming

Alternatively, we can do the combination all in post processing. We measure the currents from each detector from a scope, which results in a current distribution with mean [symbol] îₙ [symbol] and variance [symbol] Δîₙ² [symbol] for each detector. Then in post-processing we combine each of the pixel distributions into a total distribution, with mean and variance:

$$〈 {\hat{ι}}_{tot} 〉 ∝ {\sum }_{n , m} {g}_{n} {U}_{m n} 〈 {\hat{X}}_{m} ( {φ}_{n} ) 〉 \qquad ( 32 )$$

$$〈 Δ {\hat{ι}}_{tot}^{2} 〉 ∝ {\sum }_{n , m , {n}^{′} , {m}^{′}} {g}_{n} {g}_{{n}^{′}} {U}_{m n} {U}_{{m}^{′} {n}^{′}} ( {\hat{X}}_{m} ( {φ}_{n} ) , {\hat{X}}_{{m}^{′}} ( {φ}_{{n}^{′}} ) ) \qquad ( 33 )$$

Since the different input modes are independent, the covariances are zero unless m=m′:

$$〈 Δ {\hat{ι}}_{tot}^{2} 〉 = {\sum }_{n , {n}^{′} , m} {g}_{n} {g}_{{n}^{′}} {U}_{m n} {U}_{m {n}^{′}} ( {\hat{X}}_{m} ( {φ}_{n} ) , {\hat{X}}_{m} ( {φ}_{{n}^{′}} ) ) \qquad ( 34 )$$

Note that the sum of the coefficients is:

$${\sum }_{n , {n}^{′} , m} {g}_{n} {g}_{{n}^{′}} {U}_{m n} {U}_{m {n}^{′}} {\sum }_{n , {n}^{′}} {g}_{n} {g}_{{n}^{′}} {δ}_{n {n}^{′}} = {\sum }_{n} {( {g}_{n} )}^{2} \qquad ( 35 )$$

As with analog beamforming, if we choose gₙ=Uⱼₙ and φₙ=φ, we measure a current distribution corresponding to the mean and variance of the desired input modes corresponding to \hat{X}ⱼ(φ). In the small pixel limit

$$〈 {\hat{ι}}_{tot} 〉 ∝ {\sum }_{n , m} {U}_{j n} {U}_{m n} 〈 {\hat{X}}_{m} ( φ ) 〉 = {\sum }_{m} {δ}_{m j} 〈 {\hat{X}}_{m} ( φ ) 〉 = 〈 {\hat{X}}_{j} ( φ ) 〉 \qquad ( 36 )$$

$$〈 Δ {\hat{ι}}_{tot}^{2} 〉 ∝ {\sum }_{n , {n}^{′} , m} {U}_{j n} {U}_{j {n}^{′}} {U}_{m n} {U}_{m {n}^{′}} Cov ( {\hat{X}}_{m} ( {φ}_{n} ) , {\hat{X}}_{m} ( {φ}_{{n}^{′}} ) ) \qquad ( 37 )$$

$$= {\sum }_{m} {δ}_{m j} {δ}_{m j} Cov ( {\hat{X}}_{m} ( φ ) , {\hat{X}}_{m} ( φ ) ) \qquad ( 38 )$$

$$= Var ( {\hat{X}}_{j} ( φ ) ) \qquad ( 39 )$$

### 6. Pixel by Pixel Combination

Now we consider what happens if we combine the currents pixel by pixel, so we have a partial sum over the array. The effective field after summing N out of Nₜₒₜ pixels is,

$${\hat{a}}_{sum} = {\sum }_{n = 1}^{N} {\sum }_{m} {\hat{a}}_{m} {U}_{m n} {g}_{n} {e}^{i {φ}_{n}} \qquad ( 40 )$$

Note that,

$${\sum }_{n = 1}^{N} {\sum }_{m} {\vert {U}_{m n} {g}_{n} {e}^{i {φ}_{n}} \vert}^{2} = {\sum }_{n = 1}^{N} {( {g}_{n} )}^{2} {\sum }_{m} {( {U}_{m n} )}^{2} = {\sum }_{n = 1}^{N} {( {g}_{n} )}^{2} \qquad ( 41 )$$

The normalized field is âₛᵤₘ/Σₙ₌₁^{N}(gₙ)².

Vacuum State Consider a field where all the modes are in the vacuum state. For vacuum state,

$$〈 0 \vert \hat{X} ( θ ) \vert 0 〉 = 0 \qquad ( 42 )$$

$$( 0 \vert Δ {\hat{X} ( θ )}^{2} \vert 0 〉 = \frac{1}{4} \qquad ( 43 )$$

For one pixel, [symbol] îₙ [symbol] =0, and

$$〈 Δ {\hat{ι}}_{n}^{2} 〉 = \frac{1}{4} {( {g}_{n} )}^{2} {\sum }_{m} {( {U}_{m n} )}^{2} \qquad ( 44 )$$

After summing up to N pixels, (îₛᵤₘ=Σₙ^{N}îₙ), then [symbol] îₛᵤₘ [symbol] =0, and

$$〈 Δ {\hat{ι}}_{sum}^{2} 〉 = \frac{1}{4} {\sum }_{n , {n}^{′} , m} {g}_{n} {g}_{{n}^{′}} {U}_{m n} {U}_{{mn}^{′}} = {{\sum }^{N}}_{n} {( {g}_{n} )}^{2} \qquad ( 45 )$$

Coherent light. Next, consider a field where the first Gaussian mode is in a coherent state and the remaining modes are in the vacuum state. For a coherent state,

$$〈 α \vert \hat{X} ( θ ) \vert α 〉 = 〈 α \vert \frac{\hat{a} {e}^{- i θ} + {\hat{a}}^{†} {e}^{i θ}}{\sqrt{2}} \vert α 〉 = \vert α \vert cos θ \qquad ( 46 )$$

$$〈 α \vert Δ {\hat{X} ( θ )}^{2} \vert α 〉 = \frac{1}{4} \qquad ( 47 )$$

For one pixel, the mean is,

$$〈 {\hat{ι}}_{n} 〉 = {g}_{n} {\sum }_{m} {U}_{m n} 〈 {\hat{X}}_{m} ( {φ}_{n} ) 〉 = {g}_{n} {U}_{1 n} \vert α \vert cos {φ}_{n} \qquad ( 48 )$$

and the variance is the same as for the vacuum field,

$$〈 Δ {\hat{ι}}_{n}^{2} 〉 = \frac{1}{4} {( {g}_{n} )}^{2} {\sum }_{m} {( {U}_{m n} )}^{2} \qquad ( 49 )$$

After summing up to N pixels, the mean is,

$$〈 {\hat{ι}}_{sum} 〉 = {\sum }_{n}^{N} {g}_{n} {U}_{1 n} \vert α \vert cos {φ}_{n} \qquad ( 50 )$$

and the variance is the same as the for the vacuum field,

$$〈 Δ {\hat{ι}}_{sum}^{2} 〉 = \frac{1}{4} {\sum }_{n , {n}^{′} , m} {g}_{n} {g}_{{n}^{′}} {U}_{m n} {U}_{{mn}^{′}} = {{\sum }^{N}}_{n} {( {g}_{n} )}^{2} \qquad ( 51 )$$

We see that we can maximize the mean current, i.e. beamform, when all the pixels constructively interfere (align the phases) such that φₙ=φ,

$$〈 {\hat{ι}}_{sum} 〉 = \vert α \vert cos φ {\sum }_{n}^{N} {U}_{1 n}^{2} \qquad ( 52 )$$

When N=Nₜₒₜ, in the small pixel limit, we recover the total field: [symbol] îsum [symbol] =|α| cos φ.

Squeezed Light. Next, consider a field where the first Gaussian mode is in a squeezed vacuum state and the remaining modes are in the vacuum state. For a squeezed vacuum state,

$$〈 ξ \vert \hat{X} ( θ ) \vert ξ 〉 = 0 \qquad ( 53 )$$

$$〈 ξ \vert Δ {\hat{X} ( θ )}^{2} \vert ξ 〉 = \frac{1}{4} ( {e}^{- 2 r} {cos}^{2} θ + {e}^{2 r} {sin}^{2} θ ) \qquad ( 54 )$$

For one pixel, the mean is the same as that of the vacuum state, [symbol] îₙ [symbol] =0, and the variance is,

$$〈 Δ {î}_{n}^{2} 〉 = \frac{1}{4} {( {g}_{n} )}^{2} {( {U}_{1 n} )}^{2} ( {e}^{- 2 r} {cos}^{2} ( {φ}_{n} ) + {e}^{2 r} {sin}^{2} ( {φ}_{n} ) ) + \frac{1}{4} {( {g}_{n} )}^{2} {\sum }_{m > 1} {( {U}_{mn} )}^{2}$$

After summing up to N pixels, then the mean is the same as for the vacuum field, [symbol] îₛᵤₘ [symbol] =0, and

$$〈 {Δ î}_{sum}^{2} 〉 = \frac{1}{4} {\sum }_{n}^{N} {\sum }_{{n}^{′}}^{N} {g}_{n} {g}_{{n}^{′}} {U}_{1 n} {U}_{1 {n}^{′}} ( {e}^{- 2 r} cos ( {φ}_{n} ) cos ( {φ}_{{n}^{′}} ) + {e}^{2 r} sin ( {φ}_{n} ) sin ( {φ}_{{n}^{′}} ) )$$

$$〈 {Δ î}_{sum}^{2} 〉 = \frac{1}{4} {e}^{- 2 r} {\sum }_{n}^{N} {\sum }_{{n}^{′}}^{N} {g}_{n} {g}_{{n}^{′}} {U}_{1 n} {U}_{1 {n}^{′}} cos ( {φ}_{n} ) cos ( {φ}_{{n}^{′}} ) + \frac{1}{4} {e}^{2 r} {\sum }_{n}^{N} {\sum }_{{n}^{′}}^{N} {g}_{n} {g}_{{n}^{′}} {U}_{1 n} {U}_{1 {n}^{′}} sin ( {φ}_{n} ) sin ( {φ}_{{n}^{′}} ) = \frac{1}{4} {\sum }_{n}^{N} {\sum }_{{n}^{′}}^{N} {\sum }_{m > 1}^{N} {g}_{n} {g}_{{n}^{′}} {U}_{mn} {U}_{{mn}^{′}}$$

Here, beamforming corresponds to constructively interfering the squeezed light by aligning the phases, setting φₙ=φ.

$$〈 {Δ î}_{sum}^{2} 〉 = \frac{1}{4} ( {\sum }_{n}^{N} {( {g}_{n} )}^{2} ) ( {e}^{- 2 r} {cos}^{2} ( φ ) + {e}^{2 r} {sin}^{2} ( φ ) ) {\sum }_{n}^{N} {\sum }_{{n}^{′}}^{N} \frac{{g}_{n} {g}_{{n}^{′}} {U}_{1 n} {U}_{1 {n}^{′}}}{{\sum }_{n}^{N} {( {g}_{n} )}^{2}} \qquad ( 56 )$$

$$+ \frac{1}{4} ( {\sum }_{n}^{N} {( {g}_{n} )}^{2} ) {\sum }_{n}^{N} {\sum }_{{n}^{′}}^{N} {\sum }_{m > 1} \frac{{g}_{n} {g}_{{n}^{′}} {U}_{mn} {U}_{{mn}^{′}}}{{\sum }_{n}^{N} {( {g}_{n} )}^{2}} \qquad ( 56 )$$

Since ΣₘΣ_{n,n′}gₙg_{n′}UₘₙU_{mn′}=Σₙ^{N}(gₙ)², we can define,

$${η}_{N} = \frac{1}{{\sum }_{n}^{N} {( {g}_{n} )}^{2}} {\sum }_{n}^{N} {\sum }_{{n}^{′}}^{N} {g}_{n} {g}_{{n}^{′}} {U}_{1 n} {U}_{1 {n}^{′}} = \frac{1}{{\sum }_{n}^{N} {( {g}_{n} )}^{2}} {( {\sum }_{n}^{N} {g}_{n} {U}_{1 n} )}^{2} \qquad ( 57 )$$

Then the variance simplifies to,

$$〈 {Δ î}_{sum}^{2} 〉 = ( {\sum }_{n}^{N} {( {g}_{n} )}^{2} ) ( \frac{1}{4} {η}_{N} ( {e}^{- 2 r} {cos}^{2} ( φ ) + {e}^{2 r} {sin}^{2} ( φ ) ) + \frac{1}{4} ( 1 - {η}_{N} ) ) \qquad ( 58 )$$

We see that as we add pixels and increase N, ON increases, therefore the squeezed light terms increase and the vacuum terms decrease. In particular, in the small pixel limit, if N=Nₜₒₜ and gₙ=U₁ₙ, then η_{N}=1.

Uniform Input Distribution Consider a uniform input distribution. Then U₁ₙ=1/\sqrt{Nₜₒₜ}. We choose uniform gains, so that gₙ=1. Then:

$${η}_{N} = \frac{1}{N} {( N / \sqrt{{N}_{tot}} )}^{2} = N / {N}_{tot} \qquad ( 59 )$$

Gaussian Input Distribution. Next, consider a Gaussian input distribution:

$${u}_{1} ( x ) = {( \frac{1}{π {σ}^{2}} )}^{\frac{1}{4}} {e}^{- \frac{1}{2} {( \frac{x - μ}{σ} )}^{2}} \qquad ( 60 )$$

Let L be the total length of the aperture. The size of each pixel is L/Nₜₒₜ where Nₜₒₜ is the total number of pixels. The center of the aperture correspond to x=0, and we consider a Gaussian beam centered with the aperture (μ=0). Then the matrix element is:

$${U}_{1 n} = \sqrt{\frac{{N}_{tot}}{L}} {\int }_{{S}_{n}} {u}_{1} ( x ) dx \qquad ( 61 )$$

First, choose uniform gains, so that gₙ=1. Then the efficiency is:

$${η}_{N} = \frac{1}{N} {( {\sum }_{n}^{N} \sqrt{\frac{{N}_{tot}}{L}} {\int }_{{S}_{n}} {u}_{1} ( x ) dx )}^{2} \qquad ( 62 )$$

$$= \frac{{N}_{tot}}{NL} {( {\sum }_{n}^{N} {\int }_{{S}_{n}} {u}_{1} ( x ) dx )}^{2} \qquad ( 63 )$$

$$= \frac{{N}_{tot}}{NL} {( {\int }_{{x}_{1} - w / 2}^{{x}_{N} + w / 2} {u}_{1} ( x ) dx )}^{2} \qquad ( 64 )$$

where xₙ=−L/2+Ln/Nₜₒₜ is the position of the center of the nth pixel and w=L/Nₜₒₜ is the pixel width. Note that,

$${\int }_{a}^{b} {u}_{1} ( x ) dx = {π}^{1 / 4} {\sqrt{\frac{σ}{2}} [ erf ( \frac{x}{\sqrt{2} σ} ) ]}_{a}^{b} \qquad ( 65 )$$

When N=Nₜₒₜ,

$${η}_{N} \approx \frac{1}{L} {( {\int }_{- L / 2}^{L / 2} {u}_{1} ( x ) dx )}^{2} = \frac{2 \sqrt{π} σ}{L} {( \frac{L}{2 \sqrt{2} σ} )}^{2} \qquad ( 66 )$$

Let's define χ=L/σ, so that the length is defined in units of σ.

$${η}_{{N}_{tot}} \approx \frac{2 \sqrt{π}}{χ} erf {( \frac{χ}{2 \sqrt{2}} )}^{2} \qquad ( 67 )$$

The maximum occurs when L=2.79σ, and η_{N}_{ₜₒₜ}=0.89.

Now let's search for the optimal gains.

$${η}_{N} = \frac{1}{{\sum }_{n = 1}^{N} {g}_{n}^{2}} {( {\sum }_{n = 1}^{N} {g}_{n} \sqrt{\frac{{N}_{tot}}{L}} {\int }_{{S}_{n}} {u}_{1} ( x ) dx )}^{2} \qquad ( 68 )$$

$$= \frac{1}{{\sum }_{n = 1}^{N} {g}_{n}^{2}} \frac{{N}_{tot}}{L} {( {\sum }_{n = 1}^{N} {g}_{n} {\int }_{{x}_{n} - w / 2}^{{x}_{n} + w / 2} {u}_{1} ( x ) dx )}^{2} \qquad ( 69 )$$

$$= \frac{1}{{\sum }_{n = 1}^{N} {g}_{n}^{2}} \frac{{N}_{tot}}{L} \frac{\sqrt{π} σ}{2} {( {\sum }_{n = 1}^{N} {{g}_{n} [ erf ( \frac{x}{\sqrt{2} σ} ) ]}_{{x}_{n} - w / 2}^{{x}_{n} + w / 2} )}^{2} \qquad ( 70 )$$

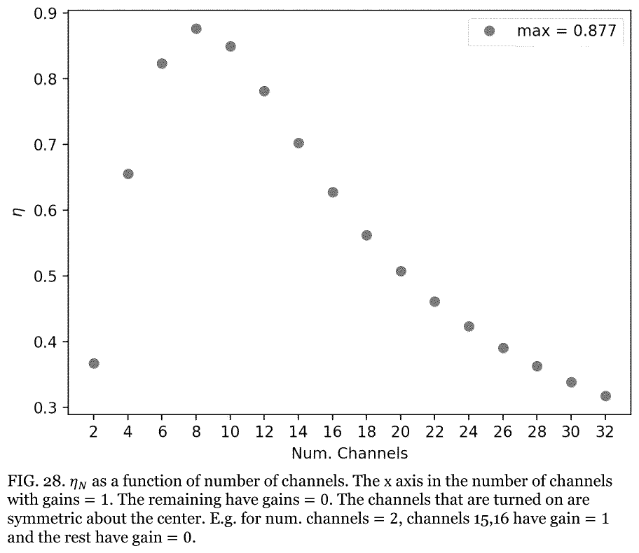

For the QPA chip, Nₜₒₜ=32, L=557.92 μm, σ=BW/4=50 μm (BW=beamwidth). Then χ=L/σ=11.15, which is far from optimal for 32 channels with uniform gains. Consider removing two channels at a time, symmetric about the middle. The optimal efficiency of 0.87 occurs for the 8 middle channels turned on and the rest turned off, see FIG. 28.

### 7. Formation of Cluster States

With post-processing by digitizing and manipulating the time series, or by using an field programmable gate array (FPGA) for real-time data processing, an additional matrix operation can be performed on the quadratures. The net transformation of the field can be written as,

$${\vec{a}}_{out} = OG Δ U {\vec{a}}_{in} \qquad ( 71 )$$

$$= {ODU}_{F} {\vec{a}}_{in} \qquad ( 72 )$$

where U_{F} is the fixed unitary matrix with matrix elements U_{F}=Uₙₘe^{iϕ}^{ₙ} where Uₙₘ is the change of basis matrix elements and e^{iϕ}^{ₙ} is the phase picked up for each pixel due to the wavefront/antenna surface roughness, D is the parameterizable diagonal matrix with matrix elements Dᵢⱼ=gⱼe^{iθ}^{ⱼ}δᵢⱼ where \vec{g} are the gains of each detector and \vec{θ} are the LO phases for each pixel, and O is the orthogonal matrix applied by the FPGA. 32 dim

$$\hat{a} ( ρ ) = {\sum }_{n} {\hat{a}}_{n} {ε}_{n} ( ρ ) \qquad ( 73 )$$

### Proof

From orthonormality, Σₘ|Uₘₙ|²=1.

$${U}_{mn} = \int {u}_{m} ( ρ ) {{ε}_{n}^{′} ( ρ )}^{*} d ρ \qquad ( 74 )$$

$${u}_{n} ( ρ ) = {\sum }_{i} {U}_{ni} {ε}_{i}^{′} ( ρ ) \qquad ( 75 )$$

$$\begin{matrix}{δ}_{nm} & = & \int {u}_{n} ( ρ ) {{u}_{m} ( ρ )}^{*} d ρ & ( 76 ) \\ & = & \int {\sum }_{i} {U}_{ni} {ε}_{i}^{′} ( ρ ) {{u}_{m} ( ρ )}^{*} d ρ & ( 77 ) \\ & = & {\sum }_{i} {U}_{ni} \int {{u}_{m} ( ρ )}^{*} {ε}_{i}^{′} ( ρ ) d ρ & ( 78 ) \\ & = & {\sum }_{i} {U}_{ni} {U}_{mi}^{*} & ( 79 )\end{matrix}$$

Therefore, Σᵢ|Uₙᵢ|²=Σᵢ(∫uₙ(ρ)ε′ᵢ(ρ)*dρ)²=1. First proof only true when ε′ₙ is complete, i.e., when in small pixel limit. Otherwise there is an average, so that ūₙ(ρ)=ΣᵢUₙᵢε′ᵢ(ρ) in the pixel basis.

$${C}_{mn} = \int {ε}_{m}^{′} ( ρ ) {{u}_{n} ( ρ )}^{*} d ρ = {U}_{nm}^{*} \qquad ( 80 )$$

$${ε}_{n}^{′} ( ρ ) = {\sum }_{i} {C}_{ni} {u}_{i} ( ρ ) \qquad ( 81 )$$

$$\begin{matrix}{δ}_{nm} & = & \int {ε}_{n}^{′} ( ρ ) {{ε}_{m}^{′} ( ρ )}^{*} d ρ & ( 82 ) \\ & = & \int {\sum }_{i} {C}_{ni} {u}_{i} ( ρ ) {{ε}_{m}^{′} ( ρ )}^{*} d ρ & ( 83 ) \\ & = & {\sum }_{i} {C}_{ni} \int {{ε}_{m}^{′} ( ρ )}^{*} {u}_{i} ( ρ ) d ρ & ( 84 ) \\ & = & {\sum }_{i} {C}_{ni} {C}_{mi}^{*} = {\sum }_{i} {U}_{in}^{*} {U}_{im} & ( 85 )\end{matrix}$$

Therefore, Σᵢ|Uᵢₙ|²=Σᵢ(∫uᵢ(ρ)ε′ₙ(ρ)*dρ)²=1

### Small Pixel Limit

In the small pixel limit, Uₘₙ≈Uₘ(xₙ,yₙ)δxδy where (xₙ,yₙ) is the location of

$$\hat{ι} = {\sum }_{n , m} {g}_{n} {u}_{m} ( {x}_{n} , {y}_{n} ) {\hat{X}}_{m} ( {φ}_{n} ) δ x δ y \qquad ( 86 )$$

If we choose gₙ=uⱼ(xₙ,yₙ) and align all the phases across the pixels such that φₙ=φ,

$$\begin{matrix}\hat{ι} & = & {\sum }_{n , m} {u}_{j} ( {x}_{n} , {y}_{n} ) {u}_{m} ( {x}_{n} , {y}_{n} ) {\hat{X}}_{m} ( φ ) δ x δ y & ( 87 ) \\ & \approx & {\sum }_{m} \int {u}_{j} ( x , y ) {u}_{m} ( x , y ) dxdy {\hat{X}}_{m} ( φ ) & ( 88 ) \\ & = & {\sum }_{m} {δ}_{jm} {\hat{X}}_{m} ( φ ) = {\hat{X}}_{j} ( φ ) & ( 89 )\end{matrix}$$

The Riemann sum in the first line approximates an integral in the second line. This agrees with the result from [1].

### REFERENCES FOR THE PROTOCOL EMBODIMENT

The following references are incorporated by reference herein.
[1] M. Beck, Quantum state tomography with array detectors, Physical Review Letters 84, 5748 (2000).
[2] G. Ferrini, J.-P. Gazeau, T. Coudreau, C. Fabre, and N. Treps, Compact gaussian quantum computation by multi-pixel homodyne detection, New Journal of Physics 15, 093015 (2013).
[3] A. I. Lvovsky, Squeezed light, Photonics: Scientific Foundations, Technology and Applications 1, 121 (2015).

### III. Further Examples

### 1. Tree Networks of Couplers

As described herein, in the quantum limit of phased arrays inputting light at the single-photon level, tuning the phases and amplitudes at the antennas can generate arbitrary single photon states and steer them. Moreover, by interfering the outputs of multiple phased arrays (or sending multiple photons into a single phased array) we can engineer multipartite entangled states.

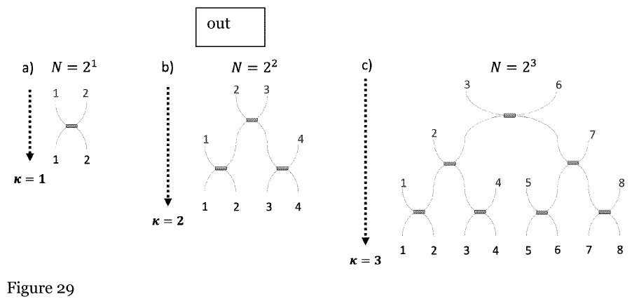

FIG. 29 illustrates an embodiment of a QPA, a tree network of bidirectional couplers (two inputs, two outputs). The binary tree topology can be leveraged to use multiple phased arrays within a single tree to interfere multiple single photons for quantum state engineering.

To see this, there are a few important observations to make about the binary tree structure. First, for a tree of order κ, there are always N=2^{κ} inputs and outputs. Second, a photon that enters either of the two inputs of the top bidirectional coupler (e.g. inputs 2,3 for κ=2), for any order tree, will have an equal probability of appearing at each output.³ In other words, the path from the top two inputs to any output is the same. Notably, the length of the path grows logarithmically (κ) with the number of inputs and outputs (N), such that a photon only ever travels through κ bidirectional couplers. Third, the binary tree is recursive: to construct a binary tree of order κ+1, take two binary trees of order κ, choose one of the two top-most inputs from each tree, and input each into a bidirectional coupler. Therefore, we can make 2^{κ-j} subtrees of order 0≤j≤κ from an order κ tree. It follows that a QPA with an order κ bidirectional coupler network consists of 2^{κ-j} QPAs with an order j bidirectional coupler network. For example, for an order 3 QPA, we inject a single photon into inputs 3 or 6. We can split the order 3 QPA into two QPAs of order 2 by instead injecting a photon into input 2 for the left QPA or into input 7 for the right QPA.

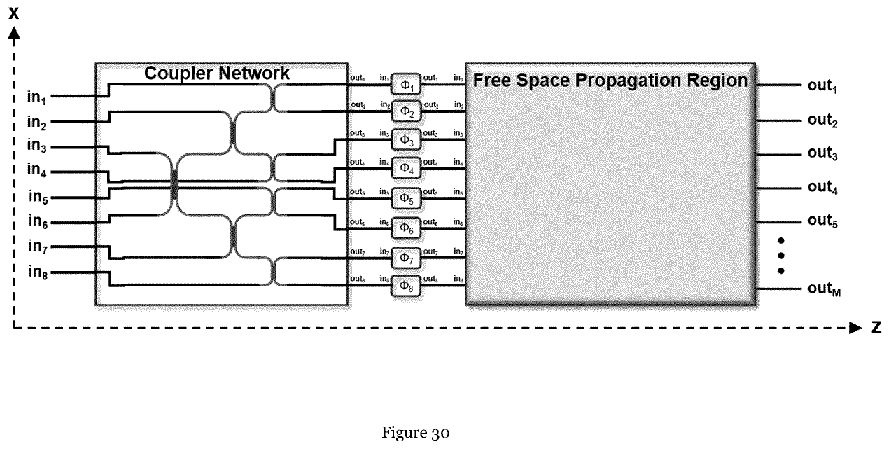

The block diagram of the QPA is depicted in FIG. 30.

Consider a single photon incident to an input of a bidirectional coupler tree, in_{*}. We want to determine the action of QPA on a single photon at in_{*}. As before, we can model the QPA using the scattering matrix formalism,

$$QPA = B Φ F \qquad ( 28 )$$

where B, Φ, and F are the transfer matrices of the coupler network, phase modulators, and free space propagation, respectively.

Since we want to have the flexibility of using all the inputs to access subtrees of the QPA, here we derive the full scattering submatrix for coupler QPA.

The scattering submatrix for a single bidirectional coupler is

$$T = [ \begin{matrix}t & r \\ r & t\end{matrix} ] \qquad ( 29 )$$

The scattering submatrix for the entire beamsplitter tree with N=2^{κ} input and output modes {y₁, . . . , y_{N}} is

$${T}_{{y}_{1} , ... , {y}_{N}}^{( κ )} = ( {T}_{{y}_{1} , ... , {y}_{N / 2}}^{( κ - 1 )} ⊕ {T}_{{y}_{( N + 1 ) / 2} , ... , {y}_{N}}^{( κ - 1 )} ) {U}_{{l}_{κ} , {r}_{κ}} \qquad ( 30 )$$

where l_{κ} and r_{κ} are defined by the coupled recursive sequence

$${l}_{κ} = {r}_{κ - 1}$$

The scattering submatrix for phase modulator block is the same as the classical phase modulator block. So,

$${\hat{a}}_{{out}_{m = n}} = {e}^{i {ϕ}_{n}} {\hat{a}}_{{in}_{n}} \qquad ( 32 )$$

In the QPA, the nth output of the coupler network is the input to the nth phase shifter, so

$${\hat{a}}_{{out}_{n}} = \frac{1}{\sqrt{N}} {\hat{a}}_{★}^{†} {e}^{i ( {α}_{n} + {ϕ}_{n} )} \qquad ( 33 )$$

Redefining αₙ+ϕₙ→ϕₙ,

$${\hat{a}}_{{out}_{n}} = \frac{1}{\sqrt{N}} {\hat{a}}_{★} {e}^{i {ϕ}_{n}} \qquad ( 34 )$$

Free Space Propagation is described as discussed above for single particle steering.

### 2. Superposition State Engineering

Consider a set of N detectors located at θ′₁, . . . , θ′_{N} at the detector plane. To deterministically send an arbitrary superposition state to the detector plane, the target single photon state is

$$\vert ψ 〉 = {\sum }_{n = 1}^{N} c ( {θ}_{n}^{′} ) {\hat{a}}^{†} ( {θ}_{n}^{′} ) \vert 0 〉 = {\sum }_{n = 1}^{N} \int c ( {θ}_{n}^{′} ) δ ( {θ}_{n}^{′} - θ ) {\hat{a}}^{†} ( θ ) d θ \vert 0 〉 \qquad ( 48 )$$

Then the coefficients at the antennas are

$$c ( ξ ) = {ℱ}^{- 1} [ {\sum }_{n = 1}^{N} c ( {θ}_{n}^{′} ) δ ( {θ}_{n}^{′} - θ ) {e}^{ikz \frac{{λ}^{2} {f}_{x , n}^{′2}}{2}} ] = {\sum }_{n = 1}^{N} c ( {θ}_{n}^{′} ) {e}^{ikz \frac{{λ}^{2} {f}_{x , n}^{′2}}{2}} {e}^{i 2 π k ξ {f}_{x , n}^{′}} = {\sum }_{n = 1}^{N} c ( {θ}_{n}^{′} ) {e}^{i 2 π k ξ ( {f}_{x , n}^{′} + {ϕ}_{n} )}$$

Beamsplitter Steering One important instance of superposition state generation is the beamsplitter.

The input-output relations for the beamsplitter are

$${\hat{a}}_{{in}_{1}} \to \frac{1}{\sqrt{2}} ( {\hat{a}}_{{out}_{1}} + i {\hat{a}}_{{out}_{2}} ) \qquad ( 50 )$$

$${\hat{a}}_{{in}_{2}} \to \frac{1}{\sqrt{2}} ( i {\hat{a}}_{{out}_{1}} + {\hat{a}}_{{out}_{2}} ) \qquad ( 51 )$$

We can realize a beamsplitter with two QPAs, where each QPA produces one of the output superposition states. Let in₁ and in₂ denote one of the topmost inputs of the QPA 1 and QPA 2, respectively.

For the first QPA, we can find the coefficients of the antennas that generate (50) by taking θ′₂=−θ′₁=θ′ and c(θ′)=ic(−θ′). We find

$$\begin{matrix}c ( ξ ) & = & c ( {θ}^{′} ) {e}^{i 2 π k ξϕ} ( {e}^{i 2 π k ξ {f}_{x}^{′}} + {ie}^{- i 2 π k ξ {f}_{x}^{′}} ) = & ( 52 ) \\ & & c ( {θ}^{′} ) {e}^{i 2 π k ξϕ} {e}^{i π / 4} ( {e}^{i ( 2 π k ξ {f}_{x , n}^{′} - π / 4 )} + {e}^{- i ( 2 π k ξ {f}_{x , n}^{′} - π / 4 )} ) & \\ & = & 2 c ( {θ}^{′} ) {e}^{i ( 2 π k ξϕ + π / 4 )} cos ( 2 π k ξ {f}_{x}^{′} - π / 4 ) & ( 53 )\end{matrix}$$

For the second QPA, θ′₁ and θ′₂ need to coincide with θ′ and −θ′. Since θ′₁ and θ′₂ are defined with respect to the detector plane of the QPA, whose origin does not overlap with that of the first QPA, we will take θ′₂=θ′₁+2θ′ for the second QPA.

$$c ( ξ ) = c ( {θ}_{2}^{′} ) ( {ie}^{i 2 π k ξ ( {f}_{x , 1}^{′} + {ϕ}_{1} )} + {e}^{i 2 π k ξ ( {f}_{x , 2}^{′} + {ϕ}_{2} )} ) \qquad ( 54 )$$

$$where c ( {θ}_{1}^{′} ) = ic ( {θ}_{2}^{′} ) .$$

### 3. N00N State Generation

The Hong-Ou-Mandel effect arises from the interference of indistinguishable single photons incident to a beamsplitter.

$${{{{{{{{{{\vert 1 〉}_{{in}_{1}} \vert 1 〉}_{{in}_{2}} = {\hat{a}}_{{in}_{1}}^{†} {\hat{a}}_{{in}_{2}}^{†} \vert 0 〉}_{{in}_{1}} \vert 0 〉}_{{in}_{2}} \to \frac{1}{2} ( {\hat{a}}_{{out}_{1}}^{†} + i {\hat{a}}_{{out}_{2}}^{†} ) ( i {\hat{a}}_{{out}_{1}}^{†} + {\hat{a}}_{{out}_{2}}^{†} ) \vert 0 〉}_{{out}_{1}} \vert 0 〉}_{{out}_{2}} = \frac{i}{\sqrt{2}} ( \vert 2 〉}_{{out}_{1}} \vert 0 〉}_{{out}_{2}} + \vert 0 〉}_{{out}_{1}} \vert 2 〉}_{{out}_{2}} )$$

This is an instance of a N00N state,

$$\frac{1}{\sqrt{2}} ( \vert N 〉 \vert 0 〉 + {e}^{i θ} \vert 0 〉 \vert N 〉 ) ,$$

### for N=2.

We can generalize HOM interference to create N00N states for any N=2^{k}. The creation operator representation of a N00N state can be factorized as

$$\begin{matrix}\frac{1}{\sqrt{2}} {( {\hat{a}}_{1}^{†} )}^{N} + {{e}^{i θ} ( {\hat{a}}_{2}^{†} )}^{N} & = & \frac{1}{2} ( {( {\hat{a}}_{1}^{†} )}^{N / 2} + {{ie}^{i \frac{θ}{2}} ( {\hat{a}}_{2}^{†} )}^{N / 2} ) ( {( {\hat{a}}_{1}^{†} )}^{N / 2} - {{ie}^{i \frac{θ}{2}} ( {\hat{a}}_{2}^{†} )}^{N / 2} ) & ( 56 ) \\ & = & \frac{1}{2} {\prod }_{\pm } {( {\hat{a}}_{1}^{†} )}^{N / 2} + {{e}^{i ( \frac{θ}{2} + π \pm \frac{π}{2} )} ( {\hat{a}}_{2}^{†} )}^{N / 2} & ( 57 ) \\ & & & \end{matrix}$$

The goal is to factorize the N00N creation operator representation into products of N single creation operator superpositions.

$$\frac{1}{\sqrt{2}} ( {( {\hat{a}}_{1}^{†} )}^{N} + {{e}^{i 0} ( {\hat{a}}_{2}^{†} )}^{N} ) = \frac{1}{{2}^{N / 2}} {\prod }_{φ} ( {\hat{a}}_{1}^{†} + {e}^{i φ} {\hat{a}}_{2}^{†} ) \qquad ( 58 )$$

We can determine what the set of φ are from recursively applying (57). For N=2^{k}, we find:

$$\begin{matrix}φ & = & \frac{θ}{{2}^{k}} + {\sum }_{j = 1}^{k} \frac{π}{{2}^{k - j}} \pm \frac{π}{2} \pm \frac{π}{4} \pm … \pm \frac{π}{{2}^{k}} & ( 59 ) \\ & = & ( \frac{θ}{{2}^{k}} + 2 π - \frac{π}{{2}^{k - 1}} ) \pm \frac{π}{2} \pm \frac{π}{4} \pm … \pm \frac{π}{{2}^{k}} & ( 60 ) \\ & & & \end{matrix}$$

Let Φ be the set of φ. Note that the k terms with ± mean that there are a total of 2^{k}φ's (i.e. |Φ|=2^{k}) as expected.

Therefore, we can create a N00N state using an MMI with N inputs and 2 outputs, where the each input sends a single photon into

$$\frac{1}{\sqrt{2}} ( {a}_{{out}_{1}}^{†} + {e}^{i ϕ} {\hat{a}}_{{out}_{2}}^{†} )$$

for each ϕ∈Φ.

We can flexibly perform this protocol using N QPA's, where each QPA sends a single photon into

$$\frac{1}{\sqrt{2}} ( {\hat{a}}_{{θ}_{1}}^{†} + {e}^{i ϕ} {\hat{a}}_{{θ}_{2}}^{†} ) ,$$

and then align the θ₁, θ₂'s of all the QPA's on the detector plane.

This protocol was independently derived by Dowling in [44], although I have only considered the even case and went into more detail.

### 4. Heralded (GHZ) Entanglement Generation

We showed in the previous section that single photon inputs into N QPA's can be interfered into a N00N state at two spatial modes on the detector plane:

$${\hat{a}}_{{in}_{1}}^{†} {\hat{a}}_{{in}_{2}}^{†} ... {\hat{a}}_{{in}_{N}}^{†} = {\prod }_{n} {\hat{a}}_{{in}_{n}}^{†} \to \frac{1}{{2}^{N / 2}} {\prod }_{φ} ( {a}_{{out}_{1}}^{†} + {e}^{i ϕ} {\hat{a}}_{{out}_{2}}^{†} ) = \frac{1}{\sqrt{2}} ( {( {a}_{{out}_{1}}^{†} )}^{N} + {{e}^{i θ} ( {\hat{a}}_{{out}_{2}}^{†} )}^{N} ) \qquad ( 61 )$$

$$with$$

$$φ = ( \frac{θ}{{2}^{k}} + 2 π - \frac{π}{{2}^{k - 1}} ) \pm \frac{π}{2} \pm \frac{π}{4} \pm … \pm \frac{π}{{2}^{k}}$$

First, considering inputting a time-bin superposition state to each of the N QPA inputs:

$$\frac{1}{{2}^{N / 2}} ( {\hat{a}}_{{in}_{1} , e}^{†} + {\hat{a}}_{{in}_{1} , ℓ}^{†} ) ( {\hat{a}}_{{in}_{2} , e}^{†} + {\hat{a}}_{{in}_{2} , ℓ}^{†} ) ... ( {\hat{a}}_{{in}_{N} , e}^{†} + {\hat{a}}_{{in}_{N} , ℓ}^{†} ) = \frac{1}{{2}^{N / 2}} {\prod }_{n} {\sum }_{t = e , ℓ} {\hat{a}}_{{in}_{n} , t}^{†} \qquad ( 62 )$$

$$\begin{matrix}\frac{1}{{2}^{N / 2}} {\prod }_{n} {\sum }_{t = e , ℓ} {\hat{a}}_{{in}_{n} , t}^{†} \vert 0 〉 & = & {( \frac{1}{\sqrt{2}} ( \vert e 〉 + \vert ℓ 〉 ) )}^{⊗ N} \to & ( 63 ) \\ & & \frac{1}{{2}^{N}} {\prod }_{φ} {\sum }_{t = e , ℓ} ( {\hat{a}}_{{out}_{1} , t}^{†} + {e}^{i φ} {\hat{a}}_{{out}_{2} , t}^{†} ) \vert 0 〉 & ( 64 ) \\ & = & \frac{1}{{2}^{N}} {\prod }_{φ} ( ( {\hat{a}}_{{out}_{1} , e}^{†} + {e}^{i φ} {\hat{a}}_{{out}_{2} , e}^{†} ) + ( {\hat{a}}_{{out}_{1} , ℓ}^{†} + {e}^{i φ} {\hat{a}}_{{out}_{2} , ℓ}^{†} ) ) \vert 0 〉 & ( 65 ) \\ & = & \frac{1}{{2}^{N}} {\sum }_{j = 0}^{N} {\sum }_{\vert Ω \vert = j} {\sum }_{ϕ ∈ Ω} {\sum }_{σ ∈ Φ - Ω} {\prod }_{ϕ} ( {\hat{a}}_{{out}_{1} , e}^{†} + {e}^{i ϕ} {\hat{a}}_{{out}_{2} , e}^{†} ) {\prod }_{σ} ( {\hat{a}}_{{out}_{1} , ℓ}^{†} + {e}^{i σ} {\hat{a}}_{{out}_{2} , ℓ}^{†} ) \vert 0 〉 & ( 65 )\end{matrix}$$

where Ω is a subset of Φ of size j, ϕ is an element of Φ, and σ is an element of the subset Φ−Ω. There are only two cases where we get a N00N state of size N photons: when all the photons are in the early time bin (j=0) or all of the photons are in the late time bin (j=N).

$$\frac{1}{{2}^{N}} [ \frac{1}{\sqrt{2}} ( {( {\hat{a}}_{{out}_{1} , e}^{†} )}^{N} + {{e}^{i θ} ( {\hat{a}}_{{out}_{2} , e}^{†} )}^{N} ) \qquad ( 67 )$$

$$+ {\sum }_{j = 1}^{N - 1} {\sum }_{\vert Ω \vert = j} {\sum }_{ϕ ∈ Ω} {\sum }_{σ ∈ Φ - Ω} {\prod }_{ϕ} ( {\hat{a}}_{{out}_{1} , e}^{†} + {e}^{i ϕ} {\hat{a}}_{{out}_{2} , e}^{†} ) {\prod }_{σ} ( {\hat{a}}_{{out}_{1} , ℓ}^{†} + {e}^{i σ} {\hat{a}}_{{out}_{2} , ℓ}^{†} ) \qquad ( 68 )$$

$$+ \frac{1}{\sqrt{2}} ( {( {\hat{a}}_{{out}_{1} , ℓ}^{†} )}^{N} + {{e}^{i θ} ( {\hat{a}}_{{out}_{2} , ℓ}^{†} )}^{N} ) ] \vert 0 〉 \qquad ( 69 )$$

In bracket notation,

$${( \frac{1}{\sqrt{2}} ( \vert e 〉 + \vert ℓ 〉 ) )}^{⊗ N} \to \frac{1}{{2}^{N}} [ \frac{1}{\sqrt{2}} ( {( {\hat{a}}_{{out}_{1} , e}^{†} )}^{N} + {{e}^{i θ} ( {\hat{a}}_{{out}_{2} , e}^{†} )}^{N} ) \qquad ( 70 )$$

$$+ {\sum }_{j = 1}^{N - 1} {\sum }_{\vert Ω \vert = j} {\sum }_{ϕ ∈ Ω} {\sum }_{σ ∈ Φ - Ω} {\prod }_{ϕ} ( {\hat{a}}_{{out}_{1} , e}^{†} + {e}^{i ϕ} {\hat{a}}_{{out}_{2} , e}^{†} ) {\prod }_{σ} ( {\hat{a}}_{{out}_{1} , ℓ}^{†} + {e}^{i σ} {\hat{a}}_{{out}_{2} , ℓ}^{†} ) \qquad ( 71 )$$

$$+ \frac{1}{\sqrt{2}} ( {( {\hat{a}}_{{out}_{1} , ℓ}^{†} )}^{N} + {{e}^{i θ} ( {\hat{a}}_{{out}_{2} , ℓ}^{†} )}^{N} ) ] \vert 0 〉 \qquad ( 72 )$$

Accordingly, if we considered each input photon to be entangled with another photon, and herald on N00N between out₁ and out₂ in the early and late time bins, then we will result in a GHZ state at the entangled photons.

$${{{{{{{{{{{{\frac{1}{{2}^{N / 2}} {{\prod }^{N}}_{n = 1} {\sum }_{t = e , ℓ} {\hat{a}}_{{in}_{n} , t}^{†} {\hat{b}}_{n , t}^{†} \vert 0 〉 = \frac{1}{{2}^{N / 2}} {{\prod }^{N}}_{n = 1} ( {\hat{a}}_{{in}_{n} , e}^{†} {\hat{b}}_{n , e}^{†} + {\hat{a}}_{{in}_{n} , ℓ}^{†} {\hat{b}}_{n , ℓ}^{†} ) \vert 0 〉 \to \frac{1}{{2}^{N / 2}} {{\prod }^{N}}_{n = 1} ( \frac{1}{\sqrt{2}} ( {\hat{a}}_{{out}_{1} , e}^{†} + {e}^{i {φ}_{n}} {\hat{a}}_{{out}_{2} , e}^{†} ) {\hat{b}}_{n , e}^{†} + \frac{1}{\sqrt{2}} ( {\hat{a}}_{{out}_{1} , ℓ}^{†} + {e}^{i {φ}_{n}} {\hat{a}}_{{out}_{2} , ℓ}^{†} ) {\hat{b}}_{n , ℓ}^{†} ) \text{?} = \frac{1}{{2}^{N / 2}} ( \frac{1}{\sqrt{2}} ( \vert N , 0 〉}_{e} + {e}^{i θ} \vert 0 , N 〉}_{e} ) \vert {e}_{1} , ... , {e}_{N} 〉 + \frac{1}{\sqrt{2}} ( \vert N , 0 〉}_{ℓ} + {e}^{i θ} \vert 0 , N 〉}_{ℓ} ) \vert {ℓ}_{1} , ... , {ℓ}_{N} 〉 = \frac{1}{{2}^{N / 2}} ( \frac{1}{\sqrt{2}} ( \vert N , 0 〉}_{e} + {e}^{i θ} \vert 0 , N 〉}_{e} ) ( \vert {Φ}_{+} 〉 + \vert {Φ}_{-} 〉 ) + \frac{1}{\sqrt{2}} ( \vert N , 0 〉}_{ℓ} + {e}^{i θ} \vert 0 , N 〉}_{ℓ} ) ( \vert {Φ}_{+} 〉 - \vert {Φ}_{-} + \frac{1}{2} ( \vert N , 0 〉}_{e} + {e}^{i θ} \vert 0 , N 〉}_{e} - \vert N , 0 〉}_{ℓ} - {e}^{i θ} \vert 0 , N 〉}_{ℓ} ) \vert {Φ}_{-} 〉 ... ) \qquad ( 76 )$$

$$\text{?} \text{indicates text missing or illegible when filed}$$

Where

$$\vert {Φ}_{\pm } 〉 = \frac{1}{\sqrt{2}} ( \vert {e}_{1} ... {e}_{N} 〉 \pm \vert {ℓ}_{1} , ... {ℓ}_{N} 〉 ) .$$

Therefore, if it is possible to discriminate |N, 0 [symbol] and |0, N [symbol] in early and late time bins, then it is possible to perform heralded GHZ entanglement distribution

The current PNR detectors available to us from JPL can discriminate well zero photons, single photons, and multiple photons. This protocol can be modified to herald on states of the form

$$\frac{1}{\sqrt{2}} ( \vert N - 1 , 1 〉 + {e}^{i θ} \vert 1 , N - 1 〉 ) ,$$

which should be easier to detect with the current PNR detectors we have available.

We note that

$$\frac{1}{\sqrt{2}} ( \vert N - 1 , 1 〉 + {e}^{i θ} \vert 1 , N - 1 〉 )$$

states can be written in terms of N00N states as

$${\hat{a}}_{1}^{†} {\hat{a}}_{2}^{†} \frac{1}{\sqrt{2}} ( \vert N - 2 , 0 〉 + {e}^{i θ} \vert 0 , N - 2 〉 ) :$$

$$\frac{1}{\sqrt{2}} ( {( {\hat{a}}_{1}^{†} )}^{N - 1} {\hat{a}}_{2}^{†} + {e}^{i θ} {{\hat{a}}_{1}^{†} ( {\hat{a}}_{2}^{†} )}^{N - 1} ) = \frac{1}{\sqrt{2}} {\hat{a}}_{1}^{†} {\hat{a}}_{2}^{†} ( {( {\hat{a}}_{1}^{†} )}^{N - 2} + {{e}^{i θ} ( {\hat{a}}_{2}^{†} )}^{N - 2} ) = \frac{1}{{2}^{N / 2}} {\hat{a}}_{1}^{†} {\hat{a}}_{2}^{†} {\prod }_{n = 1}^{N - 2} ( {\hat{a}}_{1}^{†} + {e}^{i {φ}_{n}} {\hat{a}}_{2}^{†} ) \qquad ( 80 )$$

It follows that

$$\frac{1}{{2}^{N / 2}} {\prod }_{n = 1}^{N} {\sum }_{t = e , ℓ} {\hat{a}}_{i {n}_{n} , t}^{†} {\hat{b}}_{n , t}^{†} \vert 0 〉 = \frac{1}{{2}^{N / 2}} {\prod }_{n = 1}^{N} ( {\hat{a}}_{i {n}_{n} , e}^{†} {\hat{b}}_{n , e}^{†} + {\hat{a}}_{i {n}_{n} , l}^{†} {\hat{b}}_{n , ℓ}^{†} ) \vert 0 〉 \to \qquad ( 81 )$$

$${{{{\frac{1}{{2}^{N / 2}} ( \frac{1}{2} ( \vert N - 1 , 1 〉}_{e} + {e}^{i θ} \vert 1 , N - 1 〉}_{e} + {e}^{i θ} \vert N - 1 , 1 〉}_{ℓ} + \text{} \vert 1 , N - 1 〉}_{ℓ} ) \vert {Φ}_{+} 〉 + \qquad ( 82 )$$

$${{{{\frac{1}{2} ( \vert N - 1 , 1 〉}_{e} + {e}^{i θ} \vert 1 , N - 1 〉}_{e} - \vert N - 1 , 1 〉}_{ℓ} - {e}^{i θ} \vert 1 , N - 1 〉}_{ℓ} ) \vert {Φ}_{-} 〉 … ) \qquad ( 83 )$$

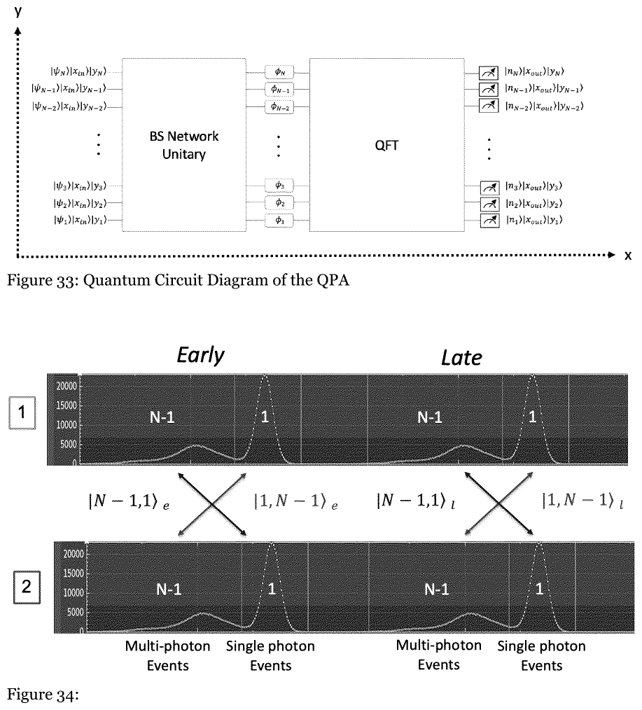

For θ=0, heralding the |Φ₊ [symbol] state could be done with two PNR detectors conditioned with the INQNET GUI as shown in FIG. 34.

### 5. Spatial And Time Hyperentanglement

If the switching time of the phase shifters is less than the time delay of the time-bins, then one could entangle the spatial and position degrees of freedom of a photon by switching phase distributions between early and late:

$$α \vert e 〉 + β {e}^{i φ} \vert ℓ 〉 \to α \vert {ψ}_{e} ( θ ) , e 〉 + β {e}^{i φ} \vert {ψ}_{ℓ} ( θ ) , ℓ 〉 \qquad ( 84 )$$

### 6. Classical to Quantum Transduction

Considering sending a coherent state |α [symbol] into a binary tree of couplers. A tree with 2^{k} input and output modes takes |α [symbol] →|α/2^{k/2} [symbol] .

For telecom bandwidth (1260 nm for beginning of O band to 1625 nm for end of L band), single photon flux in watts is

$$\frac{hc}{1260 nm \times s} = 1.577 \times 1 {0}^{- 19} W \qquad ( 85 )$$

$$\frac{hc}{1536 nm \times s} = 1.293 \times 1 {0}^{- 19} W \qquad ( 86 )$$

$$\frac{hc}{1625 nm \times s} = 1.22 \times 1 {0}^{- 19} W \qquad ( 87 )$$

Typical receiver energies for OPAs are on the order of pW. So the number of photons per second≈10⁷ for telecom wavelengths.
https://physics.stackexchange.com/questions/448660/laser-power-and-coherent-state-amplitu
CW constant measurements up to detector dead time.
https://en.wikipedia.org/wiki/Coherent_state

### 7. Further Example QPA Designs for Entanglement Embodiments

The QPA (free space or fiber-optic platform) could be fabricated silicon quantum photonic chips fabricated using AMF 193 nm SiP platform.

Design of the QPA encompasses designing an integrated system that satisfy the system-level specification objectives. A key specification is the maximum order of entanglement that could be generated by a QPA, which determines a lot of the other QPA specifications.

Since the order of entanglement is related to the number of coupler subtrees we can use, number of antennas determine the order of entanglement. While this relationship is not clear at first, we first look at the maximum and minimum z we can operate in for lowest order and highest order entanglement, respectively. To maximize the z and consequently the order of entanglement range, we have chosen both QPAs to be 1D since routing might limit the number of antennas in a 2D QPA, which consequently limits zₘₐₓ as it will be shown below.

Dynamic z. We first assume, we have control over where the detectors can be placed, namely z is not static. As the number of antennas increase, the far field distance also increases:

$${Z}_{far} \approx \frac{2 {D}_{Tx}^{2}}{λ} \qquad ( 88 )$$

$$\approx \frac{{( N - 1 )}^{2} λ}{2} \qquad ( 88 )$$

where N is the number of antennas of a sub-array used in entanglement generation, and assuming half-wavelength antenna spacing,

$${D}_{T x} \approx \frac{( N - 1 ) λ}{2}$$

is the array aperture. This condition can be relaxed by superimposing a quadratic phase profile,

$${e}^{- i k \frac{{( ( n - 1 ) d )}^{2}}{2 z}} ,$$

to the calculated aperture function from the protocol and operate in the near-field region as if it was far field by canceling the quadratic phase term in (16). This relaxes the distance constraint to

$${z}_{near} \approx 10 {( \frac{{\vert x - ξ \vert}_{max}^{4}}{λ} )}^{1 / 3}$$

However, in some embodiments, this constraint is too stringent for the Fresnel approximation to still hold. Therefore, assuming the steering range isn't extremely wide, this can be relaxed to

$${z}_{near} \approx \frac{{D}_{Tx}^{2}}{16 λ} \qquad ( 90 )$$

$$\approx \frac{{( N - 1 )}^{2} λ}{64} \qquad ( 90 )$$

This imposes a lower bound for z, z_{lower}=zₙₑₐᵣ. While the detectors can be placed as far away as possible, the beamwidth increases due to diffracting beam. Therefore, the beamwidth at the detector plane needs to be smaller than the receiver aperture to maximize fidelity. For an angular beamwidth of θ_{BW}, this imposes an upper bound on z.

$${z}_{upper} = \frac{{D}_{R x} cot ( {θ}_{BW} / 2 )}{2} \qquad ( 91 )$$

where D_{Rx} is the receiver aperture. Since the far field radiation pattern is the discrete Fourier transform of the QPA aperture function, the angular beamwidth and aperture size follows the following relation due to the uncertainty principle in Fourier analysis:

$${θ}_{BW} {D}_{T x} = λ \qquad ( 92 )$$

Hence, the condition on z becomes

$${z}_{lower} \leq z \leq {z}_{upper} \qquad ( 93 )$$

This range, zᵤₚₚₑᵣ−z_{lower}, decreases with increasing N. Therefore, for a fixed D_{Rx}, this sets a bound on the maximum N. Namely, above a certain N, there won't be a z that will allow for both far-field operation and small enough beamwidth. Therefore, we can find Nₘₐₓ by setting

$$\frac{{D}_{Rx} cot ( \frac{2}{{N}_{max} - 1} )}{2} = \frac{{( {N}_{max} - 1 )}^{2} λ}{64} \qquad ( 94 )$$

Hence,

$${( {N}_{max} - 1 )}^{2} tan ( \frac{2}{{N}_{max} - 1} ) = \frac{32 {D}_{Rx}}{λ} \qquad ( 95 )$$

Since zᵤₚₚₑᵣ increases with N, we find zₘₐₓ.

$${z}_{max} = \frac{{( {N}_{max} - 1 )}^{2} λ}{64} \qquad ( 96 )$$

For large Nₘₐₓ,

$${z}_{max} \approx \frac{{N}_{max}^{2} λ}{64} \qquad ( 97 )$$

zₘᵢₙ doesn't have a limit with respect to QPA design as it is limited by the individual antenna aperture for the case of N=1. Therefore, the lowest order of entanglement, Nₘᵢₙ, is 2 for Nₘᵢₙ=4, and the highest order of entanglement, Nₘₐₓ, which follows from Nₘₐₓ is

$${N}_{max} = {2}^{⌊ {log}_{2} ( {N}_{max} ) ⌋ - 2} \qquad ( 98 )$$

We also note that total number of antennas in this QPA design would be 2N₋, where N₋ is the number of antennas of the sub-arrays used in the lowest order of entanglement, at most 2Nₘₐₓ.

Static z Now, we do the same analysis, but now we assume z is static. In this case, we need to find z so that it is greater than z_{lower} of the lowest order of entanglement, z_{lower-}, and smaller than zᵤₚₚₑᵣ of the highest order of entanglement, zᵤₚₚₑᵣ₊. This imposes a more stringent condition on z.

$${z}_{lower -} \leq z \leq {z}_{upper +} \qquad ( 99 )$$

Using (90) and (91), we define

$${Z}_{upper +} = \frac{{D}_{Rx} cot ( \frac{2}{{N}_{+} - 1} )}{2} = \frac{{D}_{Rx} cot ( \frac{{2}^{Δ + 1}}{{N}_{-} - {2}^{Δ}} )}{2} \qquad ( 100 )$$

$${z}_{lower -} = \frac{{( {N}_{-} - 1 )}^{2} λ}{64} \qquad ( 100 )$$

where N₊ is the number of antennas of the sub-arrays used in the highest order of entanglement, N₋ is the number of antennas of the sub-arrays used in the lowest order of entanglement, and Δ is the order of entanglement range.⁶ We want to optimize for maximum Δ, so again, setting

$$\frac{{D}_{Rx} cot ( \frac{{2}^{{Δ}_{max} + 1}}{{N}_{- , opt} - {2}^{{Δ}_{max}}} )}{2} = \frac{{( {N}_{- , opt} -- 1 )}^{2} λ}{64} \qquad ( 101 )$$

Hence,

$$\frac{{2}^{{Δ}_{max} + 1}}{{N}_{- , opt} -- {2}^{{Δ}_{max}}} = arctan ( \frac{32 {D}_{Rx}}{{( {N}_{- , opt} -- 1 )}^{2} λ} ) \qquad ( 102 )$$

Solving this with the optimum N_{-,opt} yields maximum Δₘₐₓ.

FoV constraint While not a limitation in far-field operation with dynamic z, |x-ξ|ₘₐₓ limitation due to (89) imposes a constraint on the FoV of a QPA design with static z. To understand this constraint, we observe the quadratic phase term in the Fresnel approximation in (16). This phase term in exact form will involve higher order of the binomial expansion described in that section. As |x−ξ|ₘₐₓ increases, contributions of those orders also increase, making the Fresnel approximation more inaccurate. The majority of the contribution in the approximation comes from orders that represent a square in ξ with a width of 4\sqrt{λz} where ξ=x. When this square is completely within the aperture (good regime), Fresnel approximation is accurate and when it is completely outside the aperture (bad regime), Fresnel approximation can be deemed inaccurate. There is a transition region where the square partially overlaps with the aperture (transition regime), in which case Fresnel approximation is partially accurate. The constraint on FoV comes from an xₘₐₓ that makes the square barely overlap with the aperture. This sets

$${x}_{max} \approx 2 \sqrt{λ z} + {D}_{QPA} \qquad ( 103 )$$

where D_{QPA} is the QPA aperture. Note that this constraint is calculated after finding N_{-,opt}.

### (i) Example Free-Space QPA

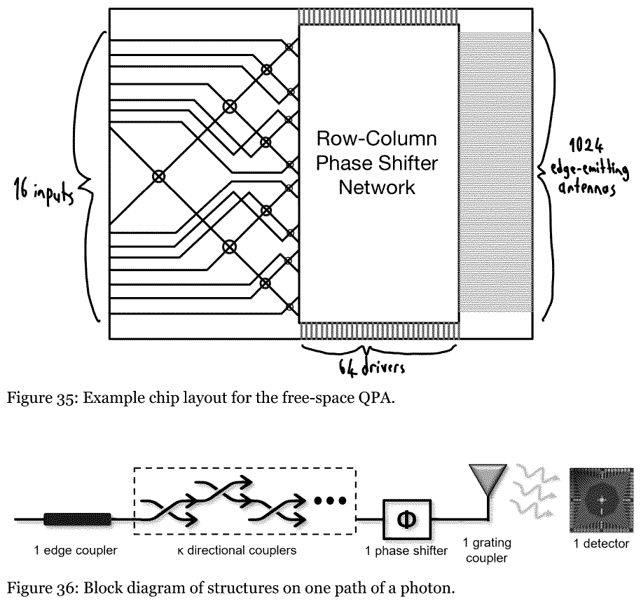

An example chip layout for the free-space chip is shown in FIG. 35 and has the same layout as a conventional OPA but replacing the beamsplitter with directional couplers. Edge-emitting antennas radiate isotropically, and interference takes place in the far-field region.

For free-space QPA, receiver aperture is set to be 1 mm, which is the active area of a typical superconducting nanowire single photon detector (SNSPD), which will be used for state detection. This sets the maximum N to be 1024 antennas, an order 10 network. Then, the maximum order of entanglement is chosen to be 8, making the total edge-coupled inputs 16. This also sets the minimum z at 3 cm.

We also make a power budget simulation for the free-space QPA with the designed chip layout. We think of the QPA as a power splitter that splits power in the coupler network and a power combiner that combines power in free space. Therefore, to compute total chip losses, we can compute the loss on one path a photon takes. Since the QPA beamwidths are engineered to make the systems non-diffraction limited, we can neglect free-space propagation losses. We also neglect the waveguide losses. Hence, total loss is

$${P}_{loss} = {P}_{EC} \times ( κ {P}_{DC} ) \times {P}_{PS} \times {P}_{GC} \times {P}_{D} \qquad ( 104 )$$

For the example chip layout in FIG. 35, typical Pₗₒₛₛ is expected to be around 13 dB.

The proposed experiment setups are shown in FIG. 36.

### 8. Example Quantum State Steering Experiment Design

Indistinguishable photon pairs are generated by spontaneous parametric downconversion (SPDC) crystals. Indistinguishable photon pair generation by SPDCs is characterized with the following expression:

$${P}_{n} = \frac{{( tanh ζ )}^{2 n}}{{( cosh ζ )}^{2}} = \frac{{μ}^{n}}{{( 1 + μ )}^{n + 1}} \qquad ( 105 )$$

where ξ is the squeezing parameter, μ is the probability of indistinguishable photon pair generation per clock cycle dependent on μ=(sin ξ)², and n is the number of generated indistinguishable photon pairs. These pairs are entangled in polarization, but can be utilized in the following ways.
1. Single-photon steering: sending a single photon from the SPDC to the QPA and steering it. An electron-multiplying charge coupled device (EMCCD) camera could be used to visualize this steering and beamwidth and FoV could be characterized.
2. Entanglement steering: sending a pair of entangled photons to two QPAs. Entangled photons could be distributed to two fibers with a polarizing beamsplitter. Two spatially entangled photons could be detected by two of the four detectors with polarizing lenses. Entanglement distribution could be verified by measuring the coincidences in polarization at the detectors. The delay line on one of the photon paths could be tuned until there is a dip in coincidences to verify entanglement. Then, this could be repeated as entanglement is steered to other detectors.

### 9. Example N00N State Generation Experiment Design

The same experimental procedure as entanglement steering could be used. However, multiple SPDCs or one SPDC with multiple attenuated coherent sources (laser) would be needed for orders of entanglement higher than two. We want to distribute N photons to N QPAs for order N N00N state generation. Therefore, for order N, with multiple SPDCs, the probability of distributing a single photon to all QPAs is

$${P}_{N} = \frac{{μ}^{N / 2}}{{( 1 + μ )}^{N}} \qquad ( 106 )$$

After this, the aggregate losses on chip and in free space reduce the fidelity of the state. Since these losses map directly from classical simulations, we can define a fidelity metric for the N00N state generation. Then, the probability of generating an order N entanglement is

$${F}_{N} = \frac{{μ}^{N / 2}}{{( 1 + μ )}^{N}} \times {P}_{loss} \qquad ( 107 )$$

We can multiply this fidelity with the clock frequency of the SPDC to get the expected number of trials for successful entanglement generation. We aim to minimize this FIG. of merit to improve efficiency of entanglement generation over other entanglement generation protocols.

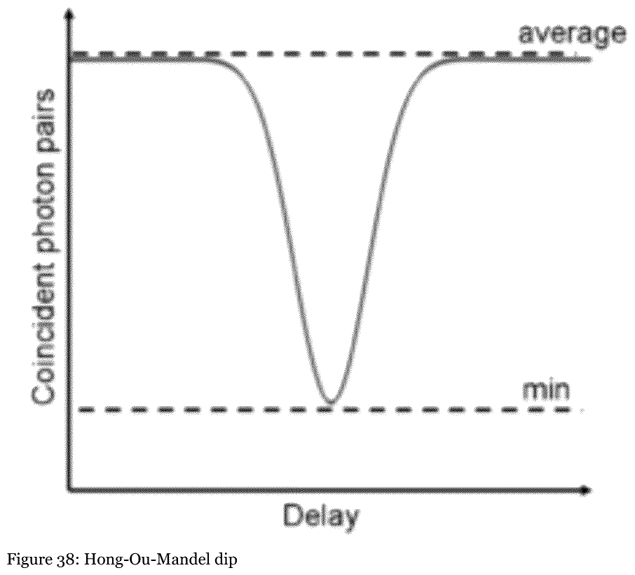

Successful entanglement generation could be identified when the coincidences from two detectors have a <−3 dB dip (classical bound) over some constant time (Hong-Ou-Mandel dip) compared to random photon arrivals as seen in FIG. 38.

### 10. Example Fiber-Optic QPA/Quantum Network on Chip (QNOC) Design

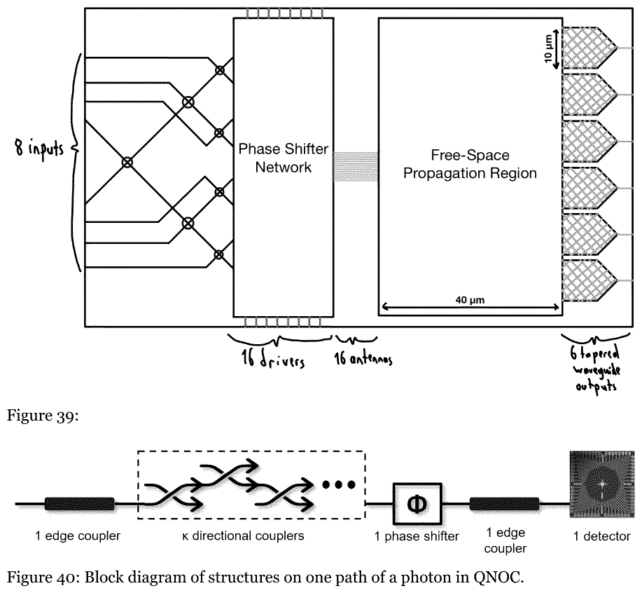

An example chip layout for the fiber-optic chip is shown in FIG. 39. We call this system quantum network on chip due to its preeminent applications in distributing entanglement in fiber-optic quantum networks.

This chip places the free space propagation region on chip with a rectangular silicon structure. While the structure is finite, it emulates free space propagation similar

to the scheme shown in [45]. Then, the interference takes place on chip and the resulting state is coupled to waveguides, which are then fiber coupled.

For QNOC, receiver aperture is set to be 10 μm, which is the largest single-mode waveguide on silicon. This sets maximum N to be 16 antennas, an order 4 network. This also automatically sets the maximum order of entanglement to be 4, with a minimum Δz at 20 μm.

We also make a power budget simulation for the QNOC with the designed chip layout. Again, considering a single path, we calculate the total loss.

Hence, total loss is

$${P}_{loss} = {P}_{EC} \times ( κ {P}_{DC} ) \times {P}_{PS} \times {P}_{EC} \times {P}_{D} \qquad ( 108 )$$

For the example chip layout in FIG. 39, typical Pₗₒₛₛ is expected to be around 11 dB.

### (i). QNOC Experiment Design

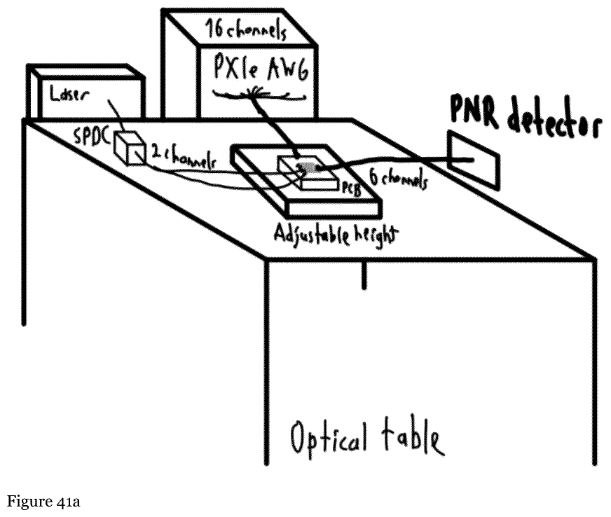

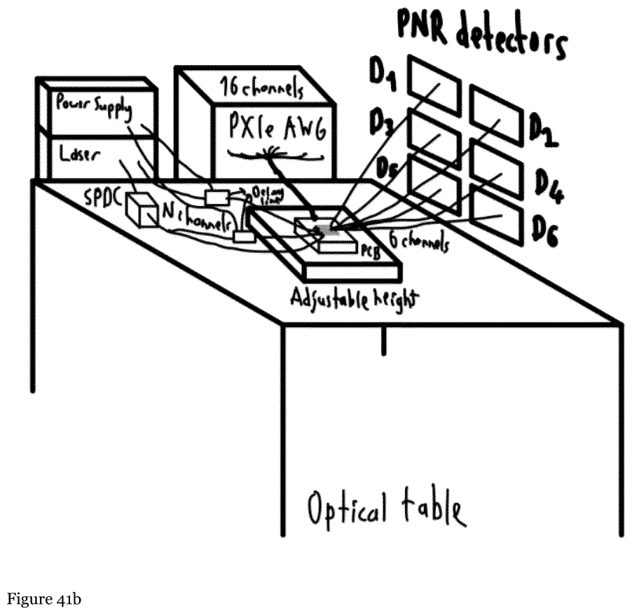

Proposed experiment setups for QNOC are shown in FIG. 41.

### (ii). Quantum State Steering

This experiment could take place the same way as the free-space version, but the detection scheme will be slightly different.
1. Single-photon steering: send a single photon from the SPDC to QNOC and steer it. The output waveguides (channels) can capture the single photon and send it to a detector via fiber and the speed of switching between channels can be characterized.
2. Entanglement steering: send a pair of entangled photons to two QPAs. Entangled photons will be distributed to two fibers with a polarizing beamsplitter. Two spatially entangled photons will be sent down two channels and will be detected by two of the six detectors with polarizing lenses. Entanglement distribution could be verified by measuring the coincidences in polarization at the detectors. The delay line on one of the photon paths could be tuned until there is a dip in coincidences to verify entanglement.

Then, this will be repeated as entanglement is steered to other detectors. We will characterize the speed of entanglement switching between channels.

### 19. N00N State Generation Experiment Design

For this experiment, same experimental procedure as entanglement steering could be used, and the same result as free-space N00N state generation is predicted to be obtained. The fidelity (number of expected trials until success) of the entanglement generation can be characterized.

### 11. Example Calibration Methods

All these experiments would require calibration of the QPA chips. These calibration procedures will need to take place to find the right phase shifts in the phase shifters.

### (i) Single-Photon Steering Experiments

Calibration for the single-photon steering experiments will map directly from OPA calibration procedures. A test structure with a few phase shifters could be used to characterize the half-wave voltage and cross-talk of the phase shifters. After this characterization, using classical light, random phase shifts could be applied and the radiation pattern will be imaged. Then, a gradient descent algorithm could be used to tune the phase shifts to maximize the power at broadside, and a beam will be formed. Then, using the test structure characterization, educated guesses could be made to tune the phase shifts to steer the beam. These phase shifts could be recorded to make a model of the QPA chip accounting for all the parasitics experimentally.

After this procedure, single photon states can be sent and steered.

### (ii) Entanglement Steering Experiments

Same single photon steering calibration procedure could be done to two QPAs. Then, entangled photons will be sent to QPAs. Delay line in front of one QPA could be used to tune the time of arrival of entangled photons to generate entanglement and observe the Hong-Ou-Mandel dip.

(iii) N00N State Generation Experiments

Using classical light again, random phase shifts could be applied to phase shifters, and a gradient descent algorithm could be used to obtain the classical version of the entanglement radiation pattern (classical radiation pattern if the phase shifts required for the entanglement generation were applied to the phase shifters). To generate this pattern, both QPAs will most likely be required to be steered slightly so that their interference patterns match up.

Then, delay line will be used to tune the photon arrival times until the Hong-Ou-Mandel dip is observed.

### REFERENCES FOR SECTION III

The following references are incorporated by reference herein
[1] R. P. Feynman, “Simulating physics with computers,” in Feynman and computation. CRC Press, 2018, pp. 133-153.
[2] E. Grumbling and M. Horowitz, Quantum computing: progress and prospects. The National Academies Press, 2019.
[3] V. Giovannetti, S. Lloyd, and L. Maccone, “Advances in quantum metrology,” Nature Photonics, vol. 5, no. 4, pp. 222-229, April 2011. [Online]. Available: https://doi.org/10.1038/nphoton. 2011.35
[4] J. P. Dowling and K. P. Seshadreesan, “Quantum optical technologies for metrology, sensing, and imaging,” Journal of Lightwave Technology, vol. 33, no. 12, pp. 2359-2370, 2015.
[5] M. A. Taylor and W. P. Bowen, “Quantum metrology and its application in biology,” Physics Reports, vol. 615, pp. 1-59, 2016, quantum metrology and its application in biology. [Online]. Available: https://www.sciencedirect.com/science/article/pii/S0370157315005001
[6] P. W. Shor and J. Preskill, “Simple proof of security of the bb84 quantum key distribution protocol,” Physical review letters, vol. 85, no. 2, p. 441, 2000.
[7] D. Bouwmeester, J.-W. Pan, K. Mattle, M. Eibl, H. Weinfurter, and A. Zeilinger, “Experimental quantum teleportation,” Nature, vol. 390, no. 6660, pp. 575-579, 1997.
[8] S. Wehner, D. Elkouss, and R. Hanson, “Quantum internet: A vision for the road ahead,” Science, vol. 362, no. 6412, 2018.
[9] P. Shor, “Algorithms for quantum computation: discrete logarithms and factoring,” in Proceedings 35th Annual Symposium on Foundations of Computer Science, 1994, pp. 124-134.
[10] S. Lloyd, “Enhanced sensitivity of photodetection via quantum illumination,” Science, vol. 321, no. 5895, pp. 1463-1465, 2008. [Online]. Available: https://science.sciencemag.org/content/321/5895/1463
[11] F. Arute, K. Arya, R. Babbush, D. Bacon, J. C. Bardin, R. Barends, R. Biswas, S. Boixo, F. G. Brandao, D. A. Buell et al., “Quantum supremacy using a programmable superconducting processor,” Nature, vol. 574, no. 7779, pp. 505-510, 2019.
[12] H.-S. Zhong, H. Wang, Y.-H. Deng, M.-C. Chen, L.-C. Peng, Y.-H. Luo, J. Qin, D. Wu, X. Ding, Y. Hu et al., “Quantum computational advantage using photons,” Science, vol. 370, no. 6523, pp. 1460-1463, 2020.
[13] J. Preskill, “Quantum computing in the nisq era and beyond,” Quantum, vol. 2, p. 79, 2018.
[14] L. A. Rozema, J. D. Bateman, D. H. Mahler, R. Okamoto, A. Feizpour, A. Hayat, and A. M. Steinberg, “Scalable spatial superresolution using entangled photons,” Phys. Rev. Lett., vol. 112, p. 223602, June 2014. [Online]. Available: https://link.aps.org/doi/10.1103/PhysRevLett. 112.223602
[15] T. Gregory, P.-A. Moreau, E. Toninelli, and M. J. Padgett, “Imaging through noise with quantum illumination,” Science Advances, vol. 6, no. 6, 2020. [Online]. Available: https://advances.sciencemag.org/content/6/6/eaay2652
[16] G. Brida, M. Genovese, and I. Ruo Berchera, “Experimental realization of sub-shot-noise quantum imaging,” Nature Photonics, vol. 4, no. 4, pp. 227-230, April 2010. [Online]. Available: https://doi.org/10.1038/nphoton. 2010.29
[17] P.-A. Moreau, E. Toninelli, T. Gregory, and M. J. Padgett, “Imaging with quantum states of light,” Nature Reviews Physics, vol. 1, no. 6, pp. 367-380, June 2019. [Online]. Available: https://doi.org/10.1038/s42254-019-0056-0
[18] R. Mailloux, “Phased array theory and technology,” Proceedings of the IEEE, vol. 70, no. 3, pp. 246-291, 1982.
[19] A. Fenn, D. Temme, W. Delaney, and W. Courtney, “The development of phased-array radar technology,” Lincoln Lab. J., vol. 12, 012000.
[20] X. Guan, H. Hashemi, and A. Hajimiri, “A fully integrated 24-ghz eight-element phased-array receiver in silicon,” IEEE Journal of Solid-State Circuits, vol. 39, no. 12, pp. 2311-2320, 2004.
[21] R. Fatemi, B. Abiri, A. Khachaturian, and A. Hajimiri, “High sensitivity active flat optics optical phased array receiver with a two-dimensional aperture,” Opt. Express, vol. 26, no. 23, pp. 29 983-29 999, November 2018. [Online]. Available: http://www.opticsexpress.org/abstract.cfm?URI=oe-23-4-5117
[22] F. Aflatouni, B. Abiri, A. Rekhi, and A. Hajimiri, “Nanophotonic coherent imager,” Opt. Express, vol. 23, no. 4, pp. 5117-5125 February 2015. [Online]. Available: http://www.opticsexpress.org/abstract.cfm?URI=oe-23-4-5117
[23] A. White, P. Khial, F. Salehi, B. Hassibi, and A. Hajimiri, “A silicon photonics computational lensless active-flat-optics imaging system,” Scientific Reports, vol. 10, 022020.
[24] F. Aflatouni, B. Abiri, A. Rekhi, and A. Hajimiri, “Nanophotonic projection system,” Opt. Express, vol. 23, no. 16, pp. 21012-21022, August 2015. [Online]. Available: http://www.opticsexpress.org/abstract.cfm?URI=oe-23-16-21012
[25] M. J. Byrd, C. V. Poulton, M. Khandaker, E. Timurdogan, D. Vermeulen, and M. R. Watts, “Free-space communication links with transmitting and receiving integrated optical phased arrays,” in Frontiers in Optics/Laser Science. Optical Society of America, 2018, p. FTu4E. 1. [Online]. Available: http://www.osapublishing.org/abstract.cfm?URI=FiO-2018-FT04E. 1
[26] J. Sun, E. Timurdogan, A. Yaacobi, E. S. Hosseini, and M. R. Watts, “Large-scale nanophotonic phased array,” Nature, vol. 493, no. 7431, pp. 195-199, January 2013. [Online]. Available: https://doi.org/10.1038/nature11727
[27] J. P. Dowling, “Quantum optical metrology—the lowdown on high-n00n states,” Contemporary physics, vol. 49, no. 2, pp. 125-143, 2008.
[28] Z.-E. Su, Y. Li, P. P. Rohde, H.-L. Huang, X.-L. Wang, L. Li, N.-L. Liu, J. P. Dowling, C.-Y. Lu, and J.-W. Pan, “Multiphoton interference in quantum fourier transform circuits and applications to quantum metrology,” Phys. Rev. Lett., vol. 119, p. 080502, August 2017. [Online]. Available: https://link.aps.org/doi/10.1103/PhysRevLett. 119.080502
[29] O. J. Farías, F. de Melo, P. Milman, and S. P. Walborn, “Quantum information processing by weaving quantum talbot carpets,” Physical Review A, vol. 91, no. 6, June 2015. [Online]. Available: http://dx.doi.org/10.1103/PhysRevA. 91.062328
[30] A. Z. Goldberg and D. F. V. James, “Entanglement generation via diffraction,” Phys. Rev. A, vol. 100, p. 042332, October 2019. [Online]. Available: https://link.aps.org/doi/10.1103/PhysRevA. 100.042332
[31] K. Wang, J. G. Titchener, S. S. Kruk, L. Xu, H.-P. Chung, M. Parry, I. I. Kravchenko, Y.-H. Chen, A. S. Solntsev, Y. S. Kivshar, D. N. Neshev, and A. A. Sukhorukov, “Quantum metasurface for multiphoton interference and state reconstruction,” Science, vol. 361, no. 6407, pp. 1104-1108, 2018. [Online]. Available: https://science.sciencemag.org/content/361/6407/1104
[32] M. J. Heck, “Highly integrated optical phased arrays: photonic integrated circuits for optical beam shaping and beam steering,” Nanophotonics, vol. 6, no. 1, pp. 93-107, 2017. [Online]. Available: https://doi.org/10.1515/nanopb-2015-0152
[33] C.-P. Hsu, B. Li, B. Solano-Rivas, A. R. Gohil, P. H. Chan, A. D. Moore, and V. Donzella, “A review and perspective on optical phased array for automotive lidar,” IEEE Journal of Selected Topics in Quantum Electronics, vol. 27, no. 1, pp. 1-16, 2021.
[34] R. Fatemi, B. Abiri, and A. Hajimiri, “An 8×8 heterodyne lens-less opa camera,” in Conference on Lasers and Electro-Optics. Optical Society of America, 2017, p. JW2A.9. [Online]. Available: http://www.osapublishing.org/abstract.cfm?URI=CLEO_AT-2017-JW2A. 9
[35] C. V. Poulton, M. J. Byrd, P. Russo, E. Timurdogan, M. Khandaker, D. Vermeulen, and M. R. Watts, “Long-range lidar and free-space data communication with high-performance optical phased arrays,” IEEE Journal of Selected Topics in Quantum Electronics, vol. 25, no. 5, pp. 1-8, 2019.
[36] M. Mastriani, “On the spectral nature of entanglement,” IET Quantum Communication, vol. 2, no. 1, pp. 8-13, 2021. [Online]. Available: https://ietresearch.onlinelibrary.wiley.com/doi/abs/10.1049/qtc2.12005
[37] Y. Nam, Y. Su, and D. Maslov, “Approximate quantum fourier transform with o(n log (n)) t gates,” npj Quantum Information, vol. 6, no. 1, p. 26, March 2020. [Online]. Available: https://doi.org/10.1038/841534-020-0257-5
[38] R. Athale and D. Psaltis, “Optical computing: Past and future,” Opt. Photon. News, vol. 27, no. 6, pp. 32-39, June 2016. [Online]. Available: http://www.osa-opp.org/abstract.cfm?URI=opn-27-6-32
[39] Y. Shih, “Quantum imaging,” IEEE Journal of Selected Topics in Quantum Electronics, vol. 13, no. 4, pp. 1016-1030, 2007.
[40] D. G. England, B. Balaji, and B. J. Sussman, “Quantum-enhanced standoff detection using correlated photon pairs,” Physical Review A, vol. 99, no. 2, February 2019. [Online]. Available: http://dx.doi.org/10.1103/.023828
[41] M. Gilaberte Basset, F. Setzpfandt, F. Steinlechner, E. Beckert, T. Pertsch, and M. Gräfe, “Perspectives for applications of quantum imaging,” Laser 8 Photonics Reviews, vol. 13, no. 10, p. 1900097, 2019. [Online]. Available: https://onlinelibrary.wiley.com/doi/abs/10.1002/lpor. 201900097
[42] C. Gerry and P. Knight, Introductory Quantum Optics. Cambridge University Press, 2004.
[43] K. Zielnicki, K. Garay-Palmett, D. Cruz-Delgado, H. Cruz-Ramirez, M. F. O'Boyle, B. Fang, V. O. Lorenz, A. B. U'Ren, and P. G. Kwiat, “Joint spectral characterization of photon-pair sources,” Journal of Modern Optics, vol. 65, no. 10, p. 1141-1160 February 2018. [Online]. Available: http://dx.doi.org/10.1080/09500340.2018.1437228
[44] P. Kok, H. Lee, and J. P. Dowling, “Creation of large-photon-number path entanglement conditioned on photodetection,” Phys. Rev. A, vol. 65, p. 052104, April 2002. [Online]. Available: https://link.aps.org/doi/10.1103/PhysRevA. 65.052104
[45] M. Jarrahi, F. Pease, D. Miller, and T. Lee, “Optical switching based on high-speed phased array optical beam steering,” Applied Physics Letters, vol. 92, pp. 014 106-014 106, 012008.
[46] Fatemi R.; et al. (Nov. 12, 2018). “High sensitivity active flat optics optical phased array receiver with a two-dimensional aperture” (PDF). Opt. Express. 26 (23). Optical Society of America: 29983-29999.
[47] In one or more embodiments, we define order of entanglement as the number of photons in an entangled state, such as N in N00N state.
[48] See arXiv: quant-ph/9806048 for a review on quantum computing with linear optics.
[49] Note that N₊<N₋ as the lowest order of entanglement corresponds to greatest number of antennas in a sub-array and vice-versa.

### Hardware Environment

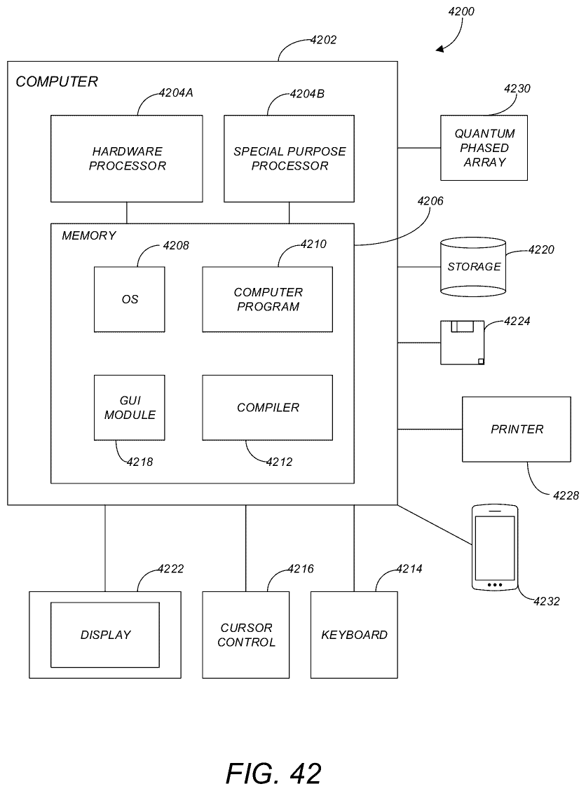

FIG. 42 is an exemplary hardware and software environment 4200 (referred to as a computer-implemented system and/or computer-implemented method) used to implement one or more embodiments of the invention, e.g., control and/or data processing for the quantum phased array 42130. The hardware and software environment includes a computer 4202 and may include peripherals. Computer 4202 may be a user/client computer, server computer, or may be a database computer. The computer 4202 comprises a hardware processor 4204A and/or a special purpose hardware processor 4204B (hereinafter alternatively collectively referred to as processor 4204) and a memory 4206, such as random access memory (RAM). The computer 4202 may be coupled to, and/or integrated with, other devices, including input/output (I/O) devices such as a keyboard 4214, a cursor control device 4216 (e.g., a mouse, a pointing device, pen and tablet, touch screen, multi-touch device, etc.) and a printer 4228. In one or more embodiments, computer 4202 may be coupled to, or may comprise, a portable or media viewing/listening device 4232 (cellular device, personal digital assistant, etc.). In yet another embodiment, the computer 4202 may comprise a multi-touch device, mobile phone, or other internet enabled device executing on various platforms and operating systems.

In one embodiment, the computer 4202 operates by the hardware processor 4204A performing instructions defined by the computer program 4210 under control of an operating system 4208. The computer program 4210 and/or the operating system 4208 may be stored in the memory 4206 and may interface with the user and/or other devices to accept input and commands and, based on such input and commands and the instructions defined by the computer program 4210 and operating system 4208, to provide output and results.

Output/results may be presented on the display 4222 or provided to another device for presentation or further processing or action. The image may be provided through a graphical user interface (GUI) module 4218. Although the GUI module 4218 is depicted as a separate module, the instructions performing the GUI functions can be resident or distributed in the operating system 4208, the computer program 4210, or implemented with special purpose memory and processors.

Some or all of the operations performed by the computer 4202 according to the computer program 4210 instructions may be implemented in a special purpose processor 4204B. In this embodiment, some or all of the computer program 4210 instructions may be implemented via firmware instructions stored in a read only memory (ROM), a programmable read only memory (PROM) or flash memory within the special purpose processor 4204B or in memory 4206. The special purpose processor 4204B may also be hardwired through circuit design to perform some or all of the operations to implement the present invention. Further, the special purpose processor 4204B may be a hybrid processor, which includes dedicated circuitry for performing a subset of functions, and other circuits for performing more general functions such as responding to computer program 4210 instructions. In one embodiment, the special purpose processor 4204B is an application specific integrated circuit (ASIC), a graphics processing unit (GPU), a field programmable gate array (FPGA), or a processor adapted for machine learning or artificial intelligence.

The computer 4202 may also implement a compiler 4212 that allows an application or computer program 4210 written in a programming language such as C, C++, Assembly, SQL, PYTHON, PROLOG, MATLAB, RUBY, RAILS, HASKELL, or other language to be translated into processor 4204 readable code. Alternatively, the compiler 4212 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 4210 accesses and manipulates data accepted from I/O devices and stored in the memory 4206 of the computer 4202 using the relationships and logic that were generated using the compiler 4212.

The computer 4202 also optionally comprises an external communication device such as a modem, satellite link, Ethernet card, or other device for accepting input from, and providing output to, other computers 4202.

In one embodiment, instructions implementing the operating system 4208, the computer program 4210, and the compiler 4212 are tangibly embodied in a non-transitory computer-readable medium, e.g., data storage device 4220, which could include one or more fixed or removable data storage devices, such as a zip drive, floppy disc drive 4224, hard drive, CD-ROM drive, tape drive, etc. Further, the operating system 4208 and the computer program 4210 are comprised of computer program 4210 instructions which, when accessed, read and executed by the computer 4202, cause the computer 4202 to perform the steps necessary to implement and/or use the present invention or to load the program of instructions into a memory 4206, thus creating a special purpose data structure causing the computer 4202 to operate as a specially programmed computer executing the method steps described herein. Computer program 4210 and/or operating instructions may also be tangibly embodied in memory 4206 and/or data communications devices, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 4202.

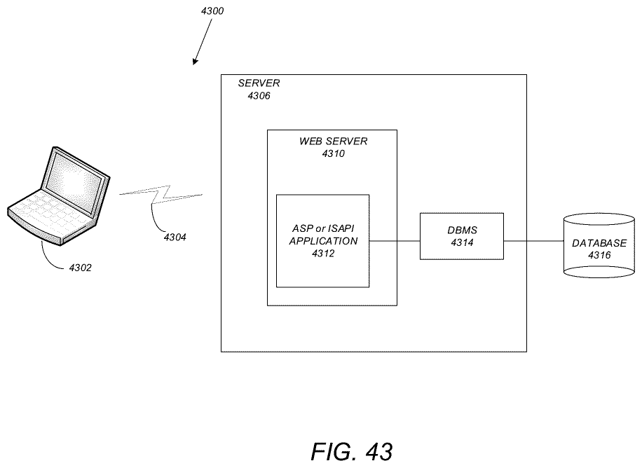

FIG. 43 schematically illustrates a typical distributed/cloud-based computer system 4300 using a network 4304 to connect client computers 4302 to server computers 4306. A typical combination of resources may include a network 4304 comprising the Internet, LANs (local area networks), WANs (wide area networks), SNA (systems network architecture) networks, or the like, clients 4302 that are personal computers or workstations (as set forth in FIG. 42), and servers 4306 that are personal computers, workstations, minicomputers, or mainframes (as set forth in FIG. 42). However, it may be noted that different networks such as a cellular network (e.g., GSM [global system for mobile communications] or otherwise), a satellite based network, or any other type of network may be used to connect clients 4302 and servers 4306 in accordance with embodiments of the invention.

A network 4304 such as the Internet connects clients 4302 to server computers 4306. Network 4304 may utilize ethernet, coaxial cable, wireless communications, radio frequency (RF), etc. to connect and provide the communication between clients 4302 and servers 4306. Further, in a cloud-based computing system, resources (e.g., storage, processors, applications, memory, infrastructure, etc.) in clients 4302 and server computers 4306 may be shared by clients 4302, server computers 4306, and users across one or more networks. Resources may be shared by multiple users and can be dynamically reallocated per demand. In this regard, cloud computing may be referred to as a model for enabling access to a shared pool of configurable computing resources.

Clients 4302 may execute a client application or web browser and communicate with server computers 4306 executing web servers 4310. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 4302 may be downloaded from server computer 4306 to client computers 4302 and installed as a plug-in or ACTIVEX control of a web browser. Accordingly, clients 4302 may utilize ACTIVEX components/component object model (COM) or distributed COM (DCOM) components to provide a user interface on a display of client 4302. The web server 4310 is typically a program such as MICROSOFT'S INTERNET INFORMATION SERVER.

Web server 4310 may host an Active Server Page (ASP) or Internet Server Application Programming Interface (ISAPI) application 4312, which may be executing scripts. The scripts invoke objects that execute business logic (referred to as business objects). The business objects then manipulate data in database 4316 through a database management system (DBMS) 4314. Alternatively, database 4316 may be part of, or connected directly to, client 4302 instead of communicating/obtaining the information from database 4316 across network 4304. When a developer encapsulates the business functionality into objects, the system may be referred to as a component object model (COM) system. Accordingly, the scripts executing on web server 4310 (and/or application 4312) invoke COM objects that implement the business logic. Further, server 4306 may utilize MICROSOFT'S TRANSACTION SERVER (MTS) to access required data stored in database 4316 via an interface such as ADO (Active Data Objects), OLE DB (Object Linking and Embedding DataBase), or ODBC (Open DataBase Connectivity).

Generally, these components 4300-4316 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 4302 and 4306 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 4302 and 4306. Embodiments of the invention are implemented as a software/hardware on a client 4302 or server computer 4306. Further, as described above, the client 4302 or server computer 4306 may comprise a thin client device or a portable device that has a multi-touch-based display.

### Process Steps

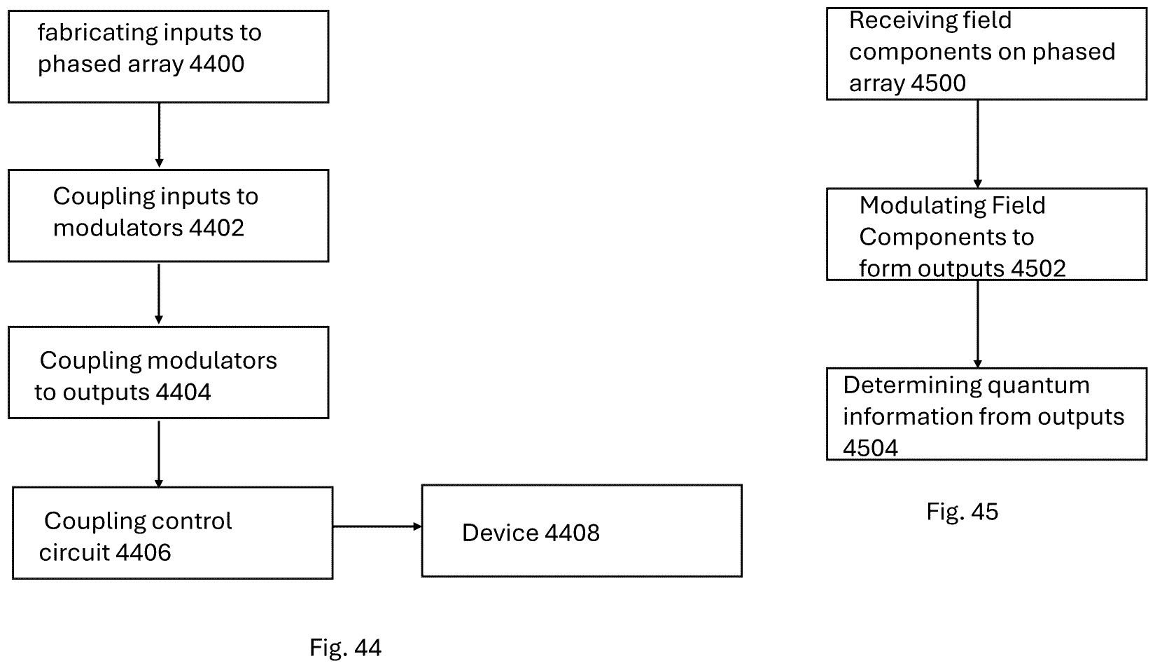

FIG. 44 illustrates a method of making a phased array, comprising the following steps.

Block 4400 represents fabricating/providing inputs each configured to receive a component of an input quantum field in an input quantum state associated with one or more particles emitted from one or more particle sources.

Block 4402 represents coupling an array of modulator elements to the inputs, each of the modulator elements operable to apply a modulation to the component to form an output component,

Block 4404 represents fabricating/providing outputs for the output components. The step can comprise optionally positioning detectors for the output components. The step can optionally comprise providing a readout circuit for reading out the signals from the detectors.

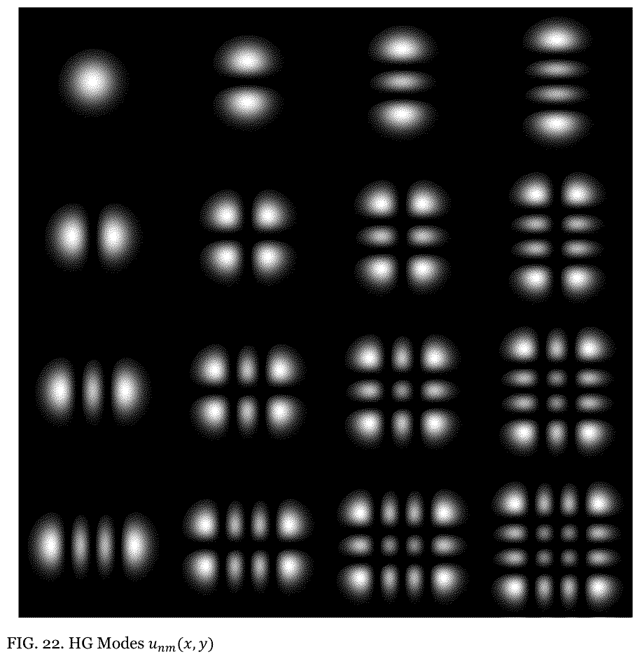

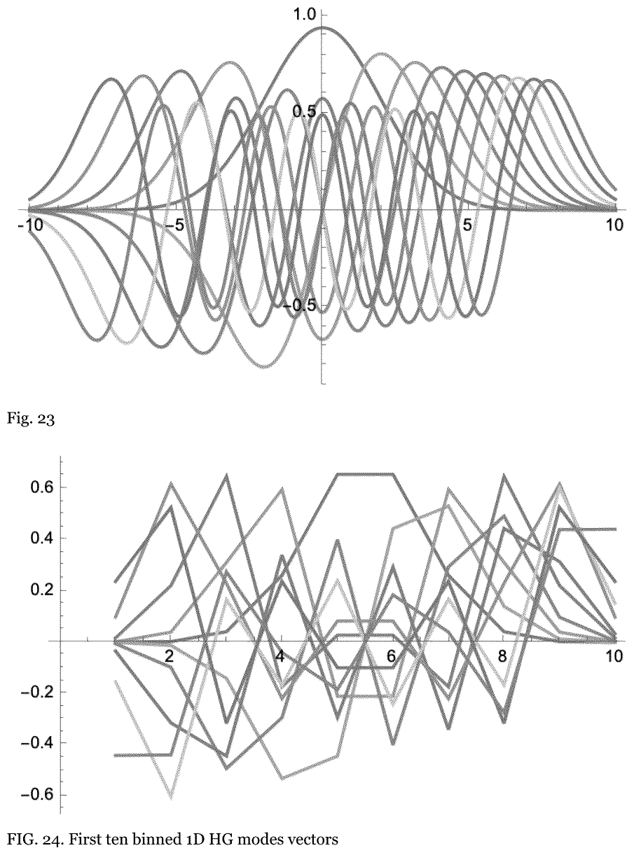

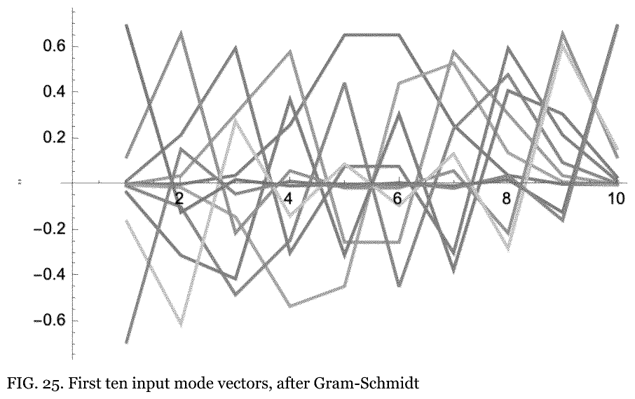

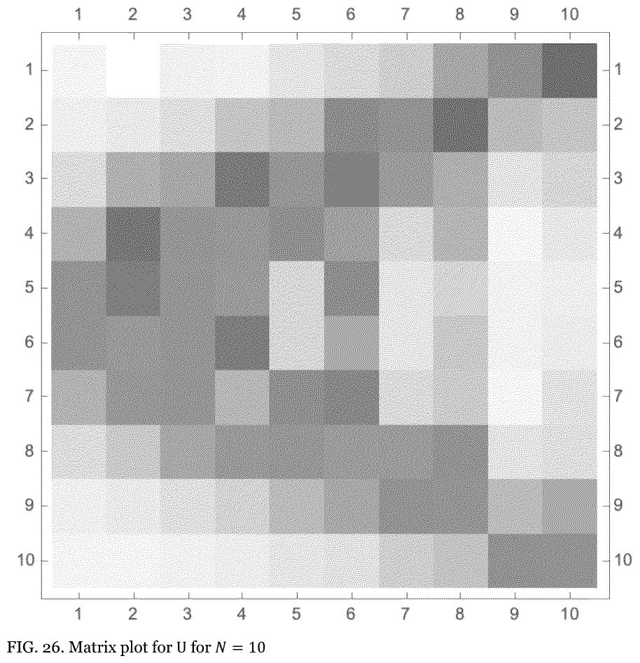

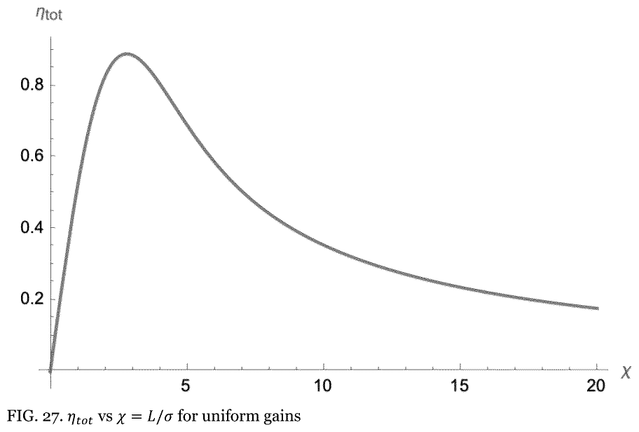

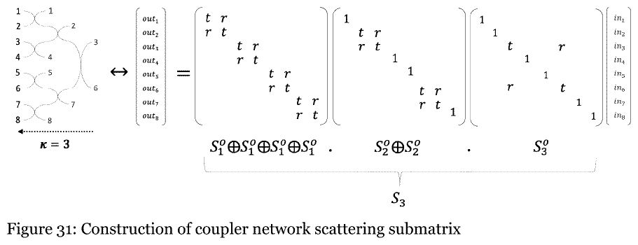

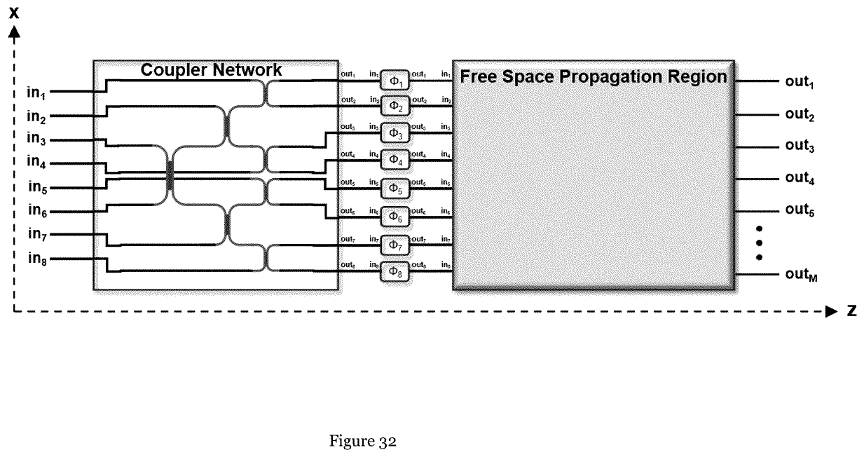

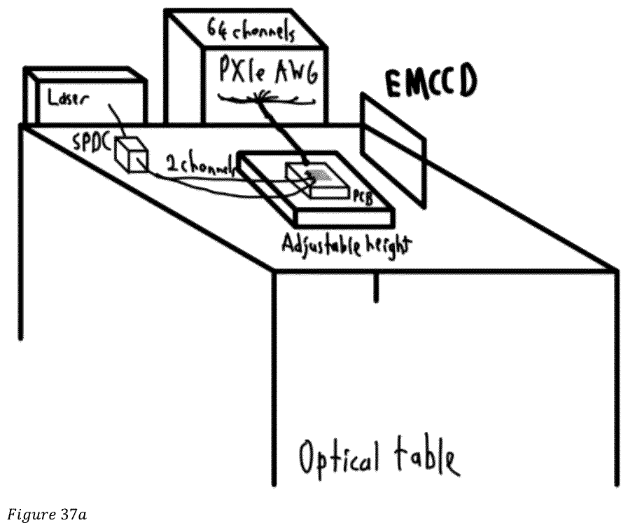

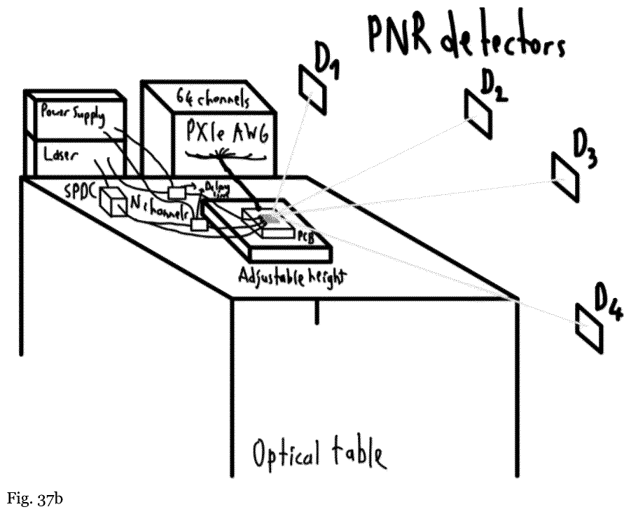

Block 4406 represents coupling a control circuit to the modulator elements, the control circuit operable to set each of one or more weights, of the modulation applied by each of the modulators elements, to control an interference of the output components forming an engineered quantum field 106 used to form a target quantum state. In one or more embodiments, the device (phased array and/or control circuit) is fabricated on one or more chips, e.g., by photolithography, to form one or more integrated circuits. Block 4408 represents the end result, a device. The device can be embodied in many ways, including but not limited to the following (referring also to FIGS. 1-43).
1. The device of clause 1, wherein the one or more quantum phased arrays 400 comprise a photonic integrated circuit comprising:
an array of channels 401 each comprising:
   the input 101 comprising a receiving antenna for receiving the input quantum field from a photon source,
   the output 108 comprising a transmit antenna for outputting the output component, and
   one of the modulator elements 406 connected between the transmit antenna and the receive antenna via a waveguide 404.
2. The device of clause 1, further comprising:
the one or more quantum phased arrays comprising the particle sources, comprising an electron source 502, and an array of channels each comprising an electron waveguide 504 coupled to one of the modulator elements 506 comprising a magnetic modulator or a window to couple to a light beam, or
the one or more quantum phased arrays 600 comprising a magneto optical trap 603 operable to transfer gas to an array of gas channels 604 in a controlled manner, and each of the gas channels coupled to a different one of the modulator elements 606 comprising a magnetic modulator or an window to couple to a light beam, or
the one or more quantum phased arrays comprising a polariton source 702 and an array of channels each comprising a polariton waveguide 704 coupled to one of the modulator elements 706 comprising an electro-optic modulator or a thermo-optic modulator.
3. A receiver 200 comprising the device of any of the clauses 1-3, wherein:
one or more of the arrays each comprise an array of detectors 206 positioned to detect the output components, and
the control circuit 208 is operable to set the weights to reconstruct the target quantum state from the output components outputted in response to the input quantum field transmitted after transmission through a propagation medium 310.
4. A transmitter 100 or the receiver 200 comprising the device of any of the clauses 1-4, wherein the control circuit 112, 208 is coupled to a computer 4200 configured to determine the weights from a protocol relating the input quantum state, the target quantum state, and a propagation 210 of the engineered quantum field through a propagation medium.
5. The device of clause 5, wherein the computer determines the weights by associating the propagation with a Quantum Fourier Transform or diffraction of the engineered quantum field.
6. The device of any of the clauses 4-6, wherein the computer 4200 is configured to:
for the transmitter, determine the weights to at least steer, modulate, encode, beam shape, multiplex, or quantum mechanically entangle the engineered quantum field, or correct for a distortion of the engineered quantum field caused by the propagation medium, and
for the receiver, determine the weights to at least correct for the distortion, filter, decode, de-multiplex, or demodulate the input quantum field comprising the engineered quantum field transmitted from the transmitter, so as to reconstruct the target quantum state.
7. The device of any of the clauses 4-7, wherein the modulation comprises a phase shift and the weights comprise a linear phase profile applied so that the phase of the output components varies linearly as a function of distance in a direction across the array, thereby steering the engineered quantum field.
8. A quantum metrology system 1200, 1300 comprising the device of any of the clauses 4-8, further comprising:
the transmitter 1202, 1302 configured to apply the weights to steer the engineered quantum field through a propagation medium to a sample 1206, 1306;
the receiver 1210, 1312 configured to apply the weights to detect a change in the engineered quantum field resulting from an interaction with the sample; and
the computer 4200 configured to determine, from the change, a property of the sample.
9. The quantum metrology system of clause 9, wherein the transmitter is configured to apply the weights to transmit the engineered quantum field comprising at least one of an entangled quantum state or a linear phase profile scanning the engineered quantum field, comprising the target quantum state, across the sample.
10. The quantum metrology system of clause 9, wherein:
the transmitter is configured to apply the weights to modulate and transmit the engineered quantum field to the sample, and
the receiver is configured to apply the weights demodulating the engineered quantum field received from the sample to detect information used to determine the property.
11. The quantum metrology system of clause 9, wherein:
the transmitter is configured to apply the weights to spatio-temporally scan the sample with the engineered quantum field having the target quantum state, and
the receiver is configured to apply the weights to filter quantum information in the engineered quantum field received from the sample and so as to obtain the property.
12. The quantum metrology system of clause 9, wherein the receiver applies the weights to determine timing information so that property is a range to the sample
13. A quantum communication 1400 system comprising the device of any of the clauses 4-8, further comprising:
the transmitter 1400 comprising a first one of the quantum phased arrays to transmit the engineered quantum field, comprising a signal comprising the target quantum state, through a propagation medium;
the receiver 1402 comprising a second one of the quantum phased arrays to receive the engineered quantum field after transmission through the propagation medium 1404; and
the computer 4200 operable to determine the signal comprising the target quantum state from the output components detected on the detectors.
15. The quantum communication system of clause 14, wherein the computer determines the weights applied in the receiver to filter transmissions received from propagation medium so that only output components corresponding to predetermined ones of the engineered quantum fields, from predetermined ones of the transmitters, are transmitted to the detectors.
14. The quantum communication system of any of the clauses 14-15, wherein a network of one or more pairs of the transmitter and the receiver are connected through the propagation medium via a network 1406 (wired network or a wireless network) transmitting the engineered quantum field.
15. The quantum communication system of clause 14, wherein the control circuit in the transmitter is operable to set the weights forming the signal comprising a multiplexed signal or timing information for synchronizing clocks at the transmitter and the receiver in a distributed network comprising one or more pairs of the transmitter and the receiver.
16. The quantum communication system of clause 14, wherein the control circuit in the transmitter is operable to set the weights encrypting the signal according to quantum or classical protocol and the receiver is operable to set the weights decrypting the signal.
17. A quantum simulator 1500 comprising the quantum phased arrays of clause 1 comprising a plurality of n quantum phased arrays 1502 cascaded so that, for 1<i≤n, the output components of the i^{th} one of the arrays is inputted to the i+1^{th} phased array and the weights:
in at least a first one of the arrays are selected to prepare the target quantum state 1504,
in at least a second one arrays are selected to evolve the target quantum states 1506 according to an interactions in a quantum system, and
in at least a third one of the arrays are selected to measure 1508 the target quantum state after the interaction.
18. A quantum computer 1600 comprising the device of any of the clauses 4-8, wherein the computer is operable to determine the weights to generate the engineered quantum field comprising the target quantum state comprising an entangled state or superposition state comprising a quantum mode.
19. The quantum computer of clause 20, wherein the computer is configured to determine:
the weights applied in the transmitter corresponding to values in a matrix, and
the weights applied in receiver to reconstruct the target quantum state by associating a propagation of the engineered quantum field to the receiver as corresponding to a matrix multiplication of the matrix.
20. The quantum computer of clause 20, wherein the computer is configured to determine:
the weights applied in the transmitter corresponding to values in a matrix, and
the weights applied in receiver to reconstruct the target quantum state by associating a propagation of the engineered quantum field to the receiver as corresponding to operation of one or more quantum gates according to a quantum algorithm.
23. A device 1800, 1900, comprising:
a photonic-electronic integrated circuit 1806 comprising a phased array receiver 401 comprising a plurality of inputs, 102, 403, 1802 configured to receive electromagnetic radiation 1803, the phased array receiver operable to convert the electromagnetic radiation into a plurality of electrical signals 1911 comprising quantum information of the electromagnetic radiation so that a quantum state of the electromagnetic radiation can be reconstructed from the electrical signals.
24. The device of clause 23, wherein the receiver comprises a plurality of channels 1814 each comprising:
an antenna 1802 configured to receive the electromagnetic radiation comprising a signal electromagnetic field; and
a network of waveguides 1804, 405 connecting the antenna to a photodetector 1904 (e.g., a pair of balanced photodiodes), the network of waveguides coupled to one or more modulators 1812, 407 and comprising one or more sections configured as one or more mixers 1808 configured to mix a mode of the signal electromagnetic field with a local oscillator (LO) electromagnetic field to form one or more mixed signals, and the photodetector configured to output one of the electrical signals in response to the mixed signals.
25. The device of clause 24, wherein:
the network of waveguides further comprises an LO section 1906 coupled to one or more of the modulators 1812, 407 for modulating a phase of the LO electromagnetic field prior to input to the one or more mixers, wherein the network of waveguides and the modulators are configured for applying a phase sweep sweeping a phase of the LO electromagnetic field in each of the channels 1814 between 0 and 2π radians so that image data representing a quantized field mode in each of the channels can be generated from the electrical signals.
26. The device of clause 25, further comprising:
a control circuit 1908, 413 connected to the modulators for controlling the phase sweep and collecting the electrical signals for each of the phases between 0 and 2π in a time window so that a mean and variance of the electrical signals in each of the channels can be calculated; and
a computer 1910, 4200 configured to determine the quantum field mode from at least one of the mean and the variance.
The device of clause 24, wherein the network of waveguides comprises, prior to input to the one or more mixers:
an LO section 1906 coupled to at least a first one of the modulators for modulating a phase of the LO electromagnetic field, and
a signal section 1912 coupled to at least a second one of the modulators for modulating a phase of the mode of the signal electromagnetic field,
wherein the network of waveguides and the modulators are configured for setting the phase of the signal electromagnetic field in each of the channels so that coherent combination of the electrical signals forms a predetermined quantum wavefunction or quantum field associated with the electromagnetic radiation.
27. The device of clause 27, wherein the integrated circuit further comprises a coherent combiner configured to combine the electrical signals into a coherently beamformed signal.
28. The device of clause 28, further comprising:
a control circuit 1908, 413 configured to apply, in a calibration mode, a phase sweep of the LO electromagnetic field in each of the channels between 0 and 2π radians at a beat frequency associated with the mixed signals obtained for the electromagnetic radiation comprising a known calibration field inputted to the receiver at a known angle of incidence;
a computer 1910, 4200 configured for:
determining, from the coherently beamformed signal as a function of the phase, the set of the phases applied in each of the channels that maximizes a tone of the coherently beamformed signal at the beat frequency; and outputting the set of the phases to the control circuit for addressing each of the channels to set the phase of the signal electromagnetic radiation in the each of the channels to form the predetermined quantum wavefunction.
29. The device of clause 24, wherein each of the channels further comprises an amplifier 1902 having a first output 1905 for outputting an amplification of the one of the electrical signals and a second output 1907 connected to one or more of the modulators for providing a feedback signal used for noise correction.
30. The device of clause 30, wherein the phased array is configured for outputting the electrical signals comprising shot noise limited signals in response to the electromagnetic radiation associated with a single photon incident on the phased array.
31. The device of clause 24, wherein the photonic-electronic integrated circuit comprises a quantum circuit 2100 operable to generate entanglement by beamforming the mixed signals and interfering the beamforming from different sections of the phased array, then interfering resulting beamformed modes in the electrical signals to form a cluster state.
32. The device of clause 24, wherein the photonic-electronic integrated circuit further comprises a coherent combiner 1909 for combining the electrical signals, wherein the modulators and the coherent combiners are configured to implement quantum logic gates.
33. The device of clause 24, wherein the mixers comprise one or more interferometers 1808 and the modulators comprise one or more phase shifters.
34. The device of clause 34, wherein:
each of the channels further comprises an amplifier 1902 for outputting an amplification of the one of the electrical signals according to a gain,
the device further comprises a control circuit 1908, 1413 coupled to the amplifiers and the modulators for setting the gains applied to the electrical signals, and the phase shifts applied to the signal electromagnetic fields and/or the local oscillator electromagnetic field via the modulators and according to a calibration protocol, such that the quantum information can be extracted from processing of the electrical signals in a computer.
36. FIG. 45 illustrates a method of transmitting or receiving quantum information, comprising:
receiving 4500, on a phased array, components of an input quantum field in an input quantum state associated with one or more particles emitted from one or more particle sources;
modulating 4502, in the phased array, each of the components according to a modulation protocol to form output components; and
determining 4504 the quantum information of a quantum state formed using the output components.
37. The method of clause 36, wherein:
the phased array comprises a photonic-electronic integrated circuit comprising:
   antennas for:
      capturing electromagnetic radiation associated with the particles comprising one or more photons; and
      transmitting the components to the modulators in response thereto, the modulating comprising mixing the components with a local oscillator to form the output components, and
   detectors for converting the output components to electrical signals; and
   wherein the determining comprises processing the electrical signals.
38. The device or method of any of the clauses, wherein the quantum states comprise gaussian states (e.g., squeezed states or cluster states) or non-Gaussian states (e.g., cat states), or GHZ states.
39. The device or method of any of the clauses, further comprising a printed circuit board (PCB), wherein the control circuit and a chip (e.g., silicon or silicon nitride on an oxide underlayer) comprising the integrated circuit are mounted on the PCB.
40. A quantum network 1400, comprising:
quantum phased array transmitters 1402;
quantum phased array receivers 1404; and
reconfigurable free-space point to point quantum links 1408 between the quantum phased array transmitters and quantum phased array receivers.
41. The quantum network of clause 40, wherein the quantum phased array receivers and transmitters are located at different nodes 1410 in the quantum network, the network further comprising a control circuit 208 for configuring the quantum phased arrays to dynamically transfer quantum information between the nodes in a distributed quantum computing, metrology, or communications system comprising the quantum network.
42. The quantum network of clause 41, wherein the quantum phased array receivers and the quantum phased array receivers are configured to at least generate, process, measure, or reconstruct quantum states for free-space quantum information processing.
43. The device of any of the clauses 1-22 comprising the device of any of the clauses 23-34.
44. The method of any of the clauses 36-37 using the device of any of the clauses 1-34.
45. The network of any of the clauses 40-42 wherein the quantum phased array receivers or transmitters comprise the device of any of the clauses 1-34.
46. The network of any of the clauses 40-42 and 45 wherein the quantum phased array receivers or transmitters are in quantum phased array transceivers.
47. The device of any of the clauses 1-46, wherein the modulator comprises material (e.g., electro-optic material, or thermo-optic material) thermally or electrically coupled to an electrode, wherein application of a voltage to the electrode controls, electro-optic effect actuation or thermo-optic effect actuation of the material so as to control a phase or amplitude of the electromagnetic field of the optical pulses passing through the material, and equivalents thereof.
48. The device of any of the clauses 1-46, wherein the modulator comprises material whose properties can be modulated (e.g., via an electrode) so as to control a phase or amplitude of the electromagnetic field of the optical pulses passing through the material, and equivalents thereof.
49. The device of any of the clauses 1-48, wherein the detectors comprise, but are not limited to, single photon-resolving direct detectors such as avalanche photodiodes, photomultiplier tubes, and superconducting nanowire single photon detectors, or single photon-resolving coherent receivers such as balanced homodyne/heterodyne.
50. The device of any of the clauses 1-49, wherein the sources comprise a single particle (e.g., single photon) source.
51. The device or method of any of the clauses 1-50, wherein the engineered quantum field or electromagnetic radiation comprises and electromagnetic wave or wavefront, e.g., having any wavelength, e.g., in a range of 400 nm to 10 micrometers.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device, comprising:
one or more quantum phased arrays each comprising:
an array of modulator elements, each of the modulator elements:
comprising or coupled to an input to receive a component of an input quantum field in an input quantum state associated with one or more particles emitted from one or more particle sources,
operable to apply a modulation to the component to form an output component, and
comprising or coupled to an output for the output component;
a control circuit connected to the modulator elements, the control circuit operable to set each of one or more weights, of the modulation applied by each of the modulators elements, to control an interference of the output components forming an engineered quantum field used to form a target quantum state.

2. The device of claim 1, wherein the one or more quantum phased arrays comprise a photonic integrated circuit comprising:
an array of channels each comprising:
the input comprising a receiving antenna for receiving the input quantum field from a photon source,
the output comprising a transmit antenna for outputting the output component, and
one of the modulator elements connected between the transmit antenna and the receive antenna via a waveguide.

3. The device of claim 1, further comprising:
the one or more quantum phased arrays comprising the particle sources, comprising an electron source, and an array of channels each comprising an electron waveguide coupled to one of the modulator elements comprising a magnetic modulator or a window to couple to a light beam, or
the one or more quantum phased arrays comprising a magneto optical trap operable to transfer gas to an array of gas channels in a controlled manner, and each of the gas channels coupled to a different one of the modulator elements comprising a magnetic modulator or a window to couple to a light beam, or
the one or more quantum phased arrays comprising a polariton source and an array of channels each comprising a polariton waveguide coupled to one of the modulator elements comprising an electro-optic modulator or a thermo-optic modulator.

4. A receiver comprising the device of claim 1, wherein:
one or more of the arrays each comprise an array of detectors positioned to detect the output components, and
the control circuit is operable to set the weights to reconstruct the target quantum state from the output components outputted in response to the input quantum field transmitted after transmission through a propagation medium.

5. A transmitter and/or the receiver comprising the device of claim 1,
wherein the control circuit is coupled to a computer configured to determine the weights from a protocol relating the input quantum state, the target quantum state, and a propagation of the engineered quantum field through a propagation medium.

6. The device of claim 5, wherein the computer determines the weights by associating the propagation with a Quantum Fourier Transform or diffraction of the engineered quantum field.

7. The device of claim 4, wherein the computer is configured to:
for the transmitter, determine the weights to at least steer, modulate, encode, beam shape, multiplex, or quantum mechanically entangle the engineered quantum field, or correct for a distortion of the engineered quantum field caused by the propagation medium, and
for the receiver, determine the weights to at least correct for the distortion, filter, decode, de-multiplex, or demodulate the input quantum field comprising the engineered quantum field transmitted from the transmitter, so as to reconstruct the target quantum state.

8. The device of claim 4, wherein the modulation comprises a phase shift and the weights comprise a linear phase profile applied so that the phase of the output components varies linearly as a function of distance in a direction across the array, thereby steering the engineered quantum field.

9. A quantum metrology system comprising the device of claim 4, further comprising:
the transmitter configured to apply the weights to steer the engineered quantum field through a propagation medium to a sample;
the receiver configured to apply the weights to detect a change in the engineered quantum field resulting from an interaction with the sample; and
the computer configured to determine, from the change, a property of the sample.

10. The quantum metrology system of claim 9, wherein the transmitter is configured to apply the weights to transmit the engineered quantum field comprising at least one of an entangled quantum state or a linear phase profile scanning the engineered quantum field, comprising the target quantum state, across the sample.

11. The quantum metrology system of claim 9, wherein:
the transmitter is configured to apply the weights to modulate and transmit the engineered quantum field to the sample, and
the receiver is configured to apply the weights demodulating the engineered quantum field received from the sample to detect information used to determine the property.

12. The quantum metrology system of claim 9, wherein:
the transmitter is configured to apply the weights to spatio-temporally scan the sample with the engineered quantum field having the target quantum state, and the receiver is configured to apply the weights to filter quantum information in the engineered quantum field received from the sample and so as to obtain the property.

13. The quantum metrology system of claim 9, wherein the receiver applies the weights to determine timing information so that property is a range to the sample.

14. A quantum communication system comprising the device of claim 4, further comprising:
the transmitter comprising a first one of the quantum phased arrays to transmit the engineered quantum field, comprising a signal comprising the target quantum state, through a propagation medium;
the receiver comprising a second one of the quantum phased arrays to receive the engineered quantum field after transmission through the propagation medium; and
the computer operable to determine the signal comprising the target quantum state from the output components detected on the detectors.

15. A quantum simulator comprising the quantum phased arrays of claim 1 comprising a plurality of n quantum phased arrays cascaded so that, for 1<i≤n, the output components of the i^{th} one of the arrays is inputted to the i+1^{th} phased array and the weights:
in at least a first one of the arrays are selected to prepare the target quantum state, in at least a second one arrays are selected to evolve the target quantum state according to an interaction in a quantum system, and
in at least a third one of the arrays are selected to measure the target quantum state after the interaction.

16. A quantum computer comprising the device of claim 4, wherein the computer is operable to determine the weights to generate the engineered quantum field comprising the target quantum state comprising an entangled state or superposition state comprising a quantum mode.

17. A device, comprising:
a photonic-electronic integrated circuit comprising a phased array receiver comprising a plurality of inputs configured to receive electromagnetic radiation, the phased array receiver operable to convert the electromagnetic radiation into a plurality of electrical signals comprising quantum information of the electromagnetic radiation so that a quantum state of the electromagnetic radiation can be reconstructed from the electrical signals.

18. The device of claim 17, wherein the receiver comprises a plurality of channels each comprising:
an antenna configured to receive the electromagnetic radiation comprising a signal electromagnetic field; and
a network of waveguides connecting the antenna to a photodetector, the network of waveguides coupled to one or more modulators and comprising one or more sections configured as one or more mixers configured to mix a mode of the signal electromagnetic field with a local oscillator (LO) electromagnetic field to form one or more mixed signals, and the photodetector configured to output one of the electrical signals in response to the mixed signals.

19. A quantum network, comprising:
quantum phased array transmitters;
quantum phased array receivers; and
reconfigurable free-space point to point quantum links between the quantum phased array transmitters and quantum phased array receivers.

20. The quantum network of claim 19, wherein the quantum phased array receivers and transmitters are located at different nodes in the quantum network, the network further comprising a control circuit for configuring the quantum phased arrays to dynamically transfer quantum information between the nodes in a distributed quantum computing, metrology, or communications system comprising the quantum network.

21. The quantum network of claim 19, wherein the quantum phased array receivers and the quantum phased array receivers are configured to at least generate, process, measure, or reconstruct quantum states for free-space quantum information processing.
